(19) United States
(12) Patent Application Publication
(10) Pub. No.: US 2015/0073815 A1
(43) Pub. Date: Mar. 12, 2015

(54) SYSTEMS AND METHODS FOR LABORATORY TESTING AND RESULT MANAGEMENT

(71) Applicant: Theranos, Inc., Palo Alto, CA (US)

(72) Inventors: Elizabeth A. Holmes, Palo Alto, CA (US); Ramesh Balwani, Palo Alto, CA (US)

(73) Assignee: Theranos, Inc., Palo Alto, CA (US)

(21) Appl. No.: 14/020,785

(22) Filed: Sep. 6, 2013

(51) Int. Cl. G06F 19/00

(52) U.S. Cl. CPC G06F 19/3418; G06F 19/327; G06F 19/328
USPC 705/2

(57) ABSTRACT

In one embodiment, a method is provided comprising displaying a laboratory test menu on a mobile computing device, where the test menu is variable-based on geographic location; selecting one or more tests from said test menu; and using the mobile computing device to send a laboratory test request to a server.

### BACKGROUND

Laboratory testing of blood samples from patients has traditionally been based on a physical, paper laboratory test request that a patient receives from a doctor. That physical document is usually then taken by the patient to a technician or administrator at a laboratory facility or a patient service center. Typically, after waiting for their turn at that facility or center, a patient is then attended to by a phlebotomist who extracts blood from the patient by way of venipunture. Before venipunture, the phlebotomist selects the correct number and type of vacuum blood collection tubes for the desired number and/or types of tests set forth in the laboratory test request. The phlebotomist ensures that blood from the venipunture fills the correct number and types of tubes. Unless the laboratory tests were ordered STAT or other expedited basis, the patient will wait days or weeks before being notified of the results of the laboratory test. Usually, the notification comes from the doctor or someone in the doctor's office, not from the laboratory that conducted the test.

This process of traditional paper-based testing protocol and traditional testing infrastructure, creates a legacy system that can be unnecessarily slow and burdened by various limitations.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### COPYRIGHT

This document contains material subject to copyright protection. The copyright owner (Applicant herein) has no objection to facsimile reproduction of the patent documents and disclosures, as they appear in the US Patent and Trademark Office patent file or records, but otherwise reserves all copyright rights whatsoever. The following notice shall apply: Copyright 2013 Theranos, Inc.

### SUMMARY

The disadvantages associated with the prior art are overcome by embodiments of systems and methods provided herein.

In one embodiment as described herein, a method is provided comprising displaying a laboratory test menu on a mobile computing device, where the test menu is variable-based on geographic location; selecting one or more tests from said test menu; and using the mobile computing device to send a laboratory test request to a server.

In one embodiment as described herein, a method is provided displaying a laboratory test menu on a mobile computing device, where the test menu is variable-based on geographic location, selecting one or more tests from said test menu; scheduling an appointment for the laboratory test; and using the mobile computing device to send a laboratory test request and appointment information to a server.

In one embodiment as described herein, a method is provided using a mobile computing device to schedule an appointment time for a laboratory test; displaying a laboratory test menu on the mobile computing device, selecting one or more tests from said test menu, wherein the test menu is variable-based on geographic location; and using the mobile computing device to send a laboratory test request and appointment information to a server.

In one embodiment as described herein, a method is provided displaying a laboratory test menu on a mobile computing device, selecting one or more tests from said test menu, wherein the test menu is variable-based on geographic location; displaying pricing of the laboratory tests selected by the user, wherein a total price and line item price are displayed to the user prior to the user sending a laboratory test request; having the user confirm the laboratory test request; and using the mobile computing device to send a laboratory test request and any appointment information to a server.

In one embodiment as described herein, a method is provided displaying a plurality of laboratory test results on a mobile computing device, wherein each of said test results has an acceptable range that is depicted as a shape on a display of the mobile computing device, wherein the shapes of two or more of the test results are normalized such that a longest physical dimension of such shape depicting an acceptable range is displayed in manner that is the same between each of the test results.

In one embodiment as described herein, a method is provided associating insurance coverage information with a user account that is accessible by way of a mobile computing device, wherein insurance coverage of a laboratory test request is confirmed and displayed to the user to show the user's copayment and any other payment required from the user for a laboratory test request for that user.

In one embodiment as described herein, a method is provided associating a plurality of health care insurances with a user account that is accessible by way of a mobile computing device, wherein insurance priorities in terms of which insurance is charged first is re-orderable by the user and wherein insurance coverage of a laboratory test request is confirmed and displayed to the user to show the user's copayment and any other payment required from the user for a laboratory test request for that user.

In one embodiment as described herein, a method is provided associating a plurality of dependent patient information with a user account that is accessible by way of a mobile computing device, wherein the associating occurs by way of importing name and other identifying information from a contact list already on or accessible from the mobile computing device.

In one embodiment as described herein, a method is provided associating a plurality of medical provider information with a user account that is accessible by way of a mobile computing device, wherein the associating occurs by way of importing name and other identifying information from a contact list already on or accessible from the mobile computing device.

In one embodiment as described herein, a method is provided creating a user account for accessing laboratory test data from a mobile computing device wherein the user is required to: acknowledge reading and understanding text related to medical, acknowledge reading and understanding text related to terms of use; and reading and acknowledging text related to privacy policy; wherein all of the foregoing must be completed before the user account is created.

In one embodiment as described herein, a method is provided capturing an image of a laboratory test request document from a mobile computing device wherein the image is processed after capture to create a corrected image from which data is extracted to include the laboratory test request in association with the user account; wherein the corrected image is created using an image correction algorithm that removes defects in the image associated with fold lines or substantially linear type aberrations in the image; wherein the corrected image is compared to images of known laboratory forms to compare and correct for data captured from the corrected image.

It should be understood that embodiments in this disclosure may be adapted to have one or more of the features described below. In one nonlimiting example, the test menu may be based on where sample will be collected and/or where sample analysis will be conducted. The available tests may be the same in multiple jurisdictions. Optionally, tests from different jurisdictions will have different sets of available tests.

In embodiments, non-transitory tangible computer readable media comprising machine-executable code for implementing methods provided herein may be provided as a stand-alone and transportable product (e.g. a DVD, flash drive, magnetic tape, or other form of removable/insertable computer-readable media), such that the program or software stored thereon can be loaded onto one or more different computers, servers, or other computing devices, in order to implement one or more methods provided herein (or elements thereof). In other embodiments, non-transitory tangible computer readable media comprising machine-executable code for implementing methods provided herein may be provided as part of a computing system involving multiple components (e.g. a server or personal computer). In embodiments, a user may interact with software on a server via a client application running on a user device, which is coupled to the server via a network. For example, the software may include a WWW-based interface to allow a remote user/client to access and view account-related information. In embodiments, software running on a server may provide certain features to a user (e.g. a WWW-based interface), while performing various processes/operations on the server.

In embodiments, provided herein is a laboratory test apparatus taking the form of a machine readable storage medium (e.g., hard disk, CD, or other medium) (or multiple media) which contains a set of software instructions for execution by a processor for performing methods provided herein.

In embodiments, methods provided herein may be implemented using hardware, software, or a combination thereof. In embodiments, software code may be implemented using one or more processors, which may be distributed between one or more computing devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1 and 2 show various embodiments of user interfaces and/or workflows as described herein.

FIGS. 3 and 4 show various embodiments of user interfaces and/or workflows as described herein.

FIGS. 5 to 6C show various embodiments of test result user interfaces and/or workflows as described herein.

FIGS. 7 to 8 show various embodiments for anonymous testing user interfaces and/or workflows.

FIGS. 9 to 10 show various embodiments for appointment creation user interfaces and/or workflows.

FIG. 11 shows various embodiments for returning user appointment creation user interfaces and/or workflows.

FIGS. 12 to 13 show various embodiments for appointment viewing and editing user interfaces and/or workflows.

FIG. 14 shows various embodiments for multiple appointment creation user interfaces and/or workflows.

FIG. 15 shows various embodiments for test reordering user interfaces and/or workflows.

FIGS. 16 to 17 show various embodiments for appointment viewing and editing user interfaces and/or workflows.

FIGS. 18 to 19 show various embodiments for editing user profile information.

FIGS. 20 to 21 show various embodiments of user interfaces and/or workflows related to insurance information for the user.

FIGS. 22 to 24 show various embodiments of user interfaces and/or workflows related to dependent information for the user.

FIGS. 25 to 26 show various embodiments of user interfaces and/or workflows related to payment information for the user.

FIG. 27 shows various embodiments for user interfaces and/or workflows related to changing a password or other security feature(s).

FIG. 28 shows various embodiments for user interfaces and/or workflows related to privacy, terms of use, and/or other use policies.

FIGS. 29 to 34 show various embodiments of user interfaces and/or workflows related to user login, account setup, password recovery, and/or logout.

FIG. 35 shows various embodiments for user interfaces and/or workflows related to scanning of physical laboratory test forms into the system.

FIGS. 36 to 37 show at least one embodiment of user interfaces and/or workflows related to editing user profile(s).

FIGS. 38 to 39 show various embodiments of user interfaces and/or workflows related to insurance information for the user.

FIGS. 40 to 42 show various embodiments of user interfaces and/or workflows related to dependent information for the user.

FIG. 43 shows various embodiments for user interfaces and/or workflows related to emergency contact information.

FIG. 44 shows various embodiments for user interfaces and/or workflows related to searching for specialists.

FIGS. 45 to 46 show various embodiments of user interfaces and/or workflows related to payment information for the user.

FIG. 47 shows various embodiments for user interfaces and/or workflows related to user health condition.

FIGS. 48 to 49 show various embodiments of user interfaces and/or workflows related to adding preferred or user selected doctor information into a user account.

FIGS. 50 to 51 show various embodiments of user interfaces and/or workflows related to adding preferred or user selected patient service center or other sample collection location information into a user account.

FIG. 52 shows various embodiments for user interfaces and/or workflows related to managing appointment expiration alert(s).

FIG. 53 shows various embodiments for user interfaces and/or workflows related to changing a user's password.

FIG. 54 shows various embodiments for user interfaces and/or workflows related to obtaining user feedback on one or more features of the system and/or service.

FIG. 55 shows various embodiments for user interfaces and/or workflows related to policy and terms related to use.

FIGS. 56 to 59 show various embodiments of user interfaces and/or workflows related to user login and/or setup.

FIG. 60 shows various embodiments for user interfaces and/or workflows related to user login and/or unlock screens.

FIGS. 61 to 62 show various embodiments of user interfaces and/or workflows related to existing lab orders, test order details, and/or specifics on certain tests.

FIGS. 63 to 64 shows various embodiments for user interfaces and/or workflows related to panel details.

FIGS. 65 to 66 show various embodiments for user interfaces and/or workflows related to creating a new test order.

FIGS. 67 to 68 show various embodiments for user interfaces and/or workflows related to user information, contact details, and/or doctor search functionality.

FIGS. 69 to 72 show various embodiments for user interfaces and/or workflows related to workflows.

FIG. 73 shows a schematic of a system according to one embodiment described herein.

FIG. 74 shows a schematic of a system according to one embodiment described herein.

FIGS. 75 to 110 show additional embodiments as described herein.

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for a sample collection unit, this means that the sample collection unit may or may not be present, and, thus, the description includes both structures wherein a device possesses the sample collection unit and structures wherein sample collection unit is not present.

As used herein, the terms “substantial” means more than a minimal or insignificant amount; and “substantially” means more than a minimally or insignificantly. Thus, for example, the phrase “substantially different”, as used herein, denotes a sufficiently high degree of difference between two numeric values such that one of skill in the art would consider the difference between the two values to be of statistical significance within the context of the characteristic measured by said values. Thus, the difference between two values that are substantially different from each other is typically greater than about 10%, and may be greater than about 20%, preferably greater than about 30%, preferably greater than about 40%, preferably greater than about 50% as a function of the reference value or comparator value.

As used herein, a “sample” may be but is not limited to a blood sample, or a portion of a blood sample, may be of any suitable size or volume, and is preferably of small size or volume. In some embodiments of the assays and methods disclosed herein, measurements may be made using a small volume blood sample, or no more than a small volume portion of a blood sample, where a small volume comprises no more than about 5 mL; or comprises no more than about 3 mL; or comprises no more than about 2 mL; or comprises no more than about 1 mL; or comprises no more than about 500 μL; or comprises no more than about 250 μL; or comprises no more than about 100 μL; or comprises no more than about 75 μL; or comprises no more than about 50 μL; or comprises no more than about 35 μL; or comprises no more than about 25 μL; or comprises no more than about 20 μL; or comprises no more than about 15 μL; or comprises no more than about 10 μL; or comprises no more than about 8 μL; or comprises no more than about 6 μL; or comprises no more than about 5 μL; or comprises no more than about 4 μL; or comprises no more than about 3 μL; or comprises no more than about 2 μL; or comprises no more than about 1 μL; or comprises no more than about 0.8 μL; or comprises no more than about 0.5 μL; or comprises no more than about 0.3 μL; or comprises no more than about 0.2 μL; or comprises no more than about 0.1 μL; or comprises no more than about 0.05 μL; or comprises no more than about 0.01 μL.

As used herein, the term “point of service location” may include locations where a subject may receive a service (e.g. testing, monitoring, treatment, diagnosis, guidance, sample collection, ID verification, medical services, non-medical services, etc.), and may include, without limitation, a subject's home, a subject's business, the location of a healthcare provider (e.g., doctor), hospitals, emergency rooms, operating rooms, clinics, health care professionals' offices, laboratories, retailers [e.g. pharmacies (e.g., retail pharmacy, clinical pharmacy, hospital pharmacy), drugstores, supermarkets, grocers, etc.], transportation vehicles (e.g. car, boat, truck, bus, airplane, motorcycle, ambulance, mobile unit, fire engine/truck, emergency vehicle, law enforcement vehicle, police car, or other vehicle configured to transport a subject from one point to another, etc.), traveling medical care units, mobile units, schools, day-care centers, security screening locations, combat locations, health assisted living residences, government offices, office buildings, tents, bodily fluid sample acquisition sites (e.g. blood collection centers), sites at or near an entrance to a location that a subject may wish to access, sites on or near a device that a subject may wish to access (e.g., the location of a computer if the subject wishes to access the computer), a location where a sample processing device receives a sample, or any other point of service location described elsewhere herein.

It should also be understood that for any and all of the user interface figures shown herein, a blue circle may be used to indicate where a user may tap, click, or otherwise select an object, item, or other feature visible on a user interface.

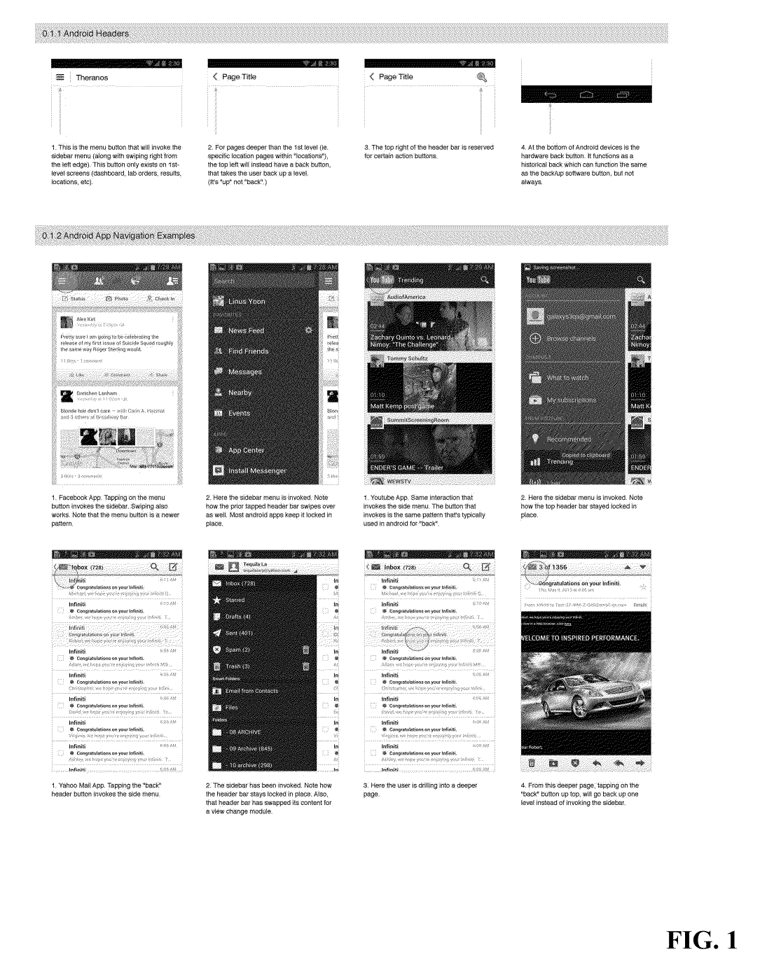

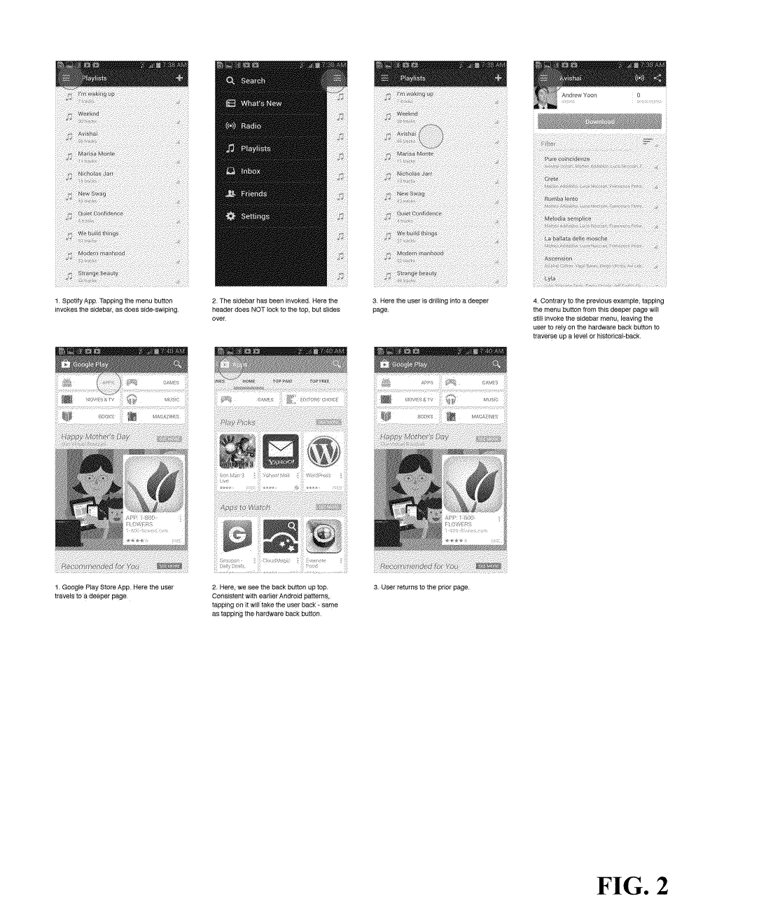

Referring now to FIGS. 1 and 2, various screenshots are shown of user interfaces for a client computing unit. In one non-limiting example, the unit may be a tablet computer. Optionally, it may be a handheld computer. Optionally, it may be a cellular telephone. Optionally, it may be a smartphone. Other examples of mobile and/or portable computing devices including wearable computing devices are not excluded.

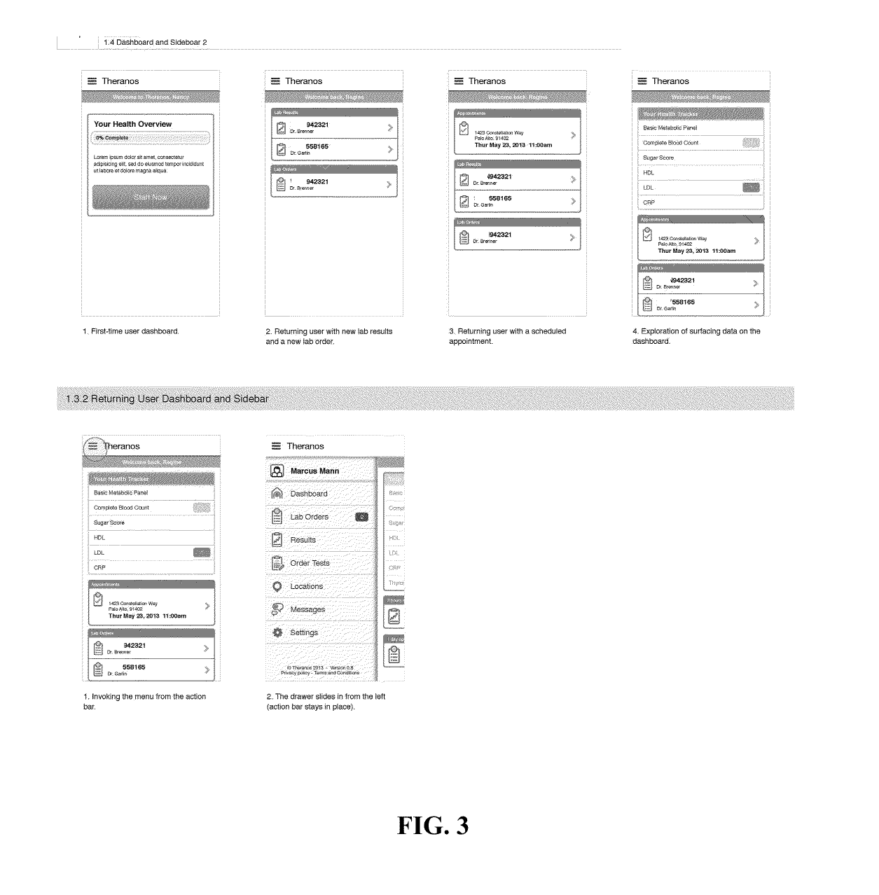

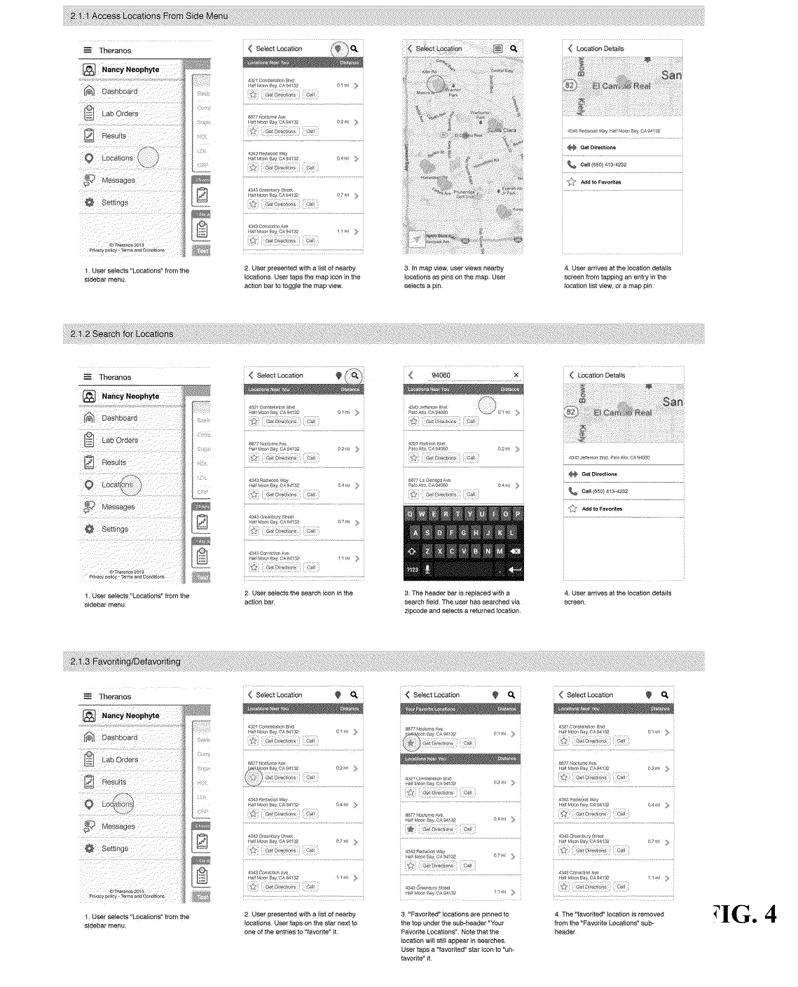

Referring now to FIG. 3, one embodiment of a user interface is shown for various dashboard pages for first time user, a returning user with new lab results and a new lab order, and/or a returning user with a scheduled appointment. On the returning user page, some embodiments may also include links to past laboratory or other test results and/or to pending laboratory orders. FIG. 3 also shows that in at least some embodiments, there may be a screen showing a health tracker, dashboard, or status page associated with one or more user, medical professional, drug company, and/or other party selected factors to display regarding a patient's health and/or other specific condition. As seen in FIG. 3, the page showing the health tracker and/or status page may have color codes associated with certain factors that may be in caution or other alert level. Some embodiments may also include numeric values or other more detail information displayed in, next to, near, or otherwise associated with the color coded area. FIG. 3 also shows that the health tracker, dashboard, or status page may also include information about any upcoming appointments and/or laboratory orders.

FIG. 3 also shows that by tapping on an icon or other symbol, a user can also reveal or invoke a menu showing navigation. As seen in FIG. 3, some embodiments show a variety of actions or options available for the user. By way of example and not limitation, the menu may slide out from one side of the screen, from the top down, from the bottom up, and/or may fade-in. In one non-limiting example, the tabs shown in the menu can be as shown or can include additional categories not shown. Optionally, it can also show fewer tabs. As seen in FIG. 3, some embodiments may still show a portion of the underlying page (in this example, showing the health tracker page) either shifted to one side of the menu, or optionally, covered by the menu.

Referring now to FIG. 4, still further aspects of various user interface embodiments will now be described. FIG. 4 shows that from one tab on the menu (in this example, the location tab), one can select the category to provide additional information. Herein the user can be presented with a list of nearby locations based on GPS location provided by the phone or other location information (such as but not limited to wifi based location or additional systems for providing location not based exclusively on GPS). On the listing page, contacting the map icon can also provide a map view of the locations from which details on that particular location can be displayed on the user interface.

FIG. 4 also shows that if one desires to locate locations not near the current location of the user, then there is an option to engage the search icon to enter other information such as but not limited to zip code, street, city, state, etc. . . . to provide a new list of locations based on the provided information.

FIG. 4 also shows that there may be options to favorite or otherwise store preferred locations such that they can be retrieved by the device and/or marked to be shown as such.

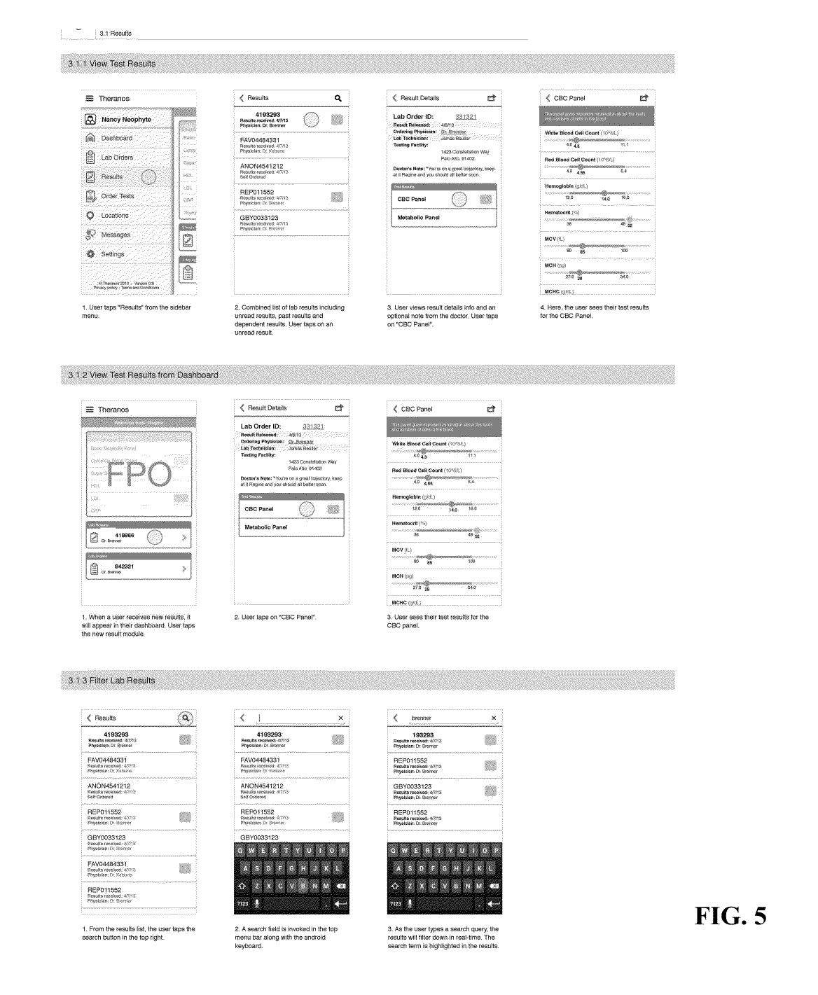

Referring now to FIG. 5, further aspects of various user interface embodiments will now be described. This embodiment shows that selecting the “results” category allows the user to show a list of result including but not limited to unread results, past results, and/or dependent results. Optionally, the number displayed can indicate the number of results that may be out of the normal range. Optionally, the number itself, the background, and/or foreground colors can be selected to correspond to an urgency of response (yellow, red, etc. . . . ). In this embodiment, the results page can show the results summary of various panels, color indicated number or area for out-of-normal results, and/or comments from a medical professional. As seen in FIG. 5, if there are no out-of-normal results, no color indicator and/or number may be used to show that results were acceptable. Optionally, some embodiments may indicate visually by color (green or other positive-connotation color), shape, and/or text that the results were acceptable.

FIG. 5 shows that on the detail page for the test results of a specific panel (in this example, the CBC panel), specific details of the test results are shown. For tests results where the output is a numeric value, the value and/or a position indicator of that value for results in an acceptable range can be shown. By way of non-limiting example, the data range of results can be normalized so that the normal “green” range is the same width and/or other dimension on the display. As seen in FIG. 5, by normalizing the width of the normal “range” for test results, a user can visually access where their results are in one analyte or category in comparison to other results for other analyte(s) and/or categories. In this particular embodiment shown in FIG. 5, a user can view the results and by viewing the results from the top to bottom or vice versa, can get a qualitative sense of where they stand in terms of their test results being in the normal range. By way of non-limiting example, results outside the range can be indicate by number, font size, font style, color and/or other indicator to show that they are not in the normal range. It should also be understood that although this example shows the results using horizontal bars, some embodiments may use vertical bars and/or other graphing techniques to display the results. Normalization of ranges can also be used in those other graphical presentations. Of course, it should be understood that display of results in a non-normalized manner is not excluded. Optionally, some may normalize ranges for a portion of the results and not all of them. It should also be understood that the ranges can be generic ranges, ranges based on the particular patient, this particular patient class, and/or some other selection criteria. It should be understood that some embodiments may use a mix of individual, class, and/or other criteria based ranges for the test results.

FIG. 5 also shows that for at least some embodiments, when new test results are received, a user can receive that notice in the dashboard and/or in the activity/update icon on the device status bar or other area where the device may indicate a new message or other activity has occurred. FIG. 5 shows that the user can more quickly navigate directly to the test result details from the dashboard page, instead of having to show a listing of all test results and then selecting from that list.

FIG. 5 also shows that for at least some embodiments, the user can also search the results based on variables such as text and/or other information in the test results. Optionally, the results can be filtered in real-time as the user enters the search query. Optionally, some embodiments may only show the results after the query is submitted by the user. Instead of text, some searches can be based on other criteria such as but not limited to only those results with out-of-range results, panic results, and/or other criteria which may be based on text entry, drop-down menu entry, check boxes, and/or other selection technique.

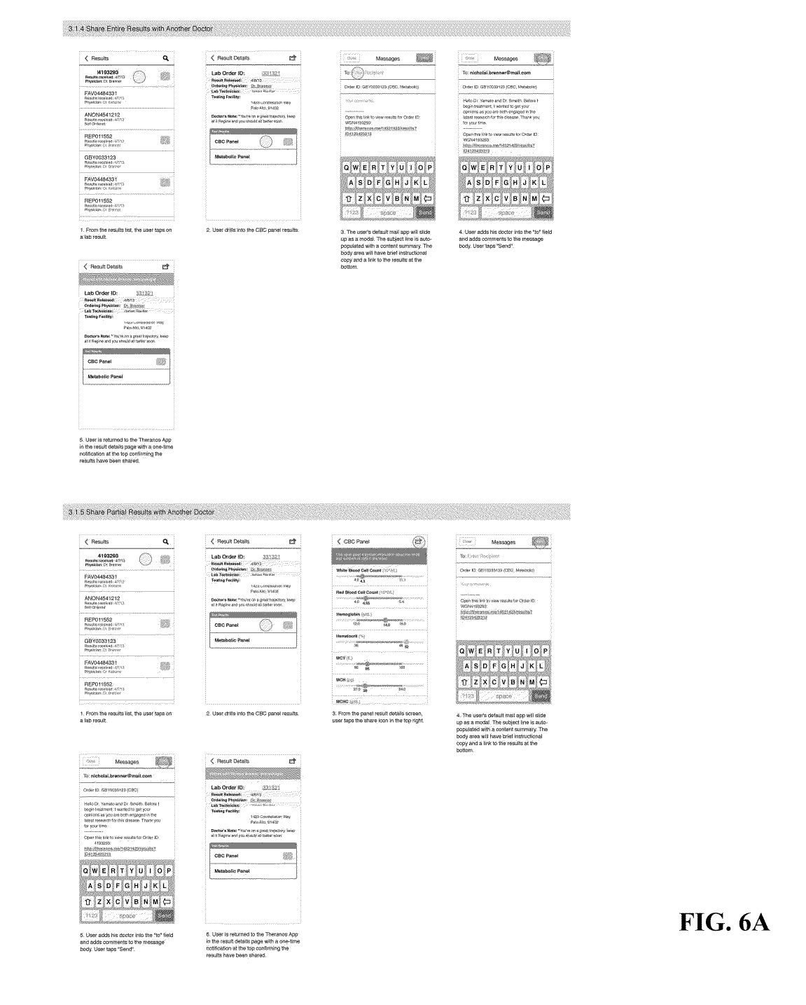

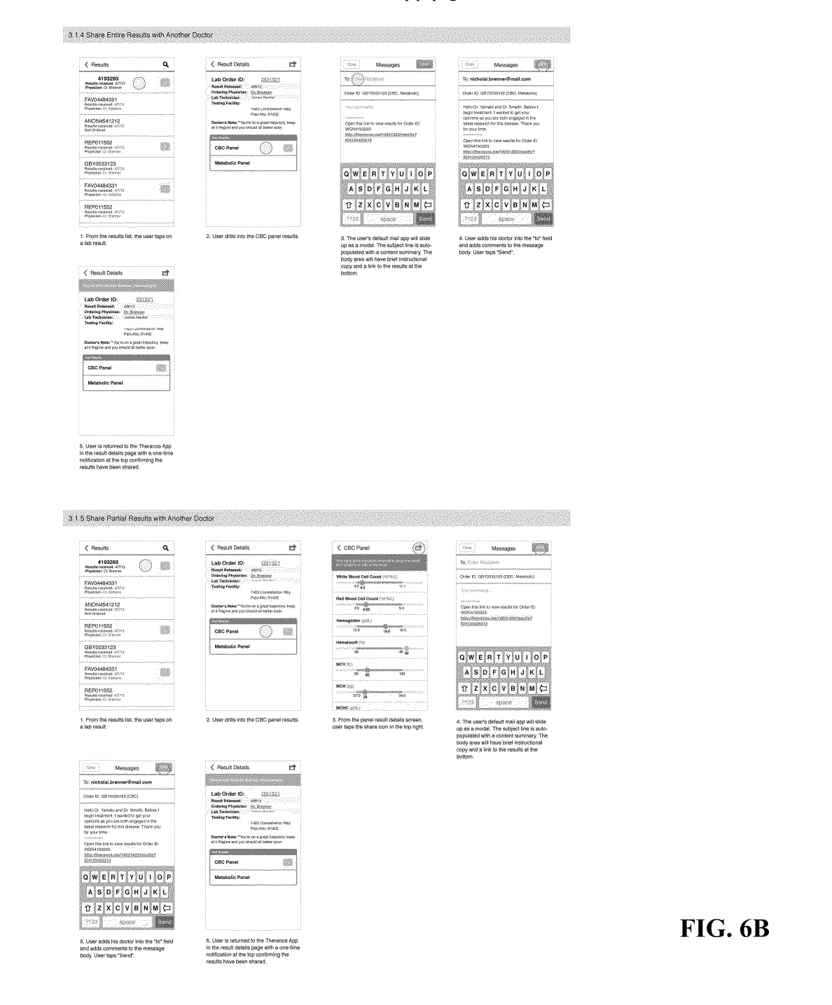

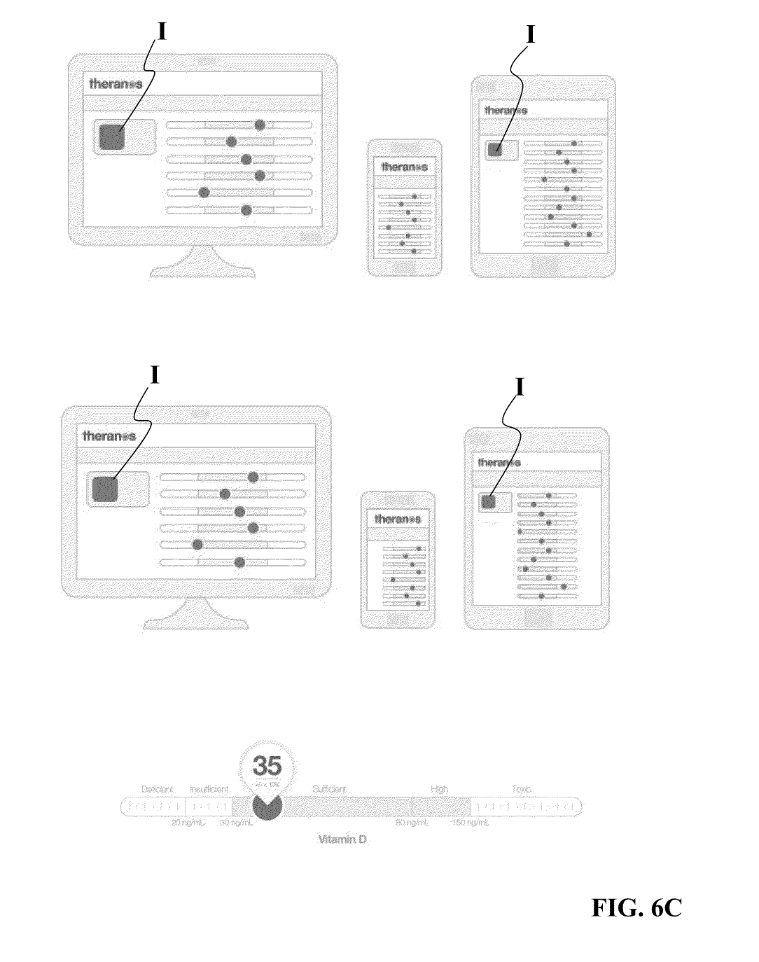

Referring now to FIGS. 6A and 6B, still further aspects of various user interface embodiments will now be described. FIG. 6A shows that some embodiments may be able to allow a user to share full or partial results with another medical profession, which may be different from the medical profession or other entity that ordered the test. By way of non-limiting example, there may be an icon that is used to initiate the mailing of results to another party such as but not limited to a medical professional. Optionally, some embodiments may be configured such that the information can only be sent to another party that is a medical professional or otherwise authorized to receive a user's private health information. After sharing, there may be a process for confirming to the user that the information has been shared. Optionally, some embodiments may also include information (visual or otherwise) noting which results have been shared. As seen in FIG. 6B, text or other information can also be entered by the user to accompany the results. Optionally, the results can be sent directly to the other party or a link may be sent to the other party that will connect to display the actual results.

Referring now to FIG. 6C, it should be understood that the test results can be displayed on any of various devices a user may use to access their test results. FIG. 6C shows that the user's test results can be shown on a personal computer, a mobile phone, and/or a tablet computer. FIG. 6C also shows that the results may have an overall color or other indicator I of test results being in range. If a certain number of tests results are out of range, then the indicator I can show a different color, text, or other indicator to let the user know that the overall results were of a concern. By way of non-limiting example, the number or other factor that results in this change in indicator I can be set by a medical professional, by the user, by a laboratory, and/or by another authorized entity. As seen in FIG. 6C, some smaller sized user interfaces can simply adjust the display so that the results are still shown, but indicator I may be removed or otherwise shown. Some optional methods for indicator I can be a change in color or text I in the title bar, background, or other screen area. Some embodiments can change the color of the dots, data markers, test value, or the like on the data displayed to indicate if the reading is one of concern. For example, some may use the usual red, yellow, and green for test result colors. Optionally, some may use other colors in that spectrum leading from green to red, wherein red is an undesirable test result. Some embodiments can change the color of letters or in the present embodiment, the color of the dot in the logo so that it can go from green, to yellow, and/or to red if the results of the tests are on-balance in an undesirable range.

FIG. 6C also shows that in some embodiments, the data range change be shifted so that the out-of-range results are highlighted such as but not limited to a) showing primarily the high results if that is where the out-of-range results are, b) showing primarily the low results if that is where the out-of-range results are, and/or c) the entire range if there are both high and low out-of-range results. For out-of-range results, in addition or in place of changing the color of the dot, number value, or other data marker, some embodiments may change the entire color of the bar, the height of the bar, the width of the bar, highlight the background of the bar, and/or other visual indicator.

Referring still to FIG. 6C, it should be understood that some embodiments may have more detailed scale bars or lines such that there are descriptors of deficient, insufficient, high, toxic, or the like for various out-of-range test results. In this manner, a user can, in addition to color or other indicator, have a text descriptor of how the results compare. It should also be understood that some embodiments can have a balloon-pop-up or marker for the test result. By way of non-limiting example, this pop-up can include the numeric value for the test result and/or include the coefficient of variation or other additional information about the test result numeric value.

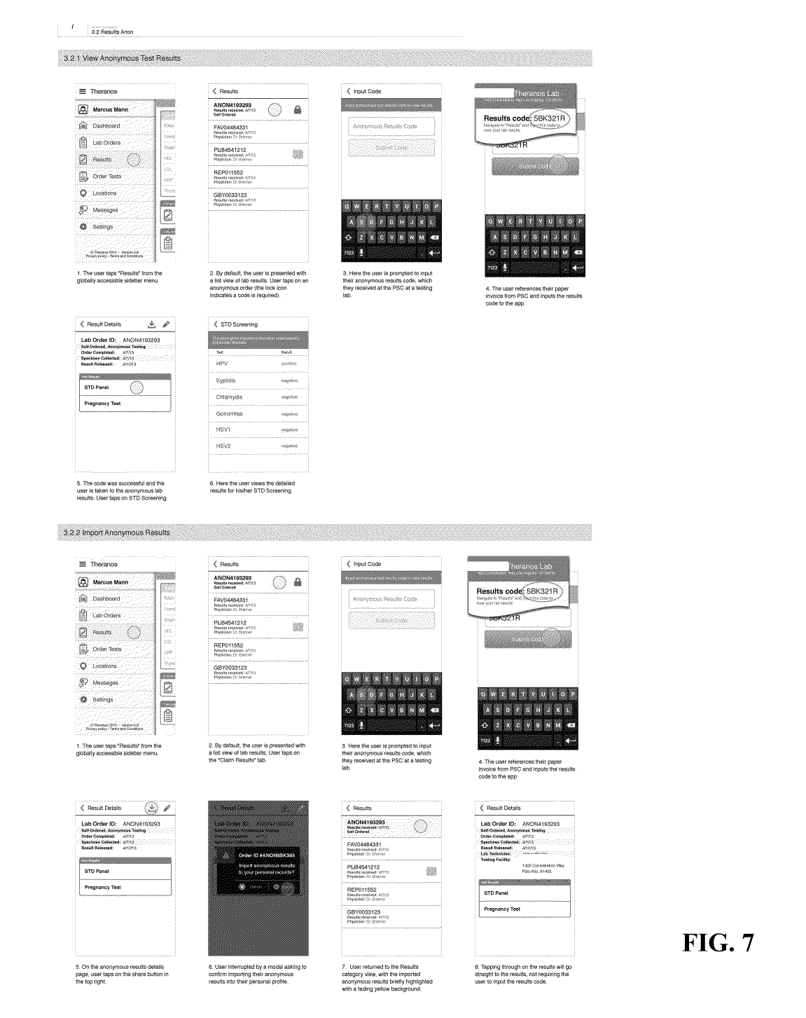

Referring now to FIG. 7, still further aspects of various user interface embodiments will now be described. FIG. 7 shows various techniques for viewing anonymous testing results. In one embodiment, a user can see from the list of test results that one of them is for an anonymous test. A user can prompted to input a code, unlock pattern, other passkey, fingerprint, retinal scan, biomarker, or other unlock credential to present the test data. Optionally, it should be understood that when a biomarker or fingerprint is used, it does not reveal the user identity, only that the fingerprint, retinal scan, or biomarker matches the one used to initiate the anonymous testing. Once the results code or other unlock code is verified, the user is shown the page listing the laboratory panels for the anonymous testing. Selecting the one or more panels will then reveal the exact test results for the screen conditions. Optionally, once the results code or other unlock code is verified, the test results may be directly displayed, without having to view the test panel page. Optionally, some embodiments may have an entirely separate page for anonymous results which can only be displayed upon entry of user unlock credential which may be the same or different for unlock credentials for the underlying test. In this manner, the anonymous test results are not shown in the list of regular test results and thus does not raise suspicions that any anonymous testing has occurred if another party sees the test results listing page.

Optionally, as seen in FIG. 7, some embodiments may prompt the user to query whether they want to import their anonymous testing results into the user's personal profile. Optionally, the user may continue to set (by default or opt-in) the anonymous test results such that they can only be viewed by entry of an unlock credential. In this manner, even importing the results into a user profile does not remove all security features for the results. Optionally, the user may select to remove one or more of the security features.

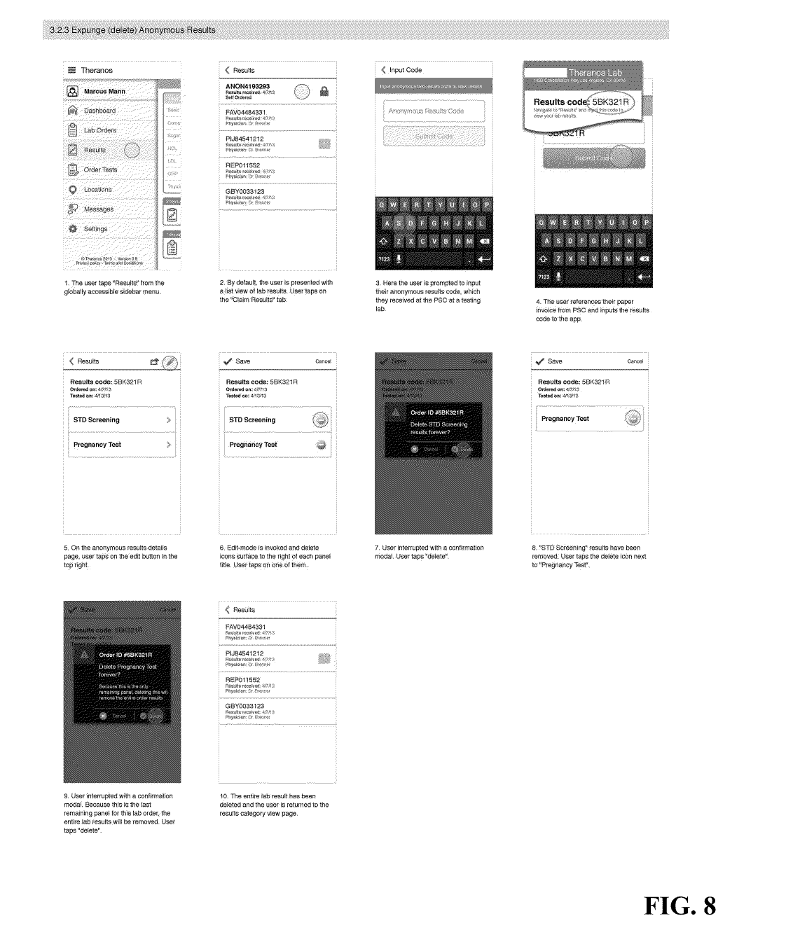

Referring now to FIG. 8, still further aspects of various user interface embodiments will now be described. This embodiment shows that from the test results page, one can delete the anonymous test results by selecting the edit option. As seen in FIG. 8, depending on user settings, one may still be prompted to enter information to unlock the anonymous testing results. In one embodiment, the deletion of results is permanent and not reversible. Optionally, some may be reversible for a set time period. Optionally, some may be reversible within a set time period and upon entry of unlock credentials. As seen in FIG. 8, deleted results will no longer appear on the results screen.

### Creating Appointments

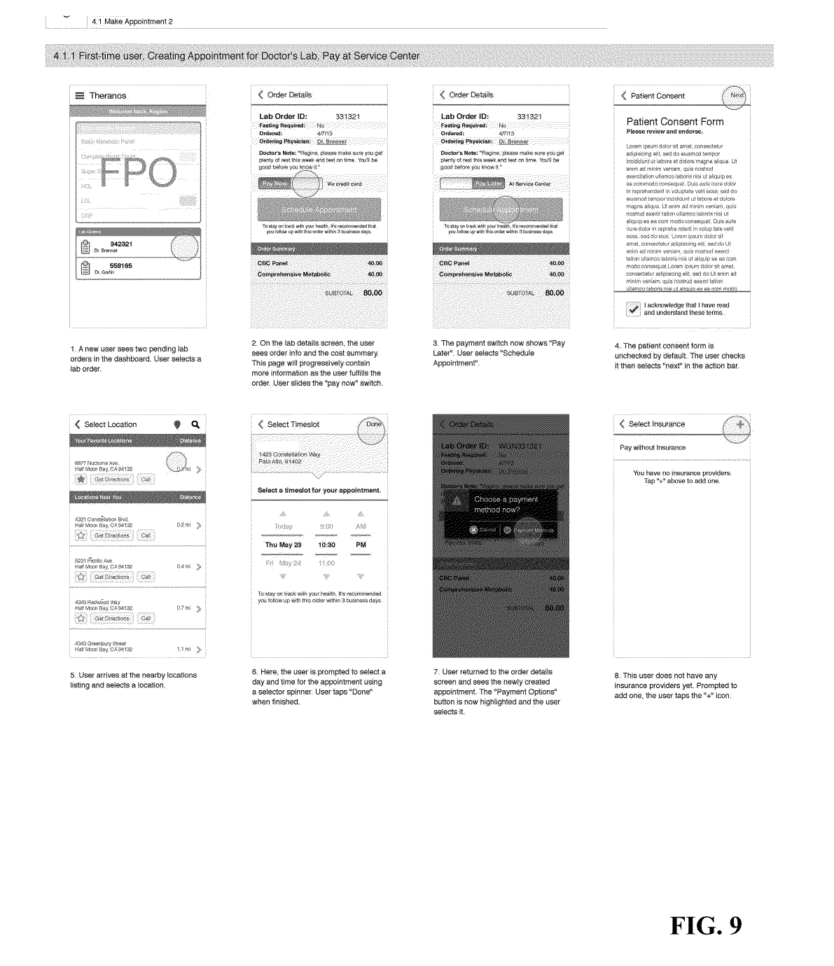

Referring now to FIG. 9, still further aspects of various user interface embodiments will now be described. FIG. 9 shows one embodiment of user interfaces that may be displayed on a device to allow a user to create an appointment for a laboratory test, based in part on a lab order that is already associated with the user. FIG. 9 shows that in this embodiment, a user can select to pay for the test at the patient service center where the sample will be drawn.

FIG. 9 also shows that the user can be requested to acknowledge that they have read and understood the patient consent form. In some embodiments, the check box or other confirmation device for acknowledgement may only appear after the user has scrolled through the entire patient consent form. Optionally, some embodiments may have check box or other acknowledgement visible and selectable by the user from the outset, without requiring the user to scroll through the entire text portion of the patient consent form.

In this embodiment, the user can also select the location for performing the sample collection. As seen in FIG. 9, the list may include locations near the user's current location, locations near a location selected by the user, locations near a default location, and/or favorite or other preferred locations set by the user or based on location that the user has visited or used in the past. Optionally, once a location is selected, a time slot can also be presented for the user to select their preferred locations. Optionally, some embodiments may have the user select a time slot (or slots or time ranges) and then only present those locations that have availability. Optionally, the user may opt to view a calendar of open slots for a location or locations. This allows a user to review a variety of different factors and select a time slot based on multiple factors such as different day, time appointments are available, location, and/or other services available at that location. Optionally, some locations may only have certain types of testing or collection available and location presented can also limited to displaying only those that can perform tests noted in the lab order. Optionally, all locations can be presented but certain locations can be noted as ones with all testing or collection capability or only select capability.

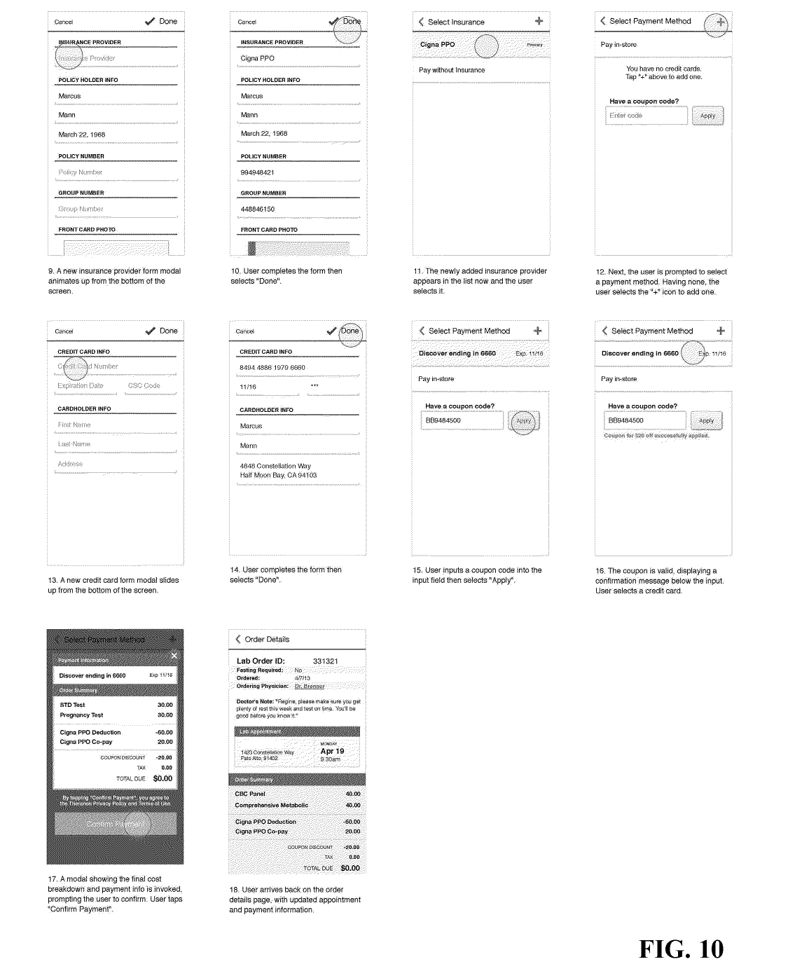

As seen in FIG. 9, the payment option may include “pay without insurance” if no insurance information has been entered into the system. Optionally, if insurance information is already entered, it can be selected as a choice for payment. Optionally, if the user desires to enter insurance information, they can do so on this screen by selection of an icon or other marker to take the user to that screen as seen in FIG. 10.

Referring now to FIG. 10, still further aspects of various user interface embodiments will now be described. FIG. 10 shows various user interfaces for the entry of insurance information, coupon codes, credit card information, pay at store, pay using a swiped credit card, and other payment services for use in payment for services to be provided. Optionally, the system may have a final cost breakdown showing payment information per line item and then requesting that the user confirm payment. After payment information is provided, a user may arrive at the order details page with updated appointment and payment information.

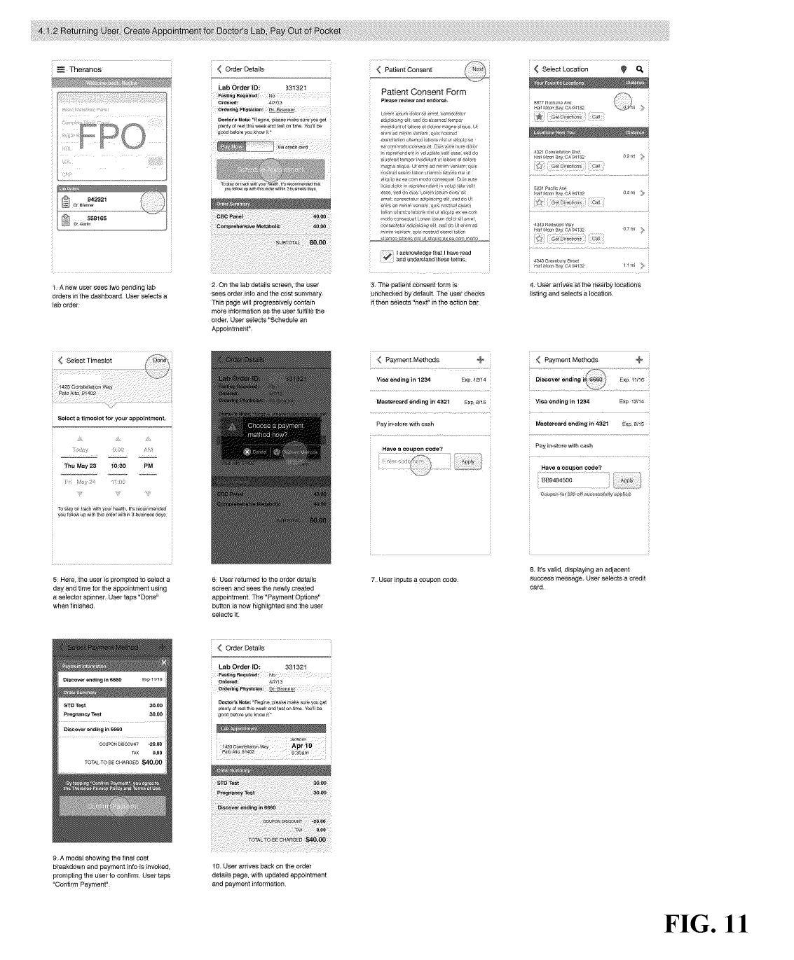

Referring now to FIG. 11, still further aspects of various user interface embodiments will now be described. The various screenshots here show how a returning user with payment information already in the system can set-up appointments. After all information is provided, a user may arrive at the order details page with updated appointment and payment information.

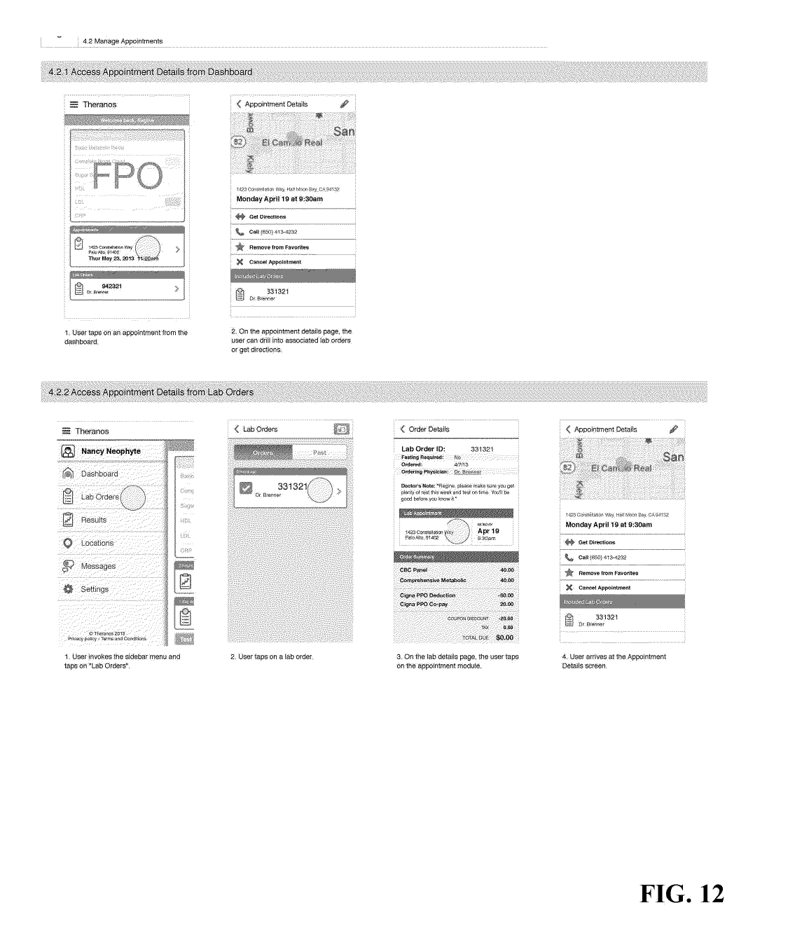

Referring now to FIG. 12, still further aspects of various user interface embodiments will now be described. FIG. 12 shows access appointment details from the dashboard. A user tapping on an appointment from the dashboard can bring up an appointment details page where the user can drill into associated lab orders or get directions.

FIG. 12 also shows that user can access appointment details by selecting the lab order, where on the lab order details page, the user can select the lab appointment area. This brings the user to the appointment details screen.

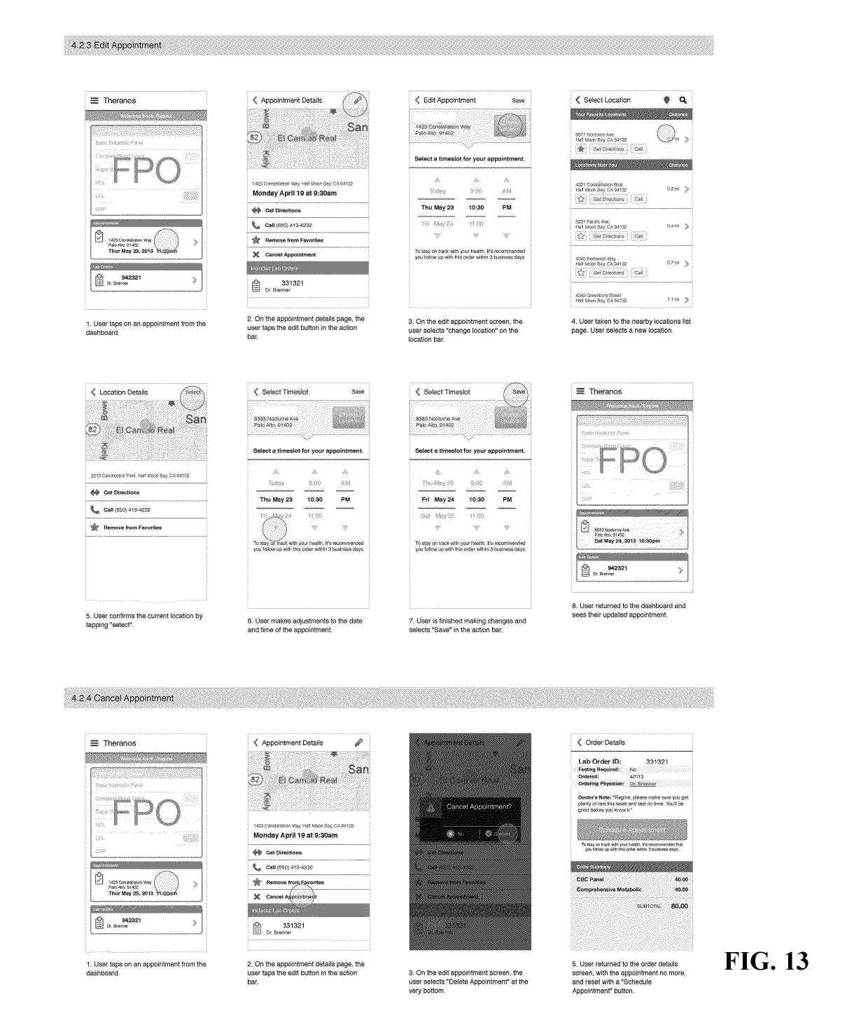

Referring now to FIG. 13, still further aspects of various user interface embodiments will now be described. FIG. 13 shows that user can edit an appointment. Using at least one of the above techniques to arrive at the payment page, one can then change location, change time of the appointment or the like. Optionally, the changing of location can also present a new set of appointment times. Optionally, the changing of appointment times may present a new list of locations with availability for those appointment time(s). Some embodiments may allow for the selection of ranges of dates and/or times. Optionally, some embodiments may allow for calendar view of available slots at one or more locations, which can be useful if the user has a schedule that is not restricted to specific times.

FIG. 13 also shows that there can be options for canceling an appointment. As seen in FIG. 13, once a user is on the appointment details page, the options to edit the page includes canceling the appointment. Optionally, some embodiments may have the cancel appointment option on the dashboard as an icon or other item that is more directly accessible to the user. Once an appointment is canceled, the status of the lab order returns to the prior condition such as but not limited to “schedule appointment” or the like.

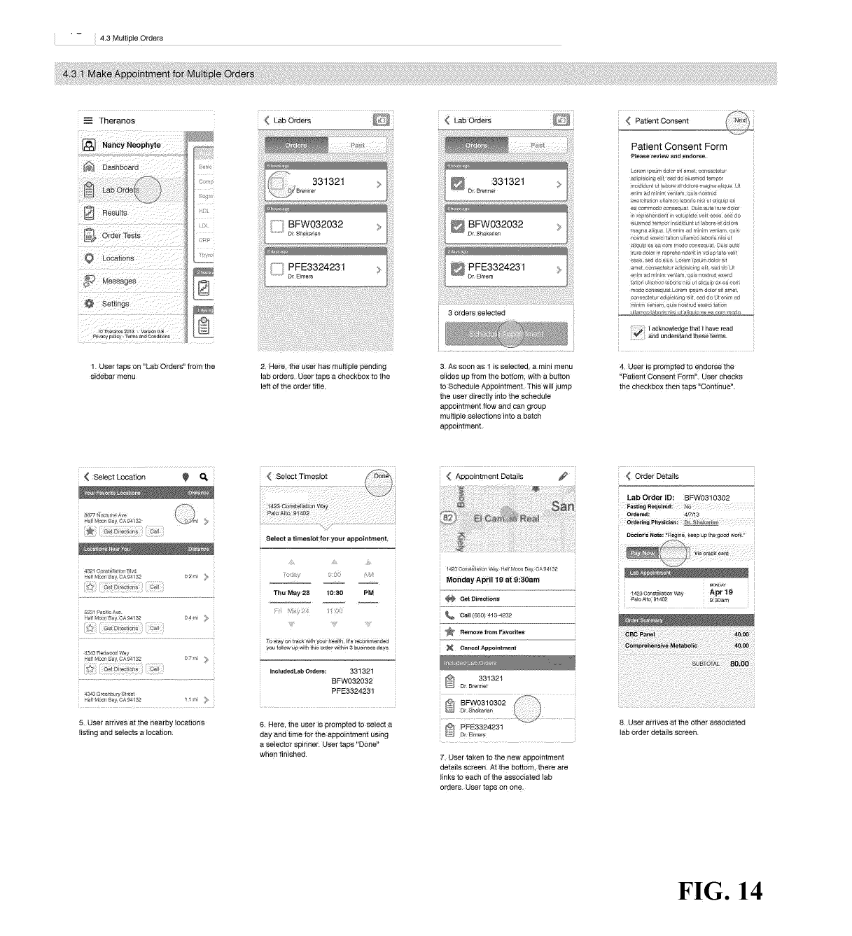

Referring now to FIG. 14, still further aspects of various user interface embodiments will now be described. FIG. 14 also shows that one can on a single screen set the appointment for a plurality of laboratory orders. It should be understood that these orders can be from the same or different medical professionals. It should also be understood that these orders can be from the same or different medical organizations. In this manner, the sample collection for laboratory orders can be done at one location while the results can be for a plurality of different medical professionals/organizations. As seen in FIG. 14, the selection of multiple laboratory orders can be done by selecting checkboxes for each of the laboratory orders, or optionally, some embodiments are configured to default to select all open laboratory orders for that user, with an opt-out to un-select those orders that the user does not want to set for appointment.

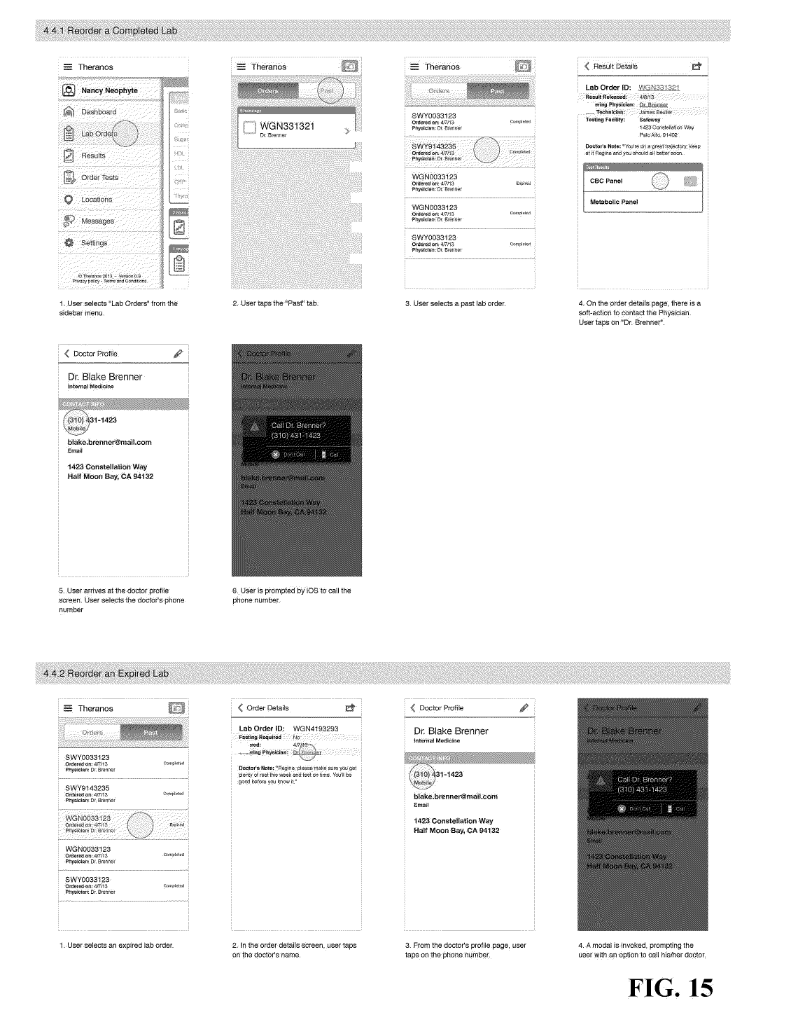

Referring now to FIG. 15, still further aspects of various user interface embodiments will now be described. FIG. 15 shows that in some embodiments there is a short cut or reduced number of steps to reorder a completed or previous lab test. Optionally, in some embodiments, there is a short cut or reduced number of steps to reorder an expired lab test. As seen in FIG. 15, some embodiments may present an option to call the medical professional to discuss any concerns or issues.

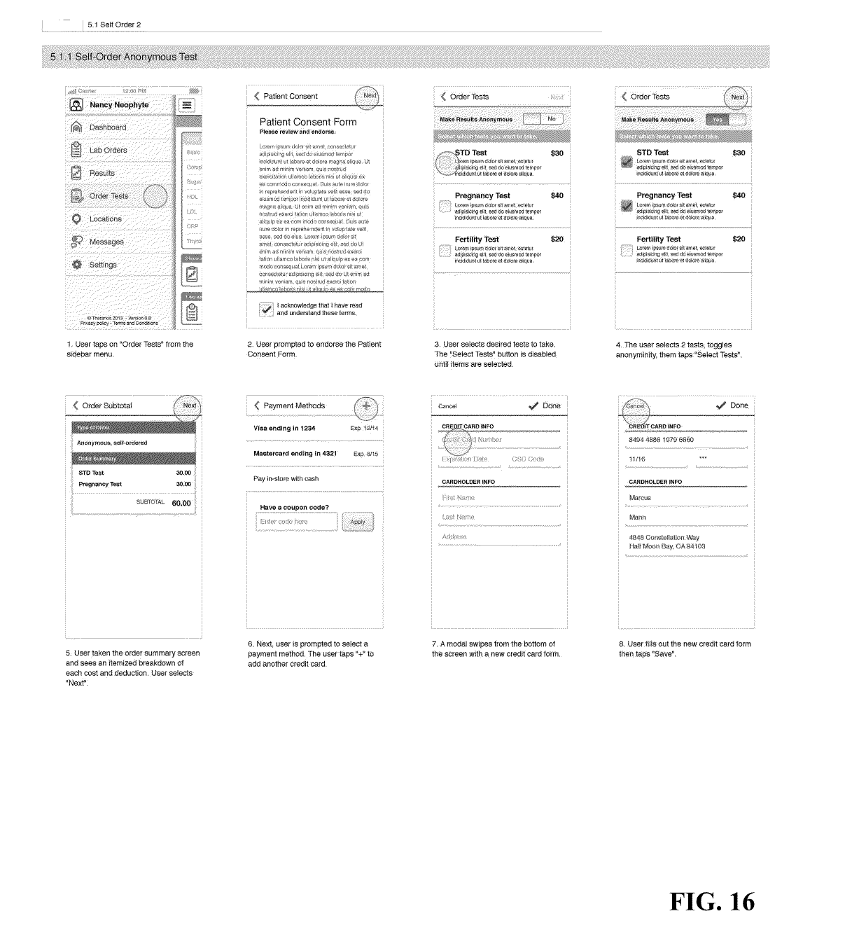

Referring now to FIG. 16, still further aspects of various user interface embodiments will now be described. FIG. 16 shows how a user can self-order an anonymous test. As seen in FIG. 16, the test order page can show a plurality of tests that can be ordered under an anonymous basis. Optionally, a regular test menu can also be shown in some embodiments, wherein the “make results anonymous” option can anonymize those tests that have that option available. In this manner, the anonymous testing feature can be activated after tests are selected, instead of vice versa where the anonymous option is first selected and then a panel of anonymous tests is provided. Optionally, even when the anonymous test option is selected first, some embodiments herein can allow for the addition of one or more non-anonymous test after the desired test or tests are selected from the anonymous panel.

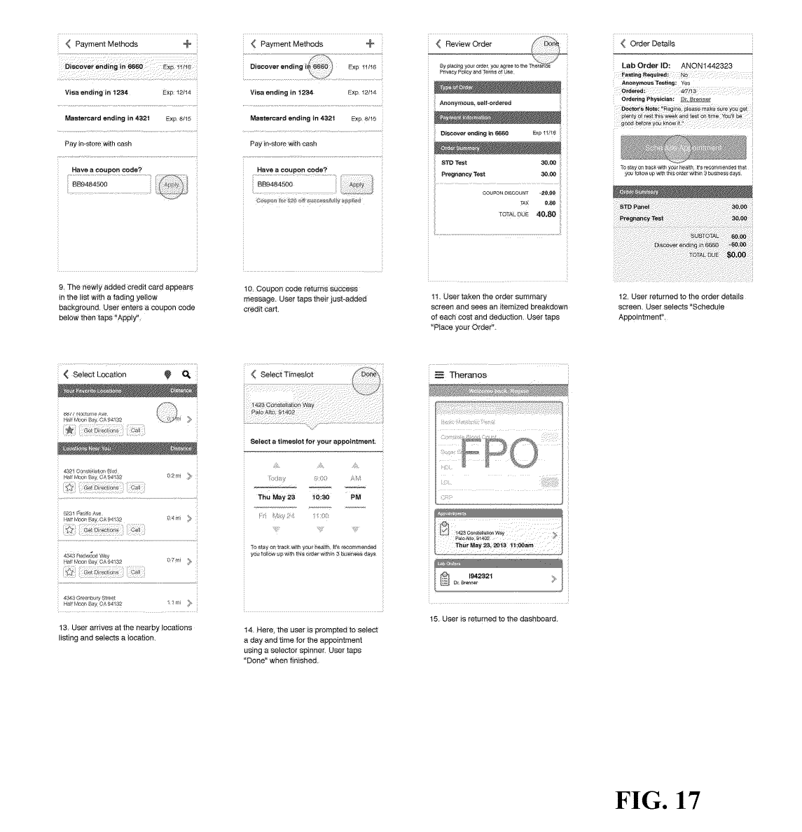

FIG. 17 continues the process shown in FIG. 16 wherein the anonymous testing is shown with pricing of each test displayed to the user at the review order screen. Again, in this particular embodiment, the order details page shows the pricing of test(s). FIG. 17 shows that the user can schedule the appointment as part of the process related to creating and/or paying for the laboratory order.

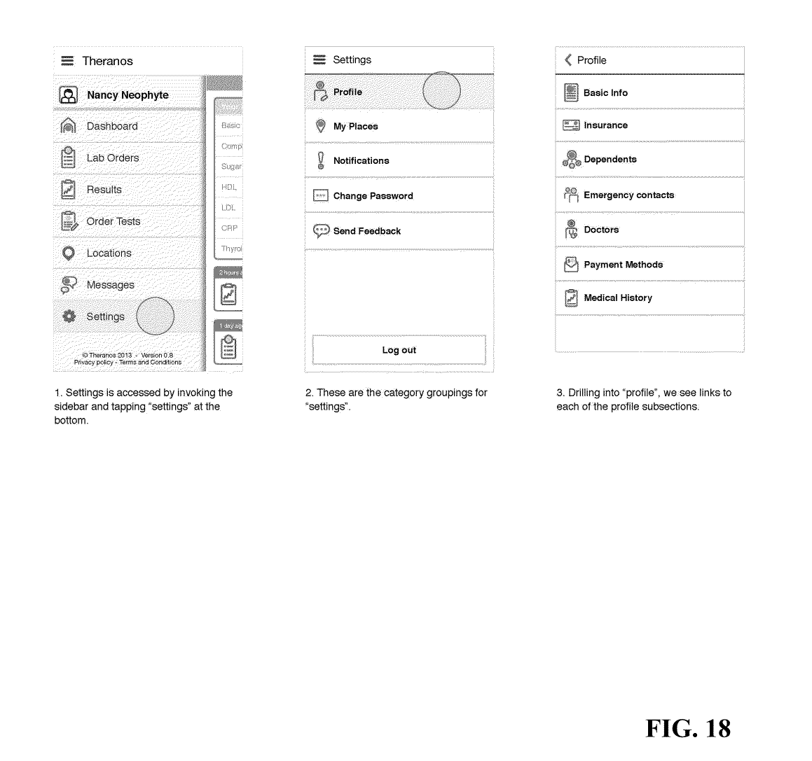

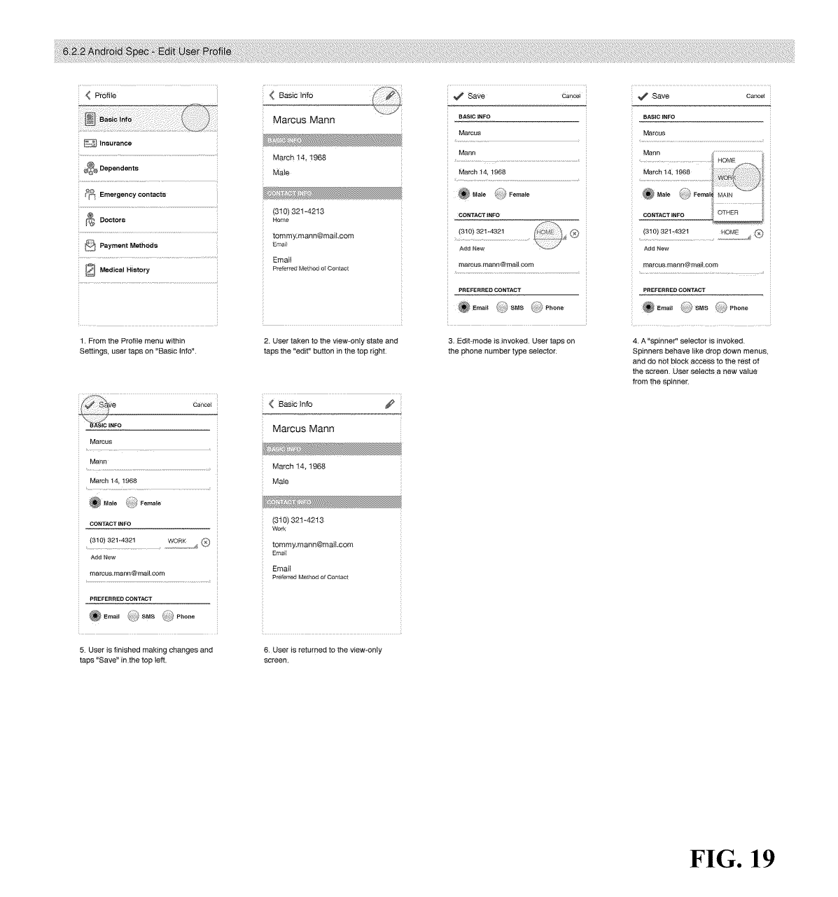

Referring now to FIG. 18, still further aspects of various user interface embodiments will now be described. FIGS. 18 to 19 show one non-limiting example of how to edit user profile information. FIG. 19 shows how a spinner selector can be invoked. A spinner may be similar to a drop down menu in that they do not block access to the rest of the screen.

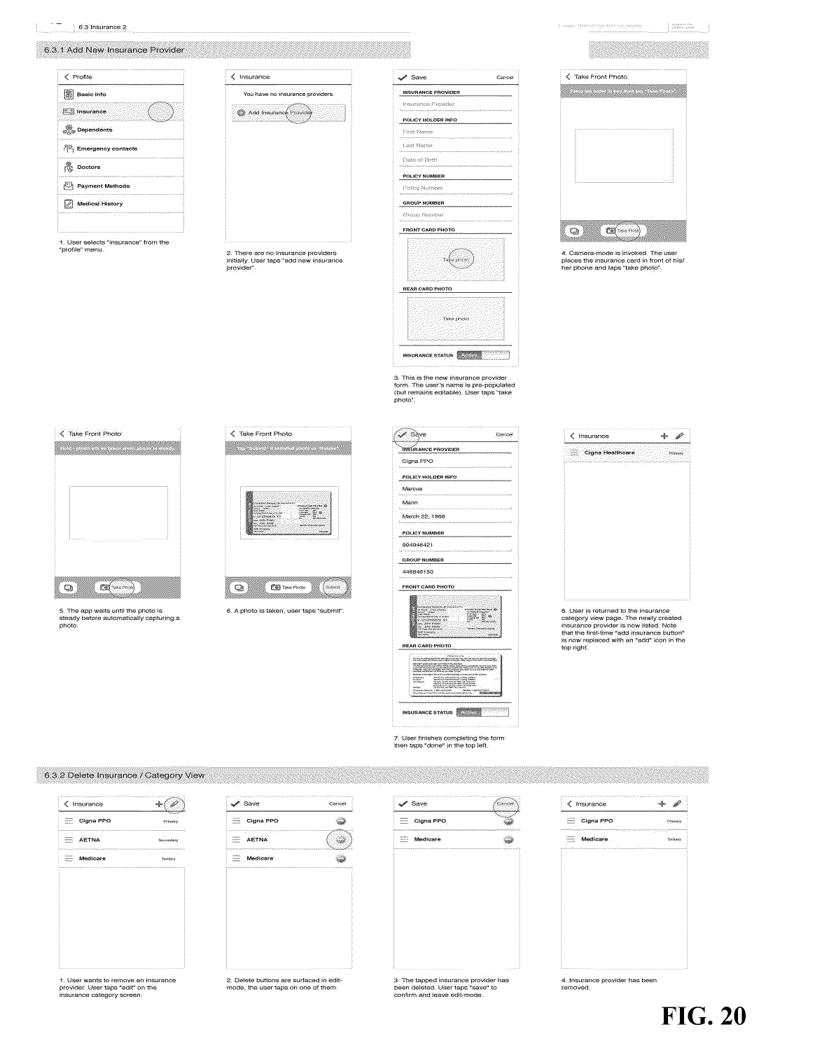

Referring now to FIG. 20, still further aspects of various user interface embodiments will now be described. FIG. 20 shows how it is possible to auto-populate information, such as but not limited to insurance provider information by capturing an image of the insurance provider card. As seen in FIG. 20, in this non-limiting example, the user may select if the image will be of the front or the rear of the card. Optionally, some embodiments may not need the user to select which side of the card is being imaged; the system will extract information from the image and use as appropriate. As seen in FIG. 20, the user in at least some embodiments, can also set whether the insurance status is active or not. FIG. 20 also shows that there may be a user interface for removing insurance information for a user account.

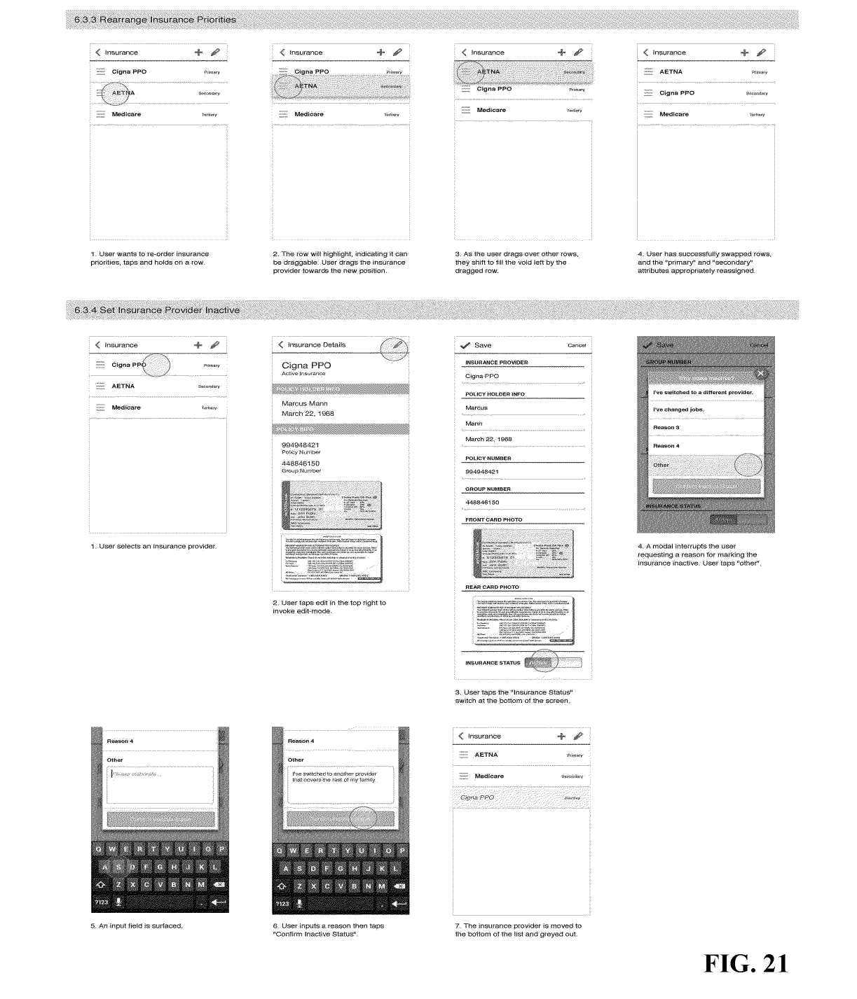

Referring now to FIG. 21, still further aspects of various user interface embodiments will now be described. FIG. 21 shows that a user can also re-order the insurance priorities in the account such that primary, secondary, tertiary, and/or other designations can be associated with the various insurance and/or payment options. FIG. 21 also shows that one can set the insurance for one of the primary, secondary, tertiary, and/or other designated insurance to be inactive.

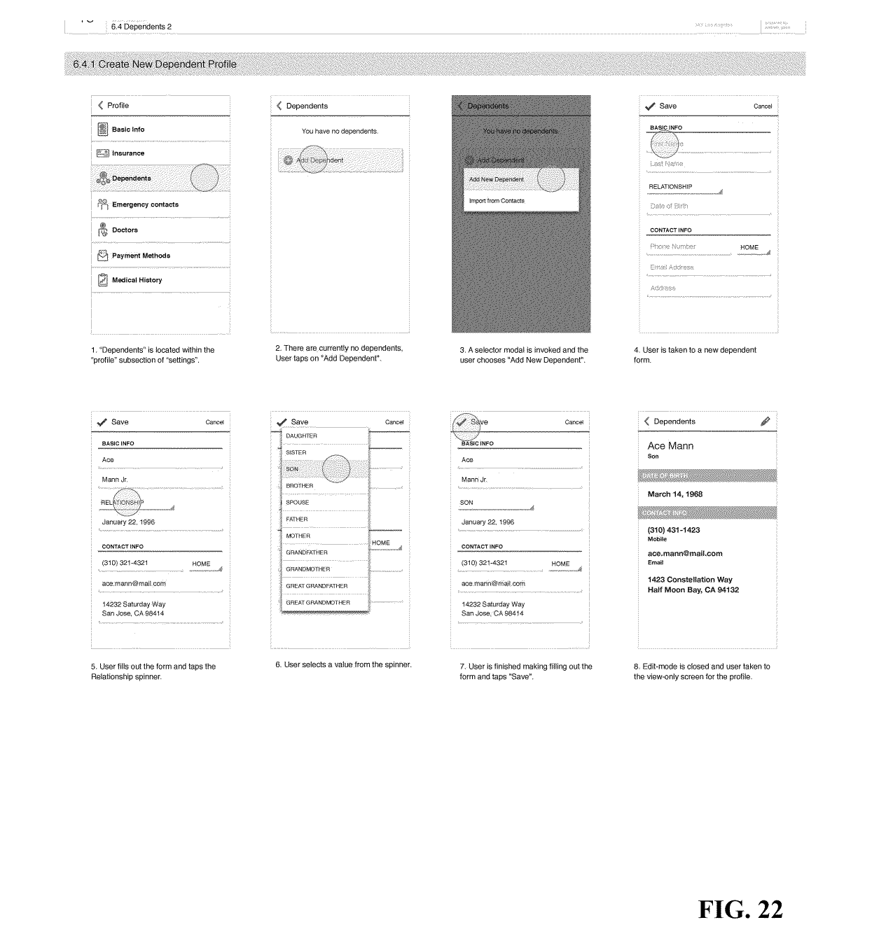

Referring now to FIG. 22, still further aspects of various user interface embodiments will now be described. FIG. 22 shows that a user can set the dependents associated with the user account. FIG. 22 shows that in this embodiment, the user can manually enter the information.

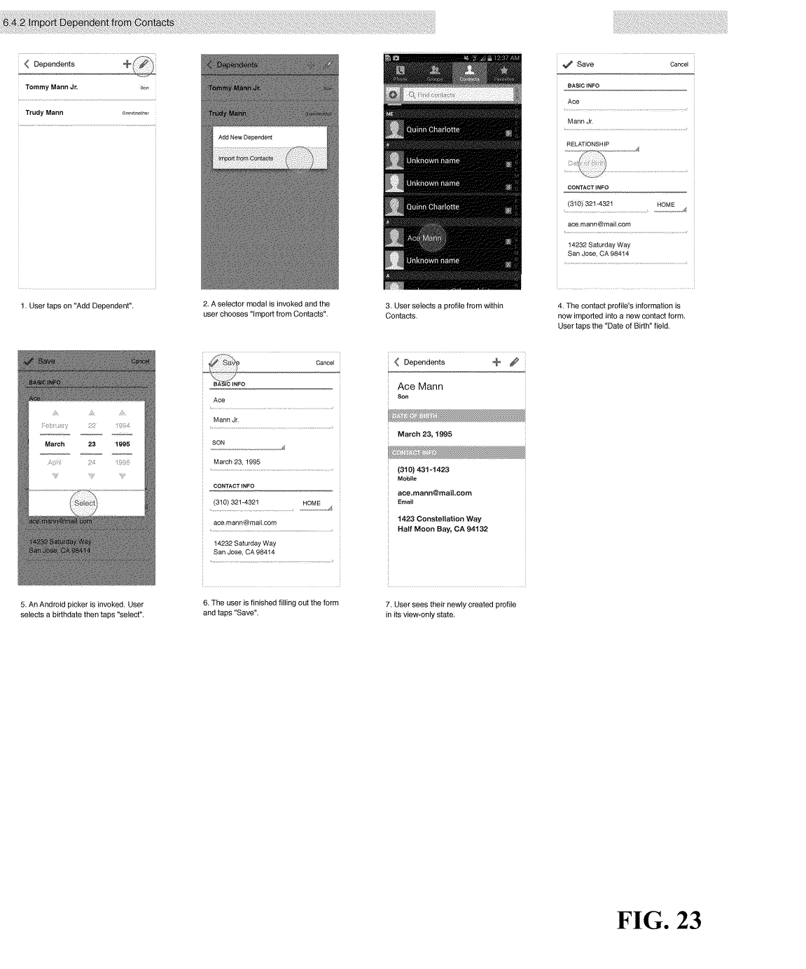

Referring now to FIG. 23, still further aspects of various user interface embodiments will now be described. FIG. 23 shows that a user can set dependent information from the user's contact list. As seen in this embodiment, the user will be able to important information but will generally also be requested to supply other information that may not be included as part of the normal contact information (such as birthdate of the dependent, relationship to the primary member, if they have a different primary insurance, etc. . . . ).

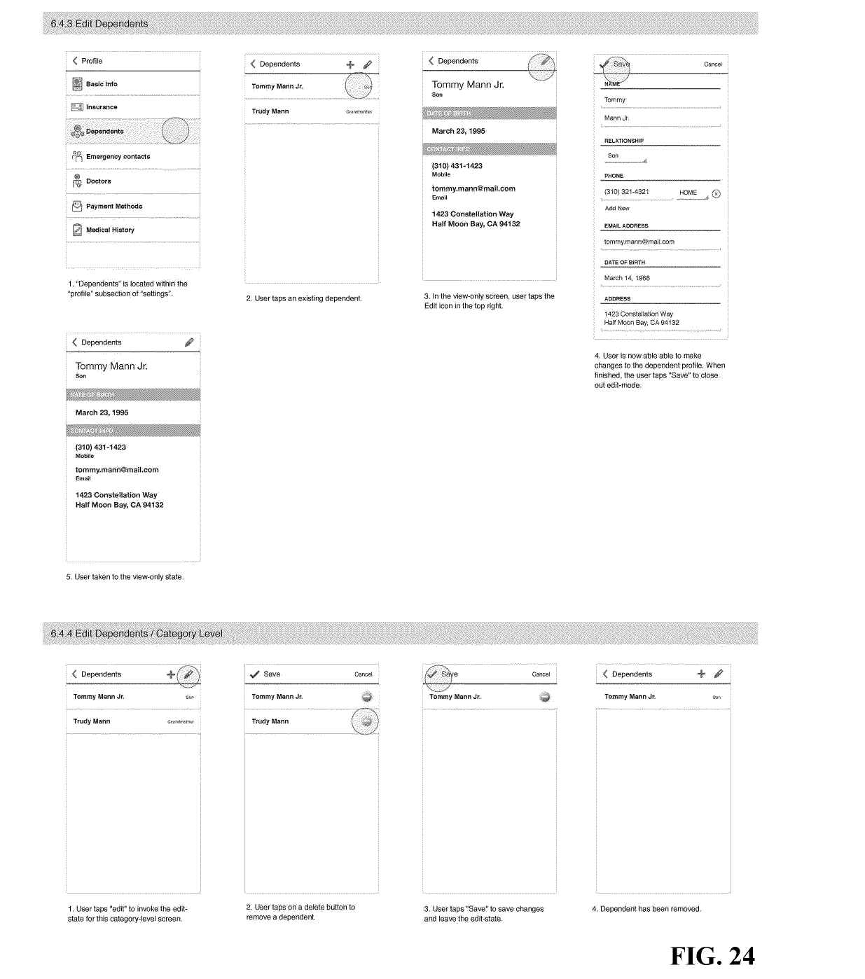

Referring now to FIG. 24, still further aspects of various user interface embodiments will now be described. FIG. 24 shows that a user, for this embodiment, can edit the dependent information and/or edit or delete their relationship information. The information can be edited using the mobile device and/or can by synchronized with any changes made through other user devices accessing the same account, such as but not limited through changes on a website. Although the embodiments herein describe the user interface as through an application on a mobile device, it should be understood that for any of the user interfaces and/or workflows herein that the changes may be made on a website, such as but not limited to ones with specific domain suffixes like .me or the like. By way of example and not limitation, medical professionals may edit their profiles and information through websites such as those with a .md suffix.

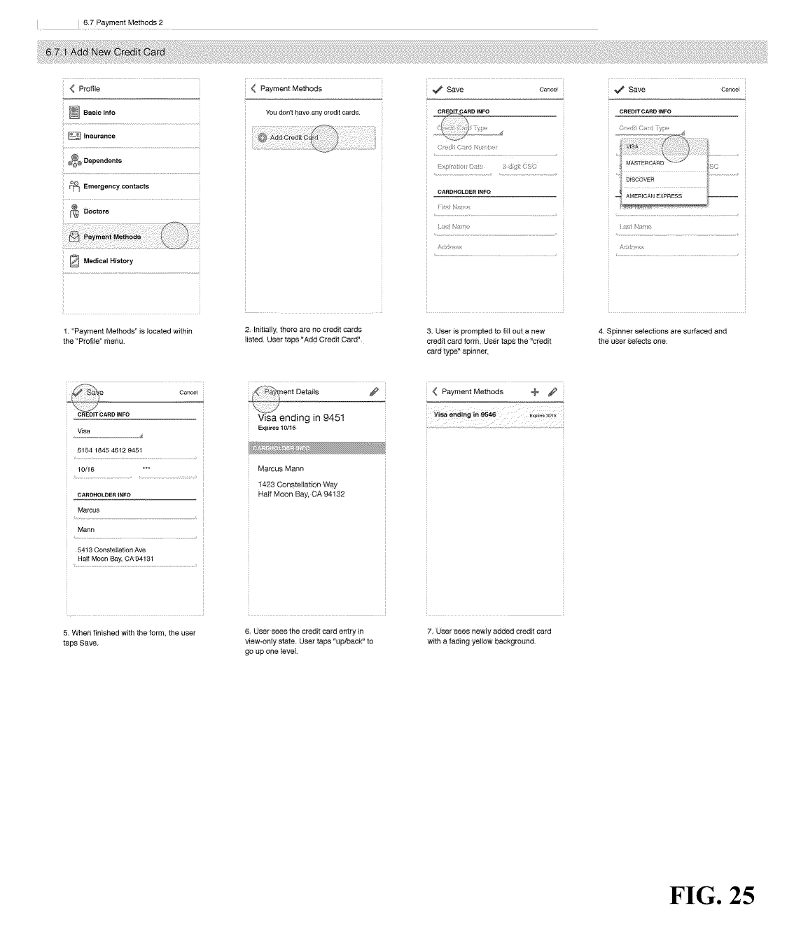

Referring now to FIG. 25, still further aspects of various user interface embodiments will now be described. FIG. 25 shows that a user, for this embodiment, can edit the payment information, particularly for non-insurance payment methods. It should be understood that security protocols for secure transmission of payment information can be used to protect the information that is being sent.

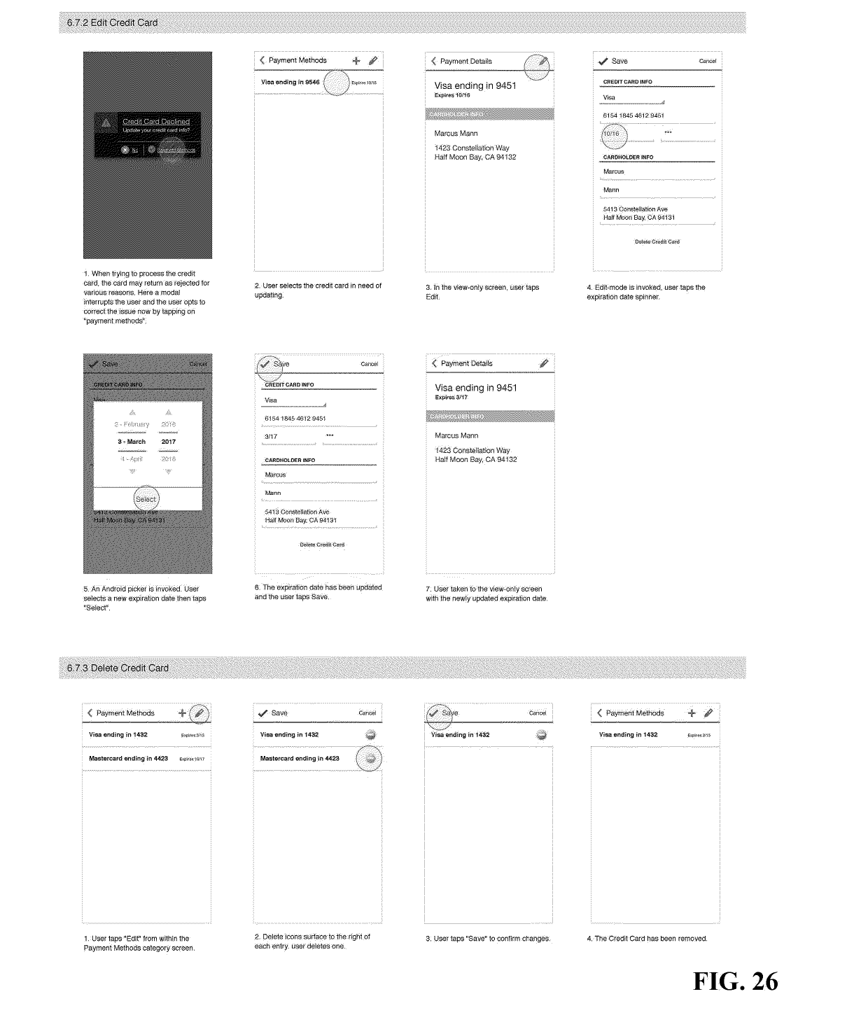

Referring now to FIG. 26, still further aspects of various user interface embodiments will now be described. FIG. 26 shows that the user can also edit the payment information such as for credit card payment information. FIG. 26 also shows that the credit card information can also be deleted, as selected from a list of possible payment items.

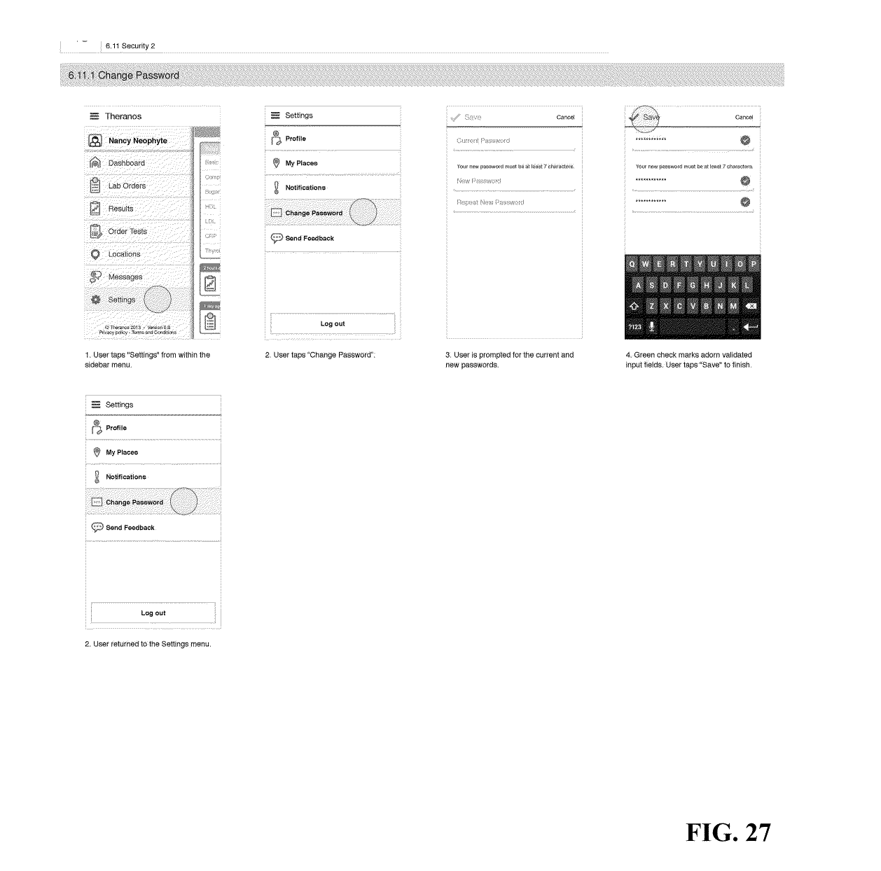

Referring now to FIG. 27, still further aspects of various user interface embodiments will now be described. FIG. 27 shows that a user, for this embodiment, a user can change password or other security setting.

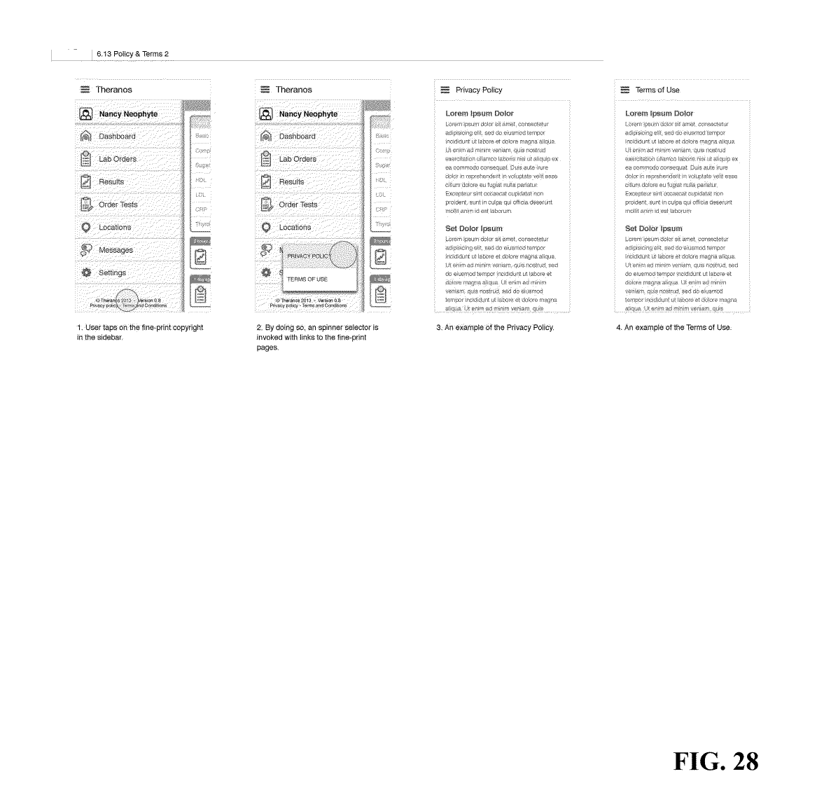

Referring now to FIG. 28, still further aspects of various user interface embodiments will now be described. FIG. 28 shows that a user, for this embodiment, a user can select the copyright print in the sidebar and by doing so can invoke a spinner that allows a user to read the privacy policy and/or the terms of use.

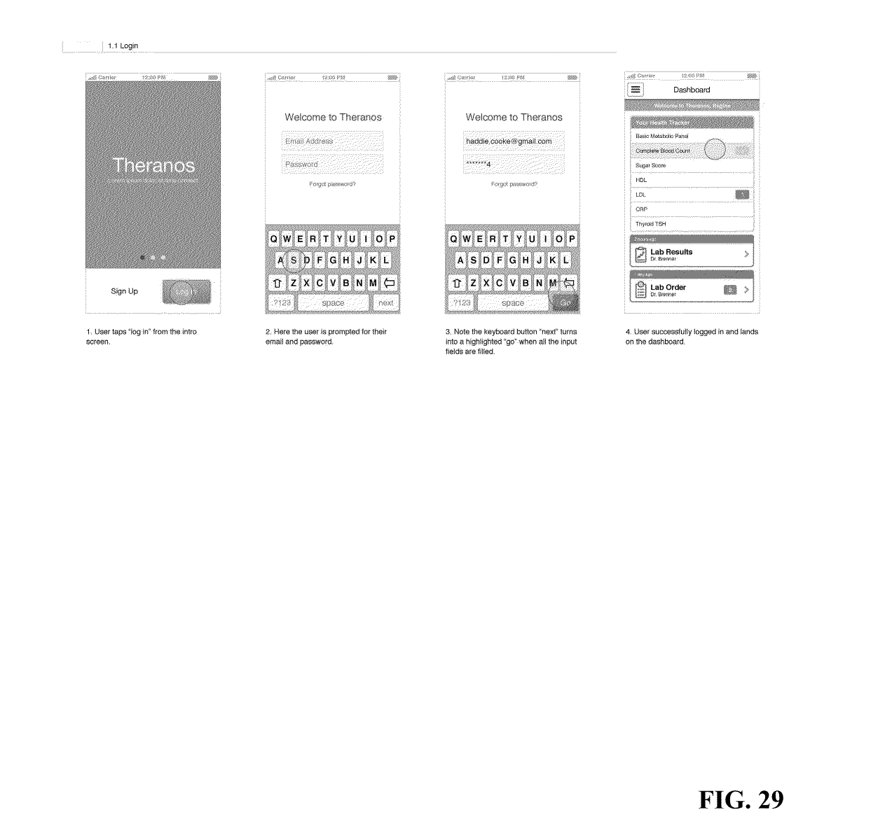

Referring now to FIG. 29, still further aspects of various user interface embodiments will now be described. FIG. 29 shows that a user, for this embodiment, the user is shown a login page wherein after the login process, the user is taken to a dashboard where the user is shown a health tracker or summary page of relevant health parameters, lab results, and/or lab orders.

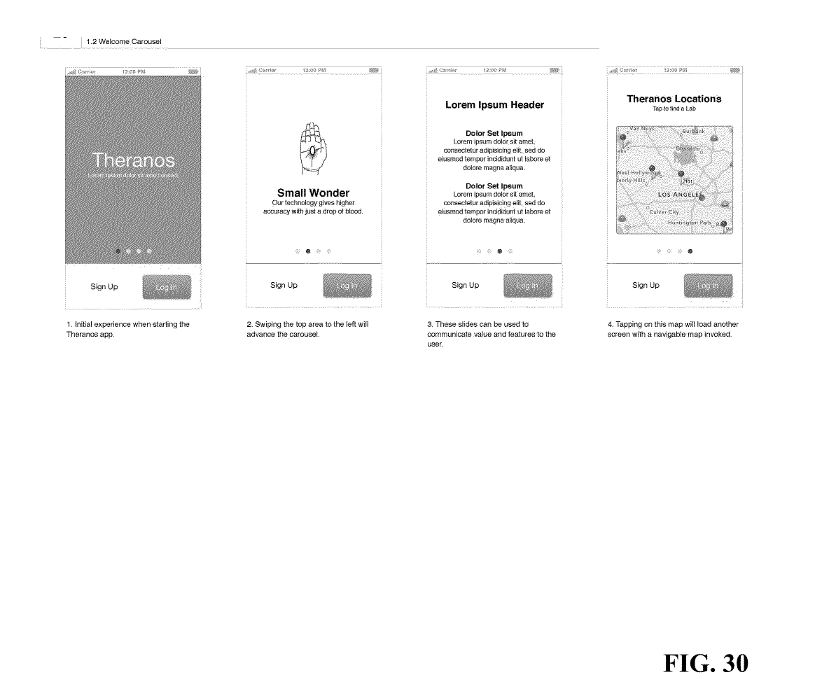

Referring now to FIG. 30, still further aspects of various user interface embodiments will now be described. FIG. 30 shows that a user, for this embodiment, the user is provide a tutorial that can communicate values and/or features to the user. The user can also be shown a map of nearby testing locations.

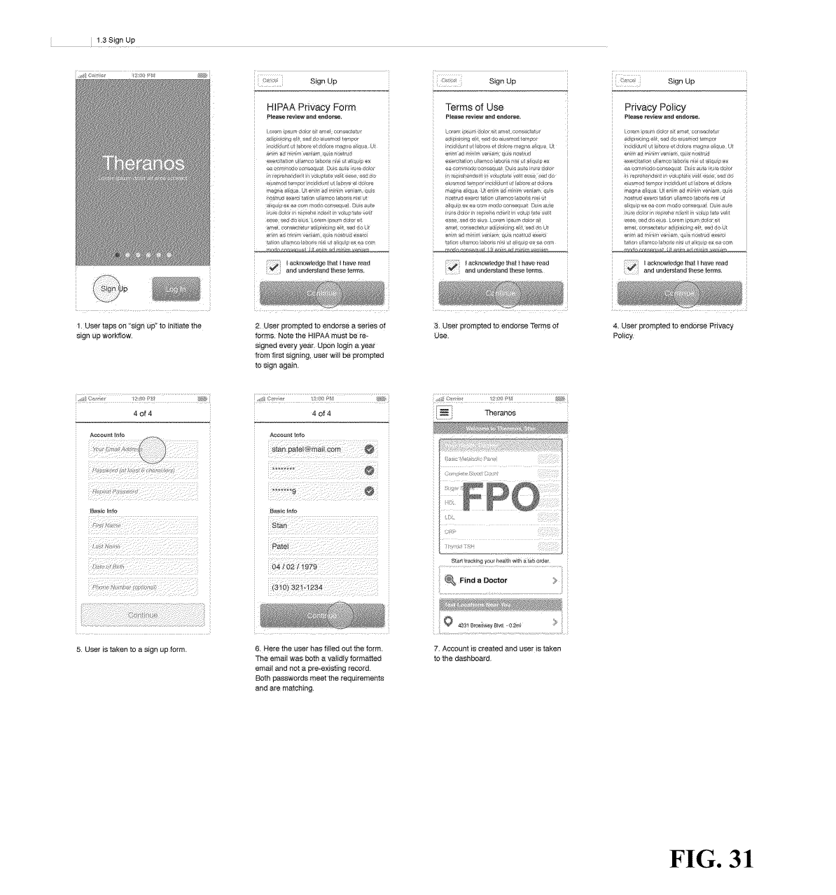

Referring now to FIG. 31, still further aspects of various user interface embodiments will now be described. FIG. 31 shows that a user, for this embodiment, the user can sign-up for the service once they have acknowledged the various privacy forms, terms of use, and/or privacy policy. As seen in FIG. 31, all of these acknowledgements can occur prior the user even filling out the email address, password, name, birthday, and/or user name fields. Optionally, all acknowledgements can occur after collection of information, but prior to completing account setup. Optionally, some embodiments may have a portion of the acknowledgements before entry of sign-up information and a portion after sign-up. Optionally, some acknowledgements, such as the HIPAA form, may require more than one check-box or other acknowledgement. For any of the acknowledgements herein, it should be understood that some may be configured so that the acknowledgement box or other interface for receiving the user's acknowledgement may be configure to appear only after all of the text, graphics, and/or information to be acknowledged has been displayed to the user.

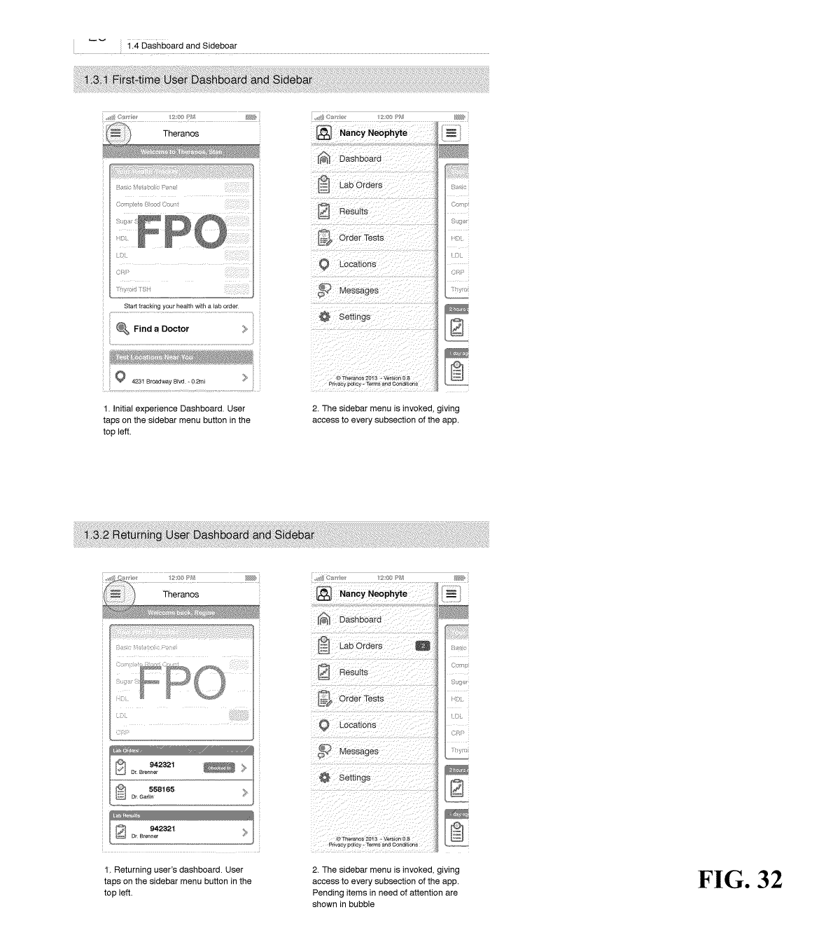

Referring now to FIG. 32, a close-up view of one embodiment of a first-time user dashboard and sidebar is shown. Optionally, FIG. 32 shows a close-up view of one embodiment of a returning user dashboard and sidebar.

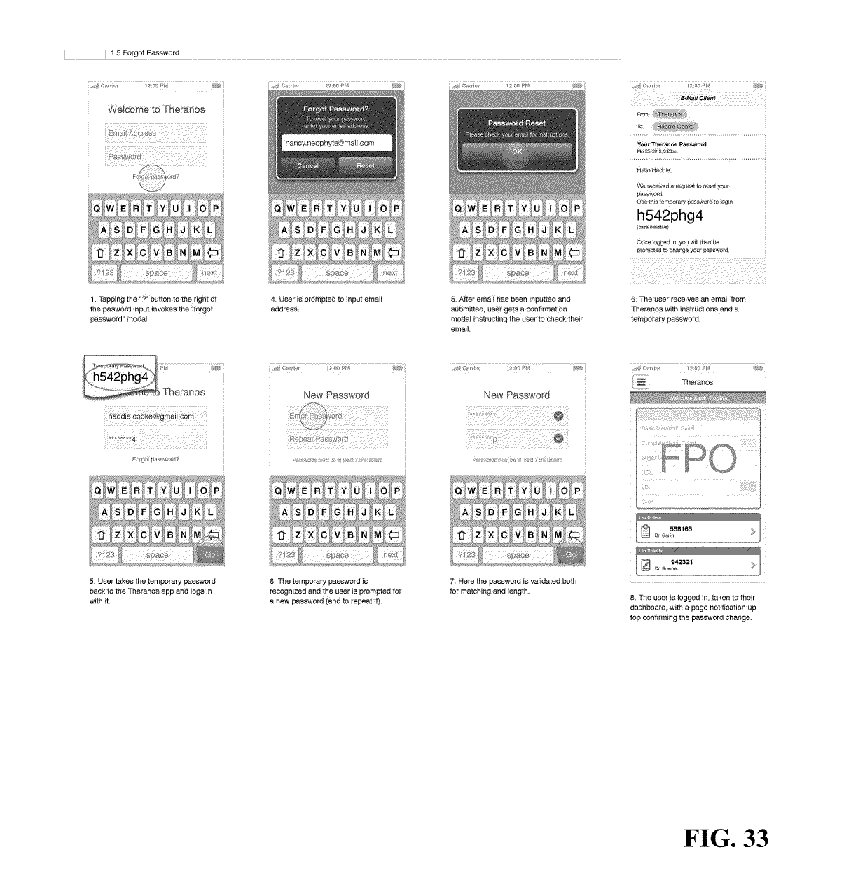

Referring now to FIG. 33, one embodiment of a system for restoring a user password is shown. This embodiment uses a temporary password. Optionally, some embodiments can be provided that re-set the password by taking the user directly to a re-set password interface, without using an intermediate temporary password.

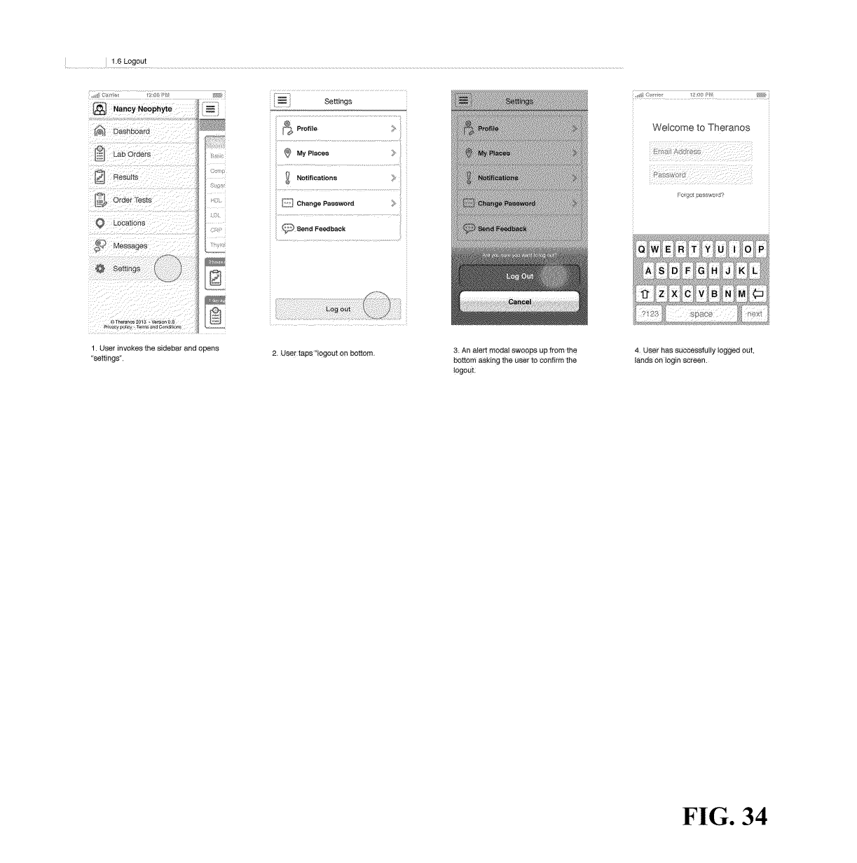

Referring now to FIG. 34, one embodiment of an interface for logging out a user is shown.

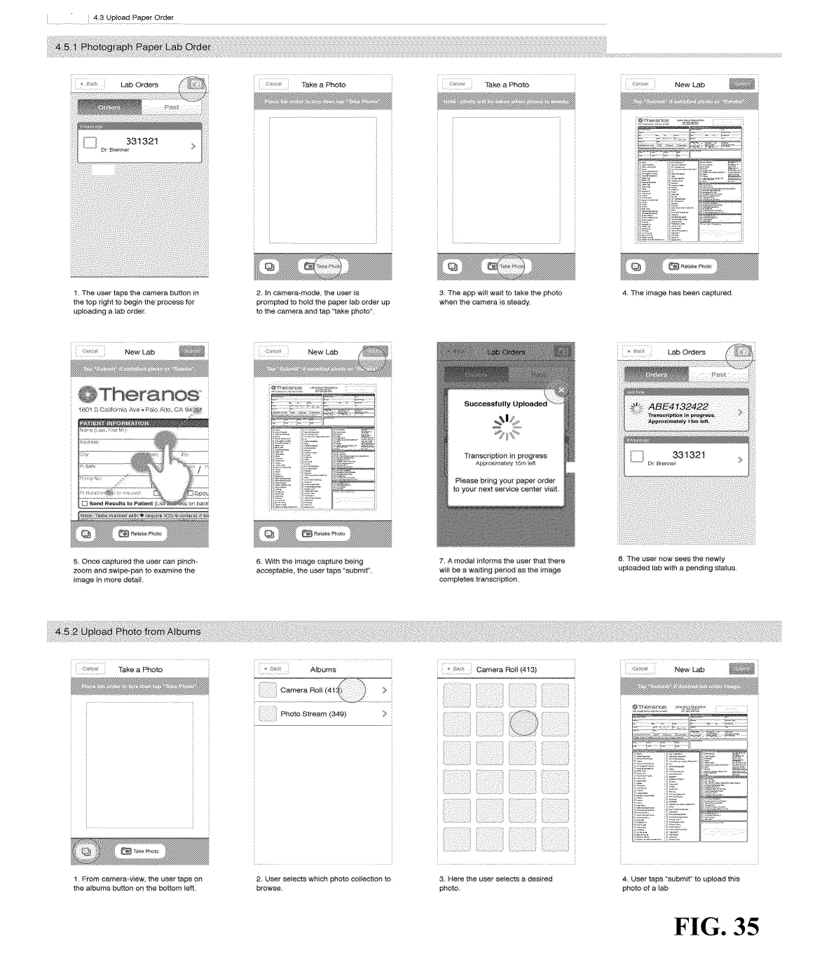

Referring now to FIG. 35, still further aspects of various user interface embodiments will now be described. FIG. 35 shows one or more embodiments for the uploading of information for paper laboratory orders into the system. In this non-limiting example, an image can be captured of the physical laboratory order and then the information extracted from that image. By way of example, the image capture can be achieved through a camera (front or rear facing) that is part of the device, through a scanner attached to the device, and/or through other image capture device.

It should be understood that the captured image may have imperfections associated with the skill of the user, the quality of the image capture device, and/or the condition of the physical condition of the original laboratory order. Some embodiments herein may use a mechanical device with a clear cover to hold the original flat. Optionally, the image can be processed through services similar to Instagram, ImageMagick, Adobe Acrobat Pro, or the like to condition the image to be in a state that allows for accurate data capture of information on the laboratory order. By way of non-limiting example, creases or other fold lines in the laboratory order can detected and then deleted or minimized so as not to interfere with data capture of information on the laboratory order. Optionally, some embodiments may use image processing to find and remove a long line, more than 1 pixel wide or remove all horizontal or vertical black lines that are at least 30 pixels long. Optionally, the image can be compared to known forms of laboratory orders, which can then be used to decipher text that may be unclear. The type of known form can be selected based on an initial image capture that may include the name of the referring physician or laboratory and/or any laboratory form identification number. The image processing can occur on the user's device, in a server, and/or on both.

As seen in FIG. 35, images of the laboratory order can loaded from a user's album of photos on the user's. Optionally, it can be loaded from an on-line album of photos that are not resident on the user's device.

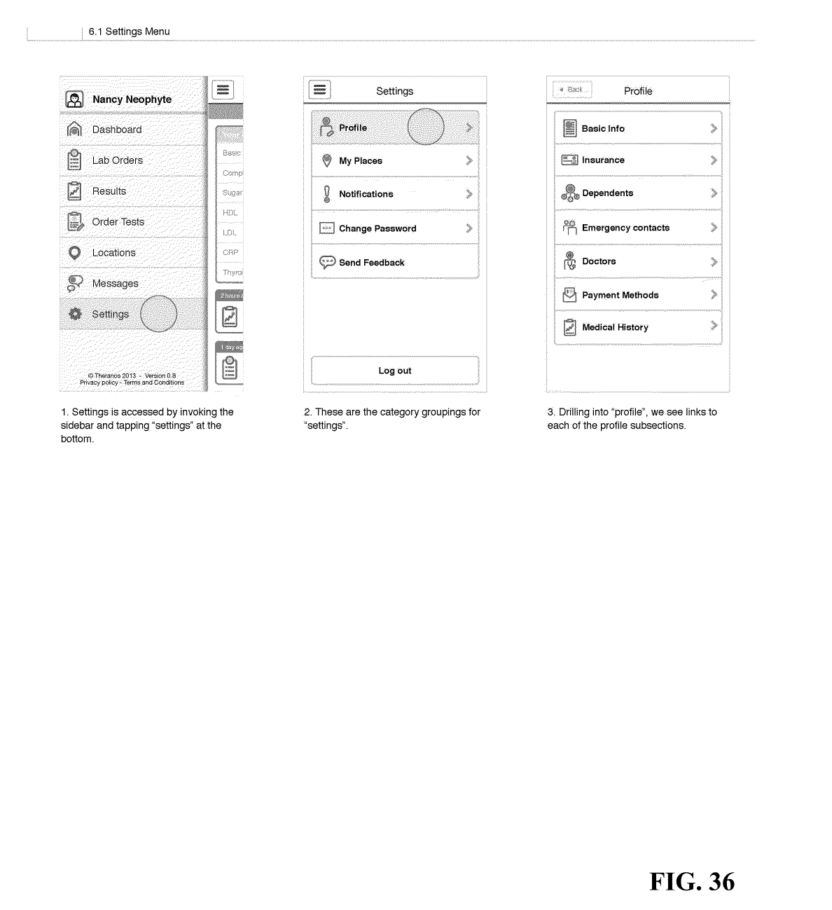

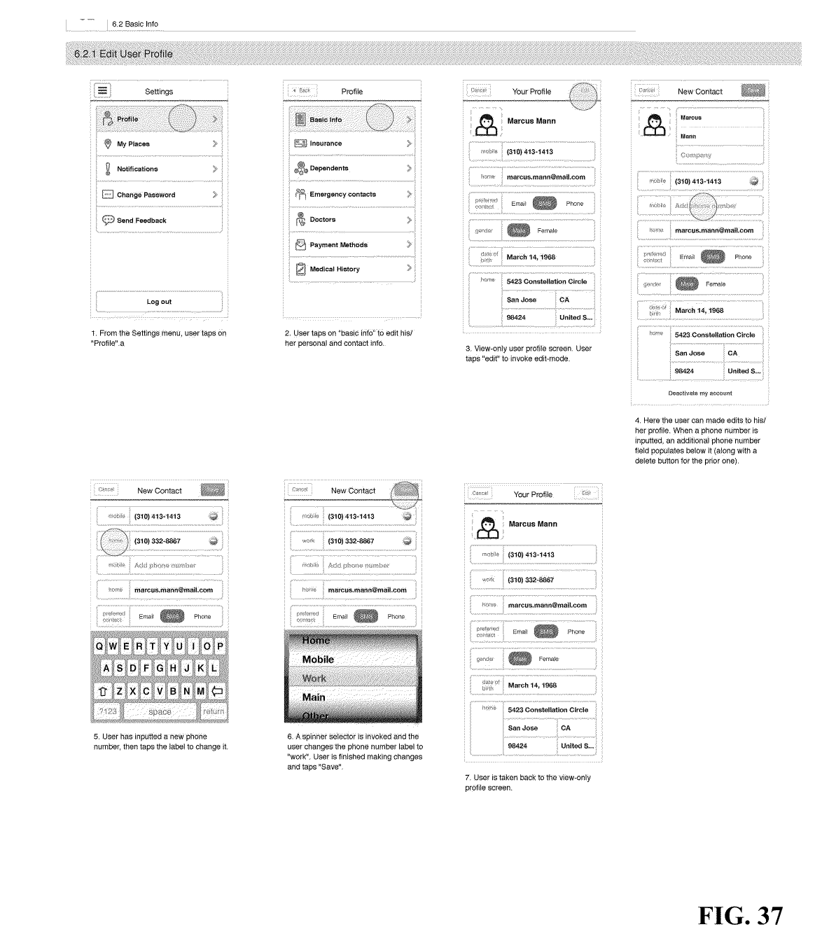

Referring now to FIGS. 36 and 37, various techniques and user interfaces for updating a user's profile information is shown.

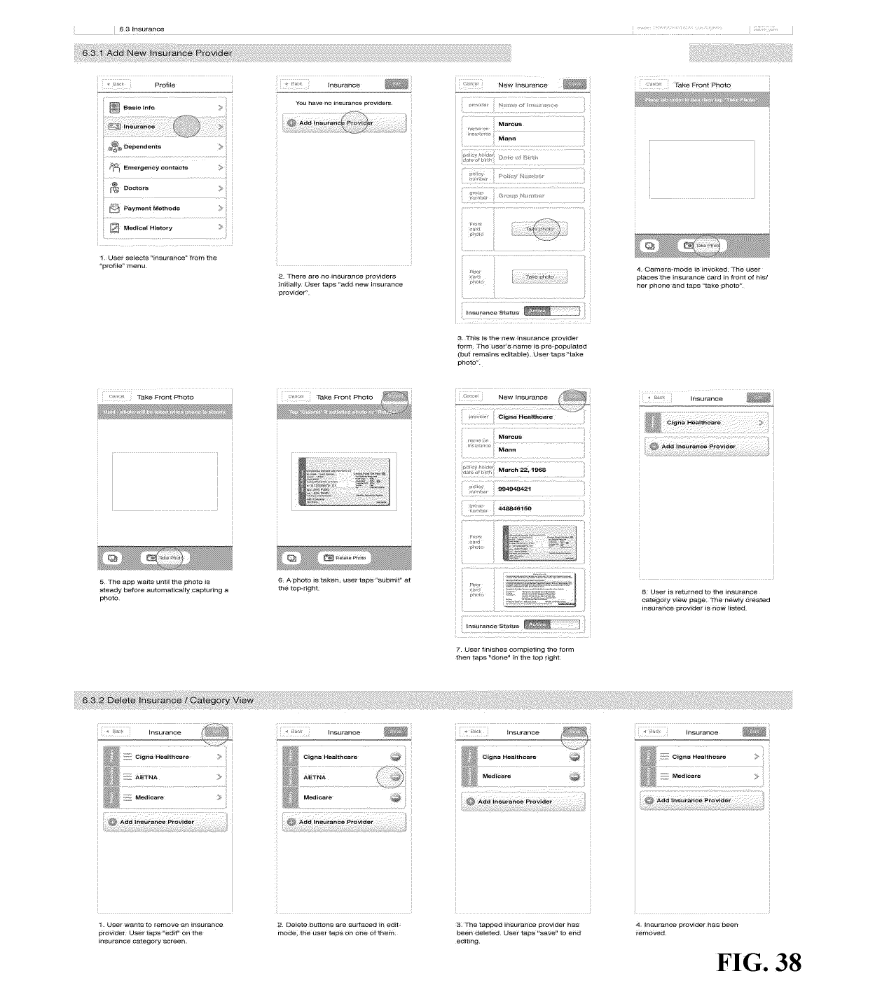

FIG. 38 shows one embodiment for uploading insurance information and/or deleting insurance information from a category view of a plurality of insurance options. The insurance may optionally be verified by connection to a back-end processing server that has insurance information that confirms that the insurance information a user enters is up-to-date and that the insurance coverage is verified as valid.

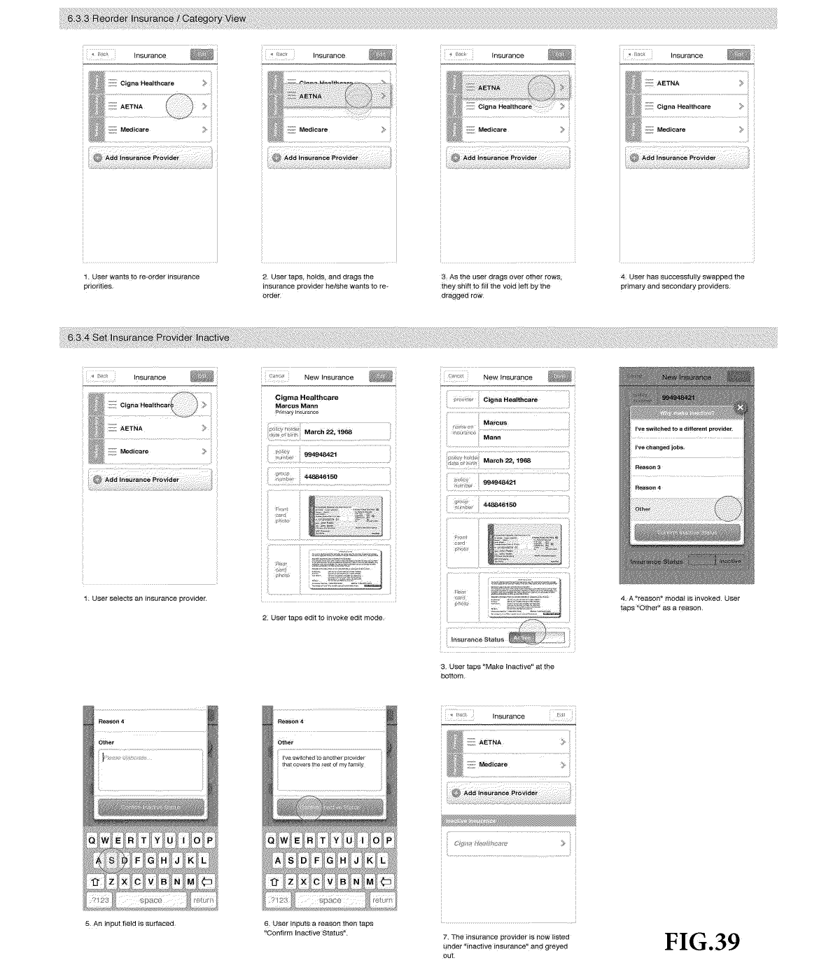

FIG. 39 shows non-limiting examples of using the drag-and-drop feature to reorder the insurance priorities. FIG. 39 also shows one embodiment of how a user can set the insurance provide to inactive. This embodiment can also ask the user about the reason for the change.

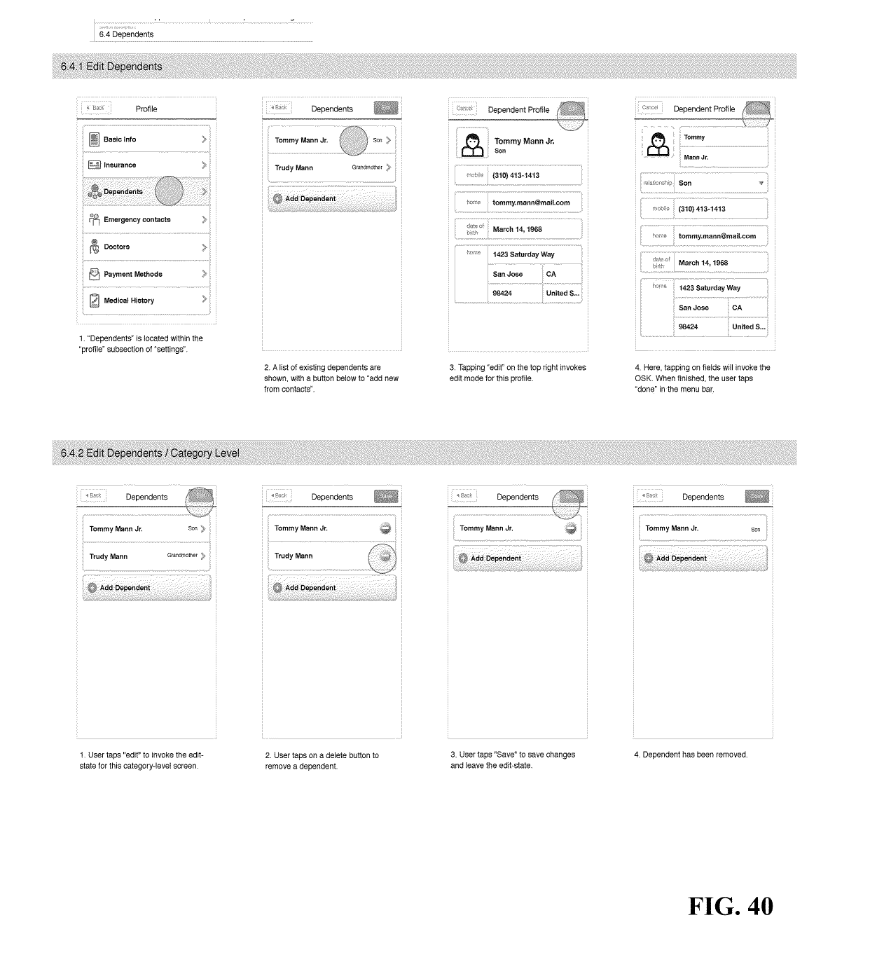

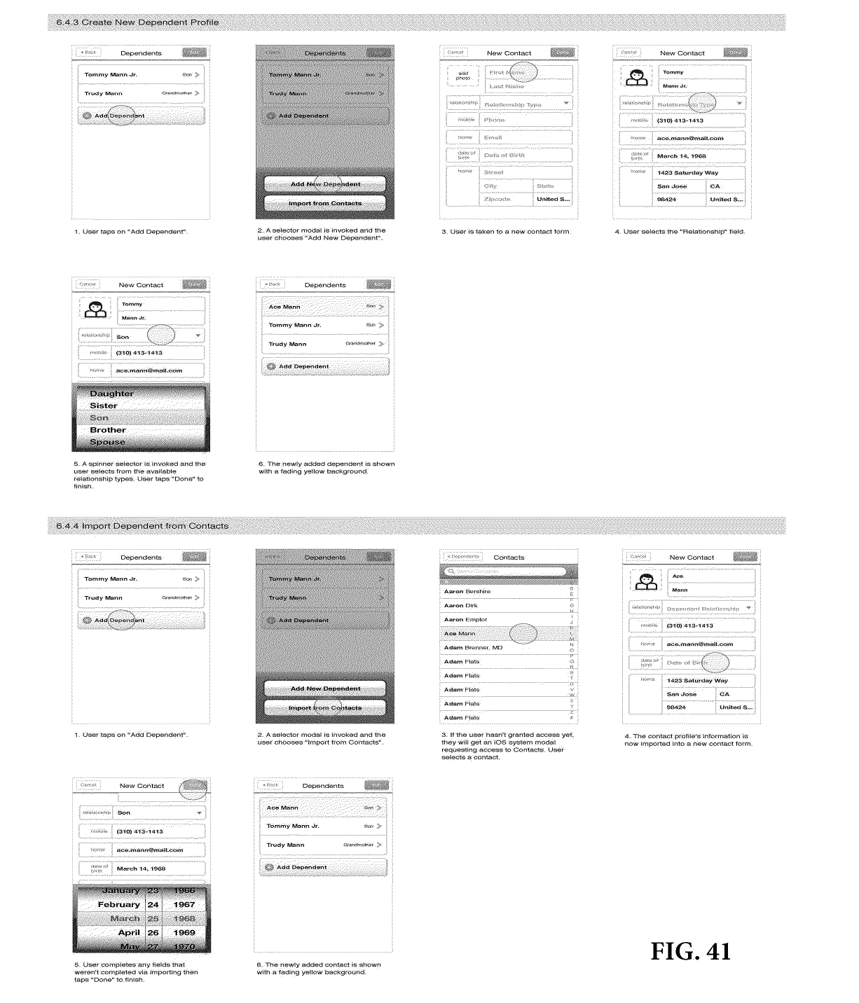

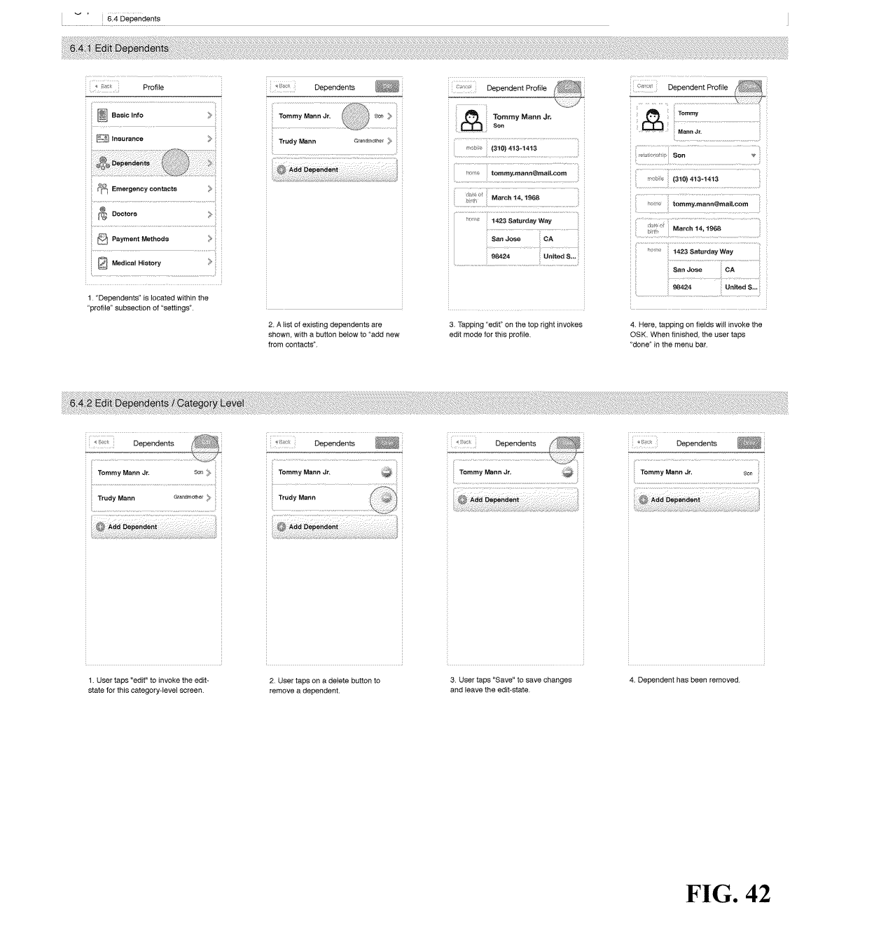

FIGS. 40 to 42 show techniques for how dependent information can be entered and/or edited. This can be done using techniques as previously described herein.

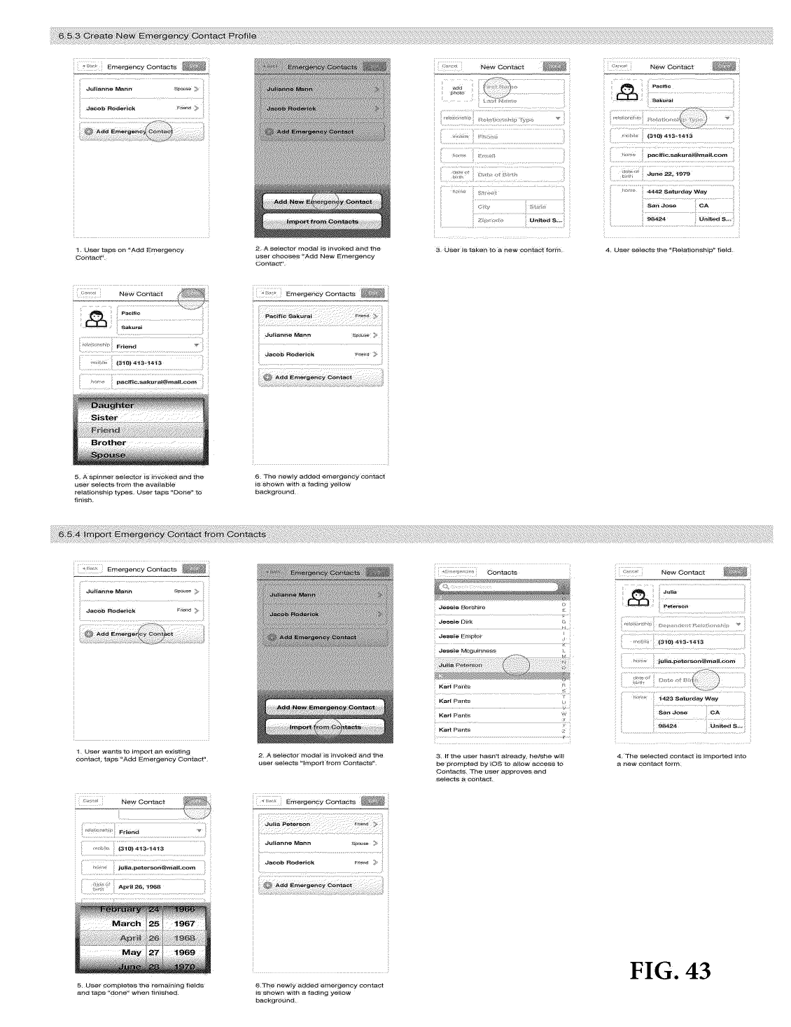

FIG. 43 shows a non-limiting embodiment of how emergency contact information can be entered into a user's profile. FIG. 43 also shows how the user can import an emergency contact from the user's contact information on the device or on a server. The user can also add certain information such as birthdate, contact priority, relationship to the user, or the like. Some embodiments can create contact priorities based on the stated relationship to the user.

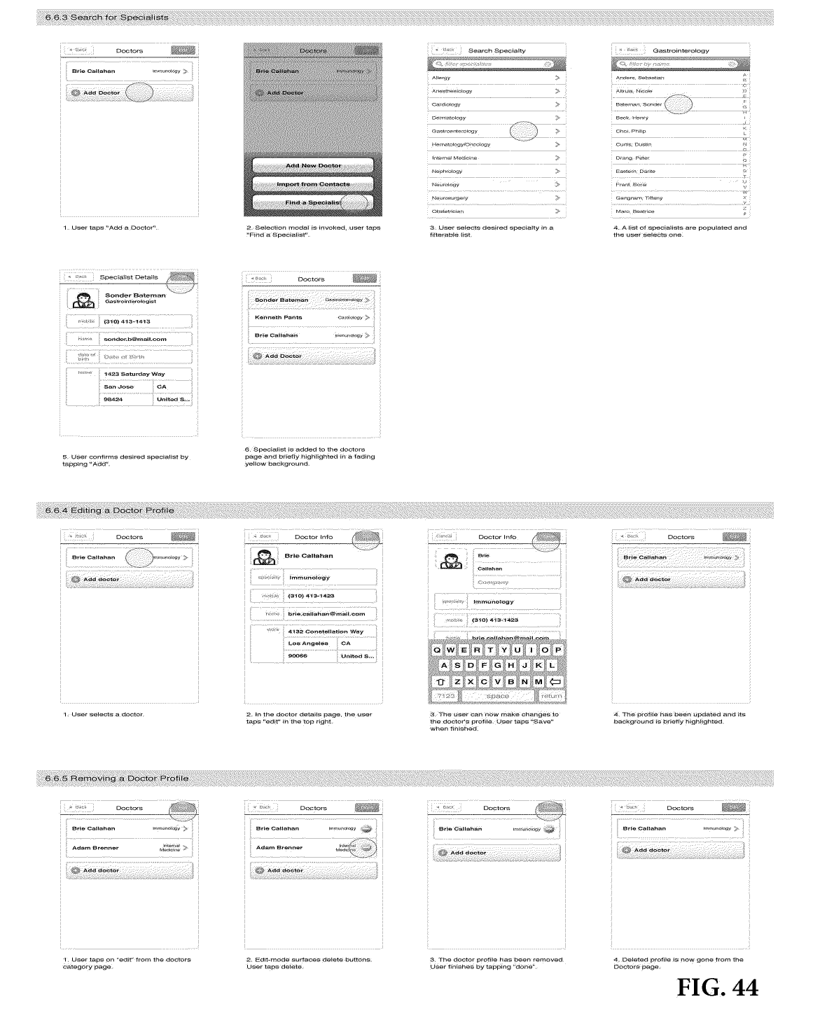

Referring now to FIG. 44, still further aspects of various user interface embodiments will now be described. FIG. 44 shows how the user can add a doctor to the information for the user account. The doctor can be further selected from a “find a specialist” button to locate the type of specialist, wherein the result list can be sorted by distance from current location, alphabetically, or other criteria. FIG. 44 also shows how a user can edit a doctor's profile and/or remove it from the list.

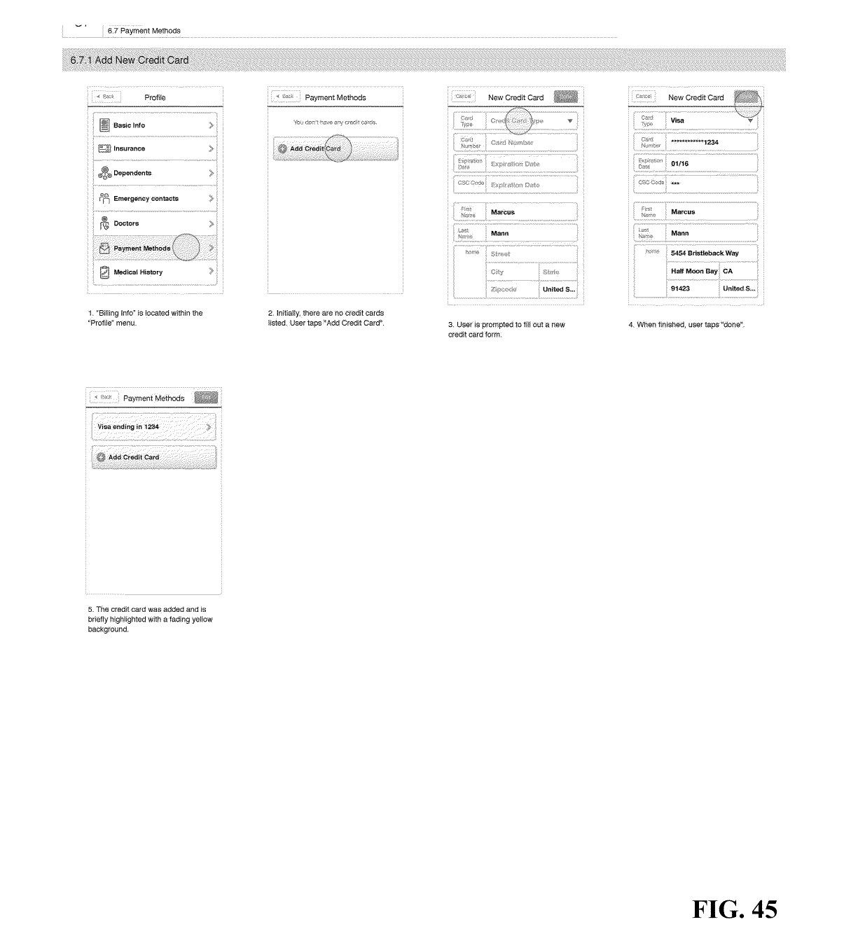

FIG. 45 shows one non-limiting example of user interfaces for adding a new credit card to the user account.

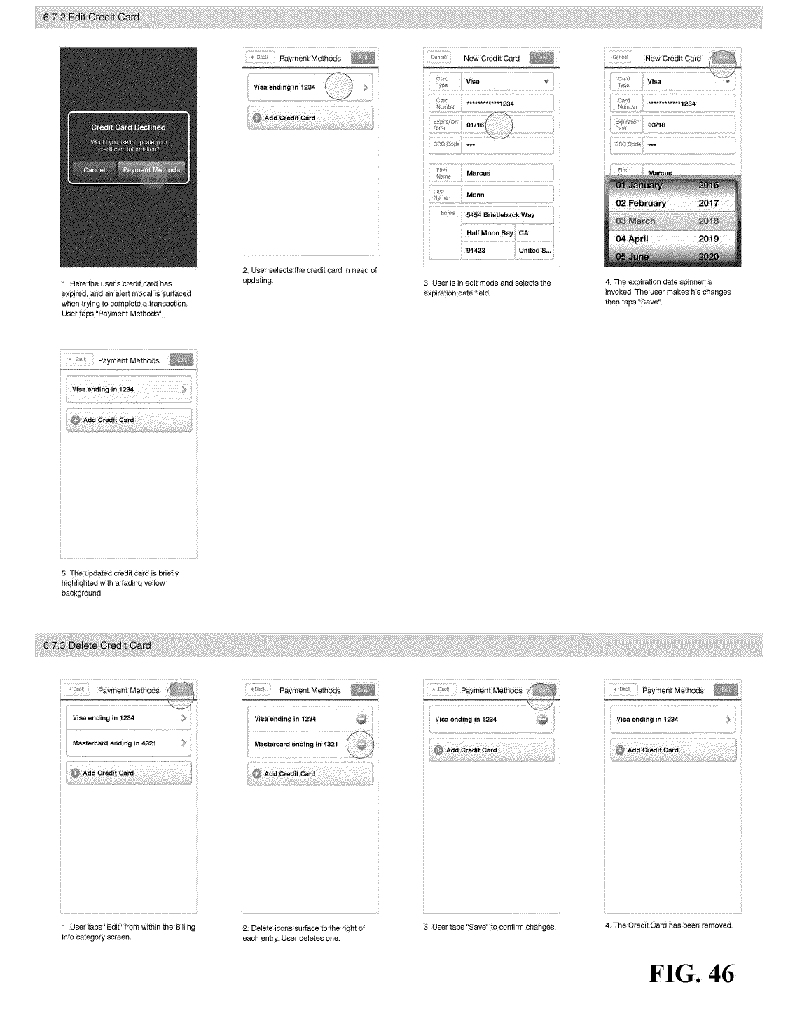

FIG. 46 shows one non-limiting example of user interfaces for editing a credit card to the user account.

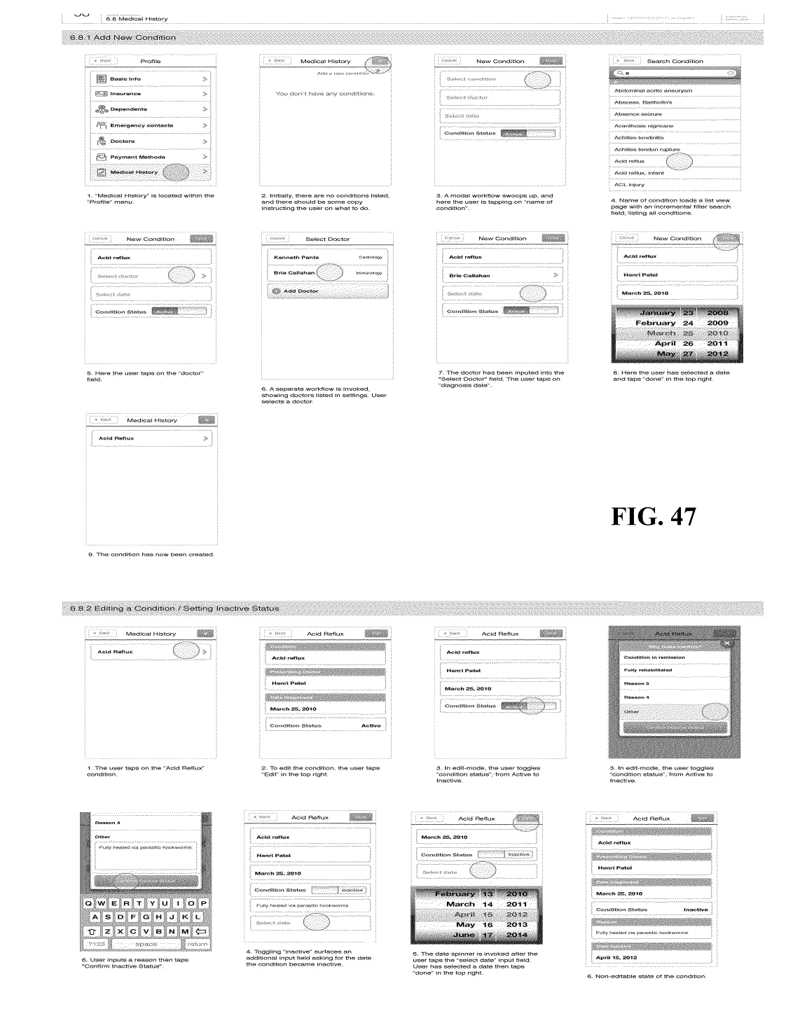

FIG. 47 shows one non-limiting example of user interfaces for adding and/or editing a medical condition associated with the user. In this non-limiting example, when a condition is added to a user profile such as their medical history, then a user can also enter information about a doctor who diagnosed the condition. Optionally, a user can also use this to add a condition this is currently symptomatic and perhaps not officially diagnosed. This can be selected, in one option, from the date where the user could not that this a current condition and the doctor which the user selected can be used to confirm this diagnosis. In one non-limiting example, a user can opt to have the system schedule an appointment with the doctor or optionally, have a message sent to the doctor about the condition, at which point the doctor or someone working with or associated with the doctor, can contact the user to follow-up on that condition.

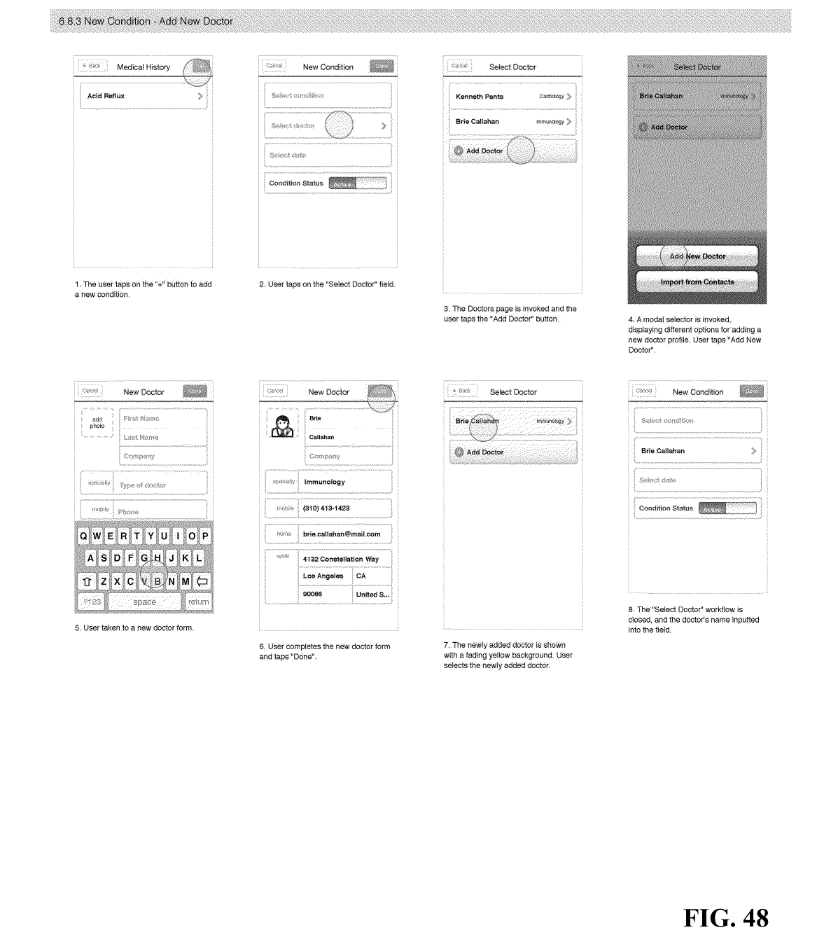

FIG. 48 shows one non-limiting example of user interfaces/workflows for adding and/or editing a medical condition associated with the user. This non-limiting example shows that user may first initiate the information input by selecting the doctor and is not limited to first selecting the condition. Thus, the sequence in which the information is input is not limited to order presented on the new condition user interface screen.

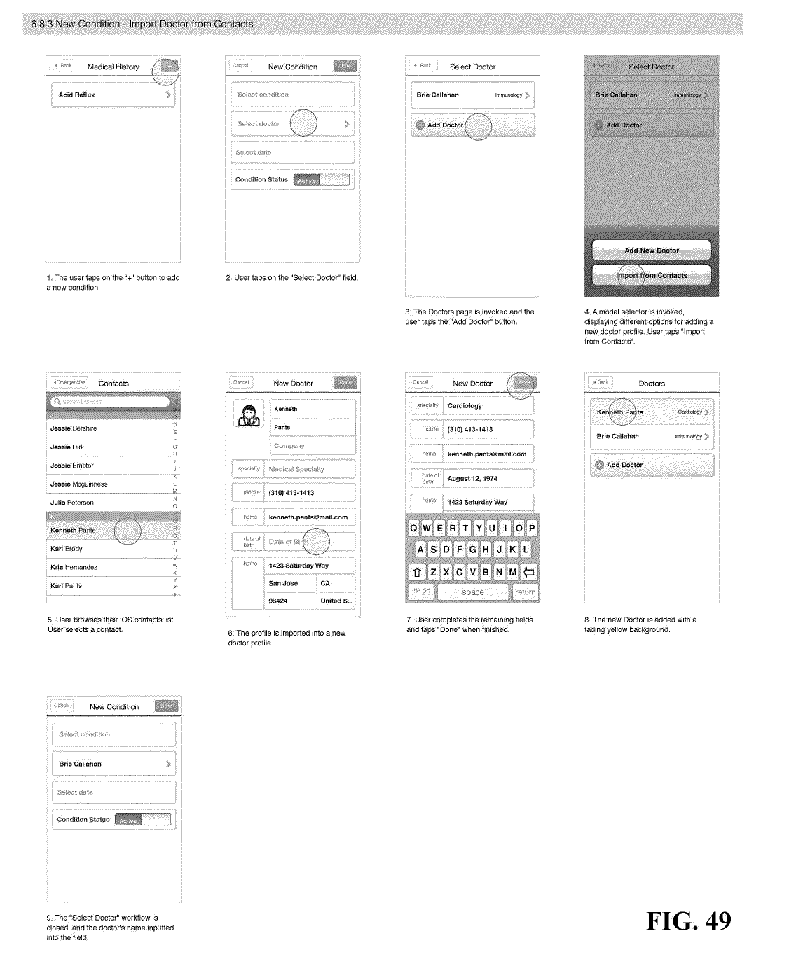

FIG. 49 shows one non-limiting example of user interfaces/workflows for importing doctor or other medical professional information from contact list that the user has already created for other purposes. As seen in FIG. 49, even after import, the user may be requested to add additional information about the doctor. Optionally, the system can also auto populate some of this information by correlating the doctor's name and/or other identifier information to external or other databases to fill-in information that the user may not have provided. Some embodiments may prompt the user to confirm that the auto filled information is accurate or acceptable to the user before saving it to the user account.

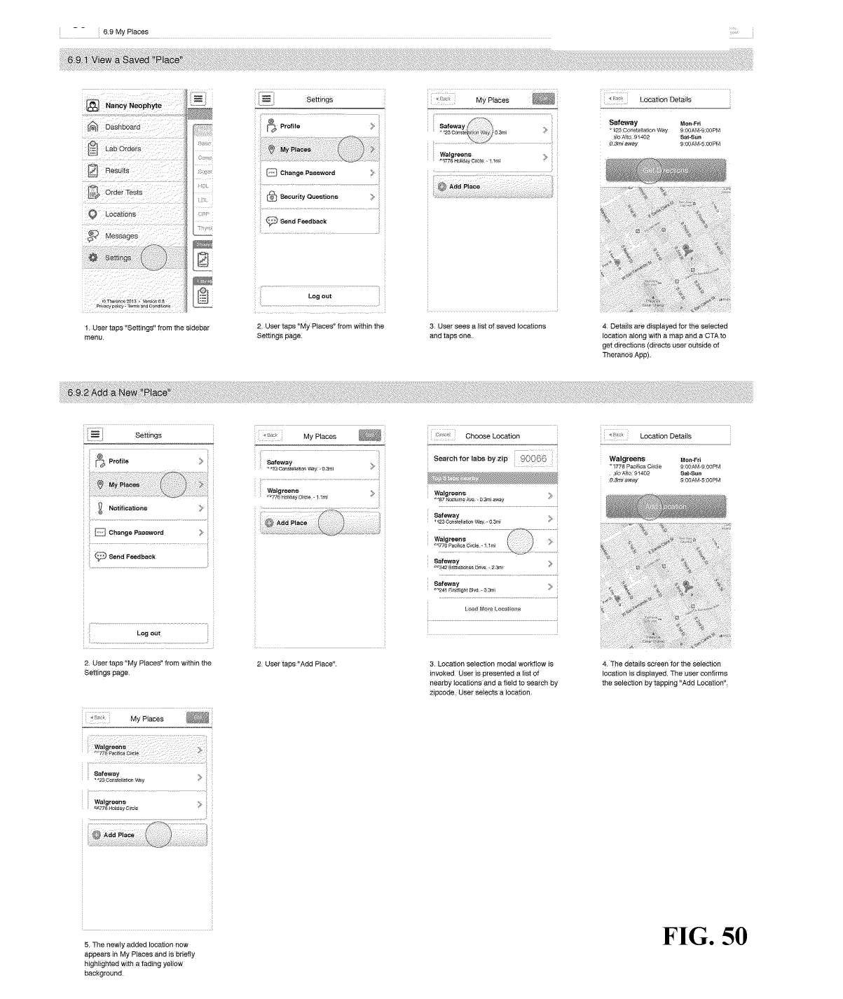

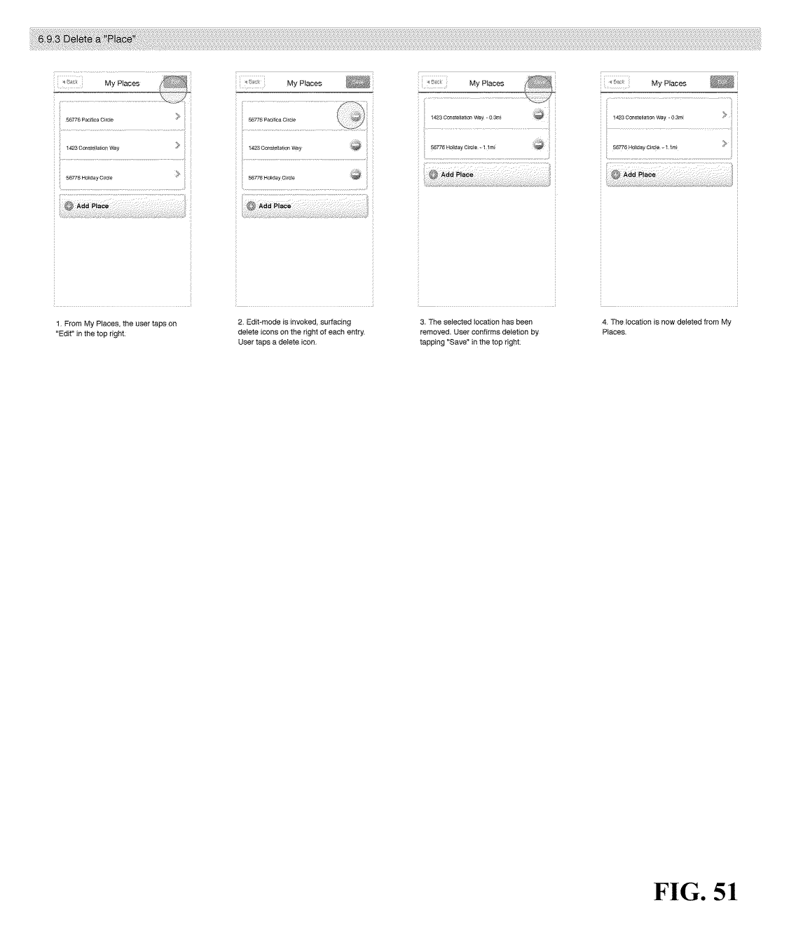

FIG. 50 shows one non-limiting example of user interfaces/workflows for adding “places” to the user account. These places can be, but are not limited to, places that are patient service centers that can collect samples for use with the testing associated with the system. The “my places” tab can save favorite or other locations that the user desires to have associated with their account. The “my places” tab can provide locations where the user has previously tested or where the user may prefer to go for testing. “My places” may be included in the default list of locations when results are pulled up for open appointment times, nearby locations, etc. . . . They may be included as part of the list in a non-preferred manner, or preferentially listed at the top or other location in the listing. Optionally, some embodiments may use visual cues to highlight the locations which are part of the “my places”. One embodiment of workflow for removing a “my places” location is shown in FIG. 51.

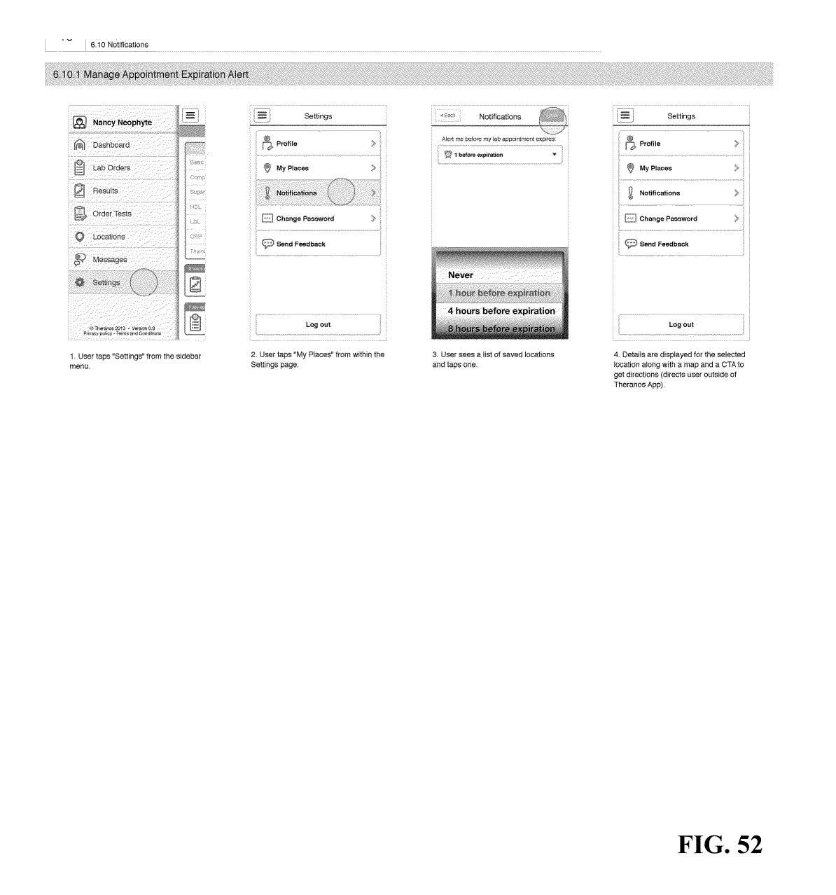

FIG. 52 shows one non-limiting example of user interfaces/workflows for managing an appoint expiration alert.

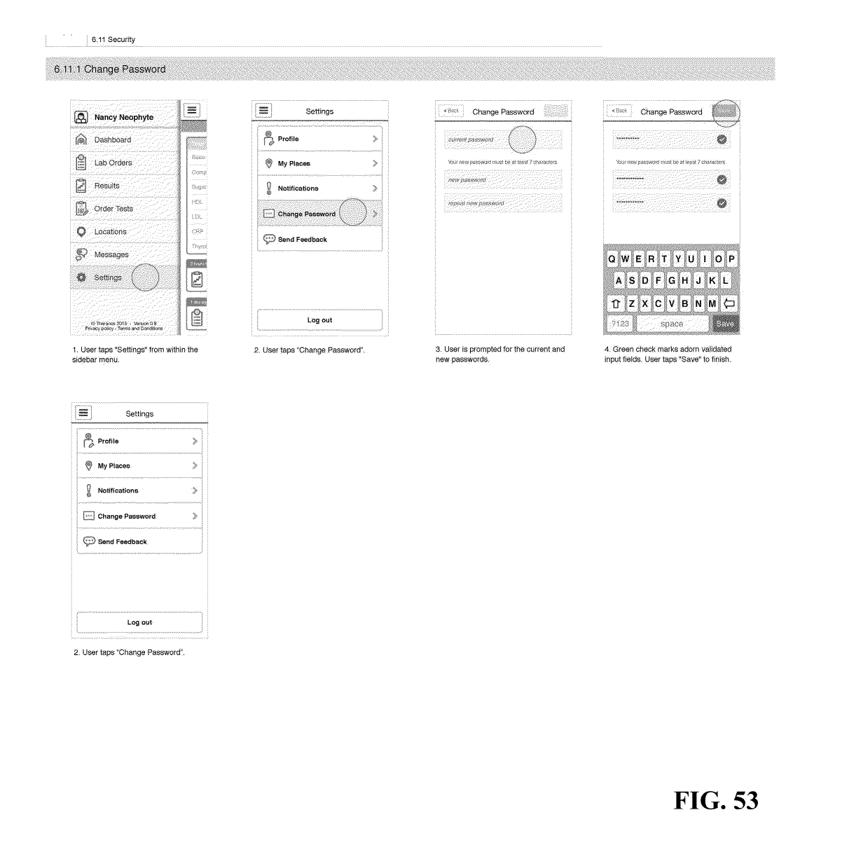

FIG. 53 shows one non-limiting example of user interfaces/workflows for managing a user's password.

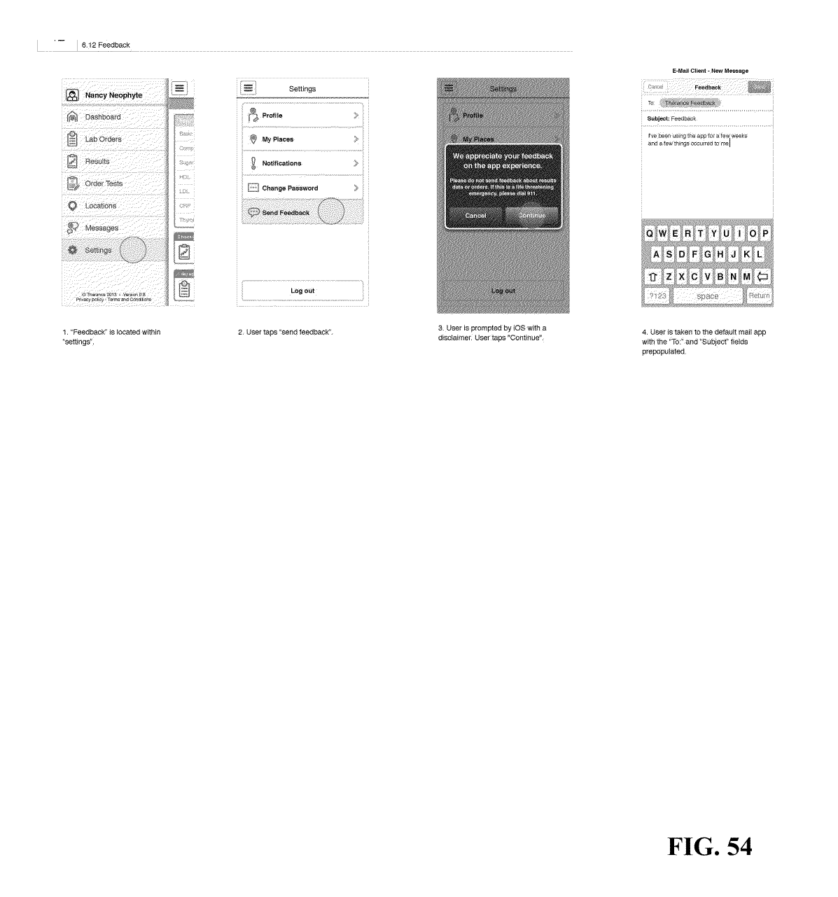

FIG. 54 shows one non-limiting example of user interfaces/workflows for obtaining user feedback on the application.

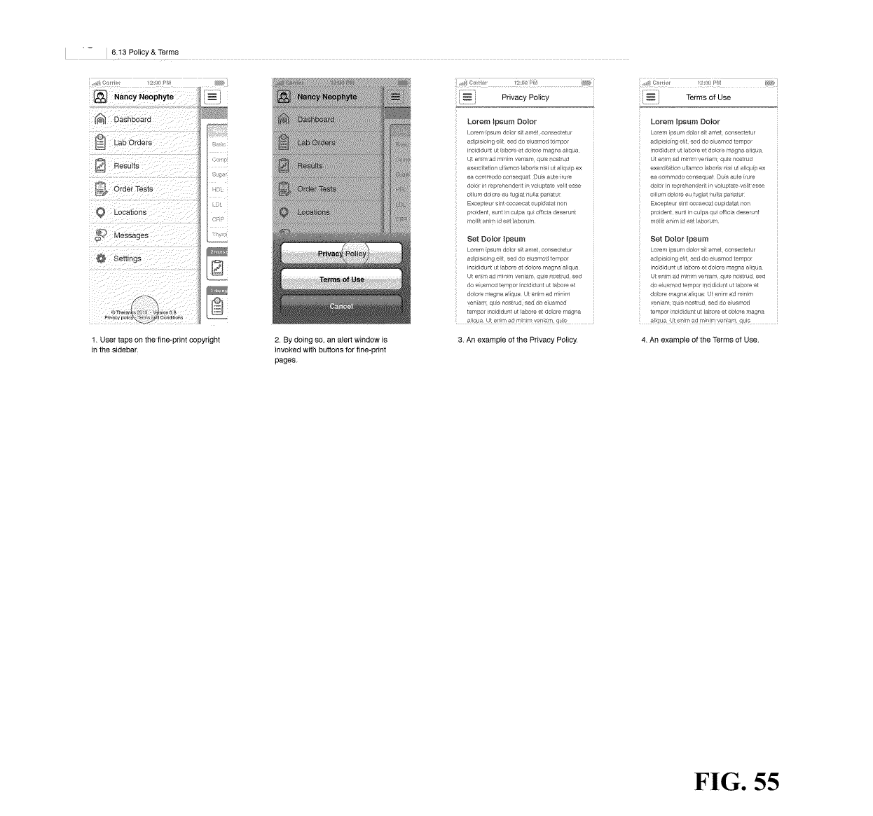

FIG. 55 shows one non-limiting example of user interfaces/workflows for reviewing privacy policy and/or terms of use.

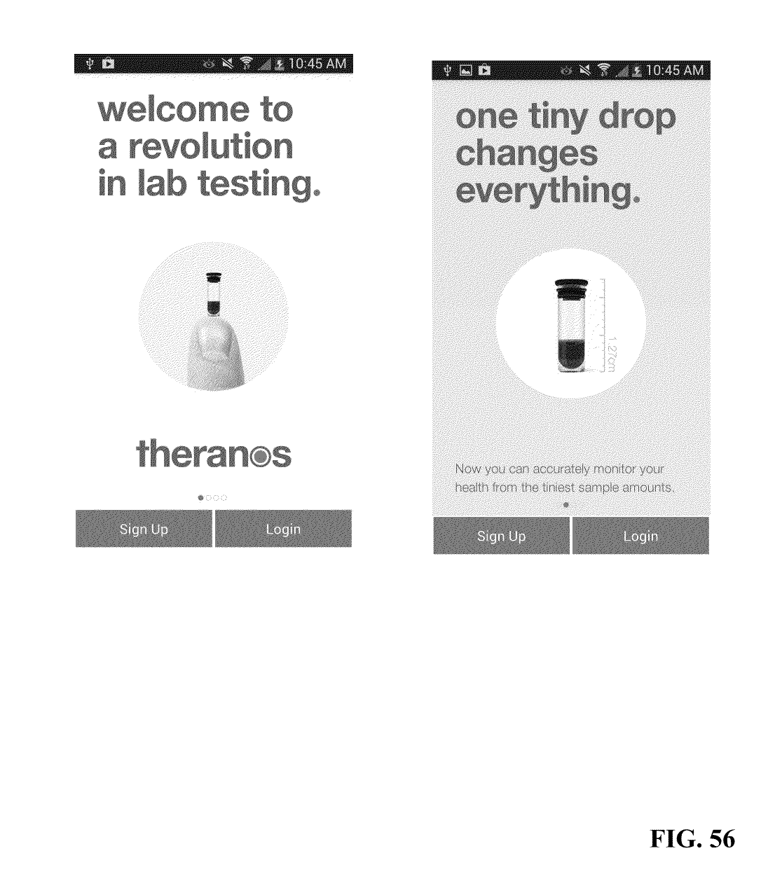

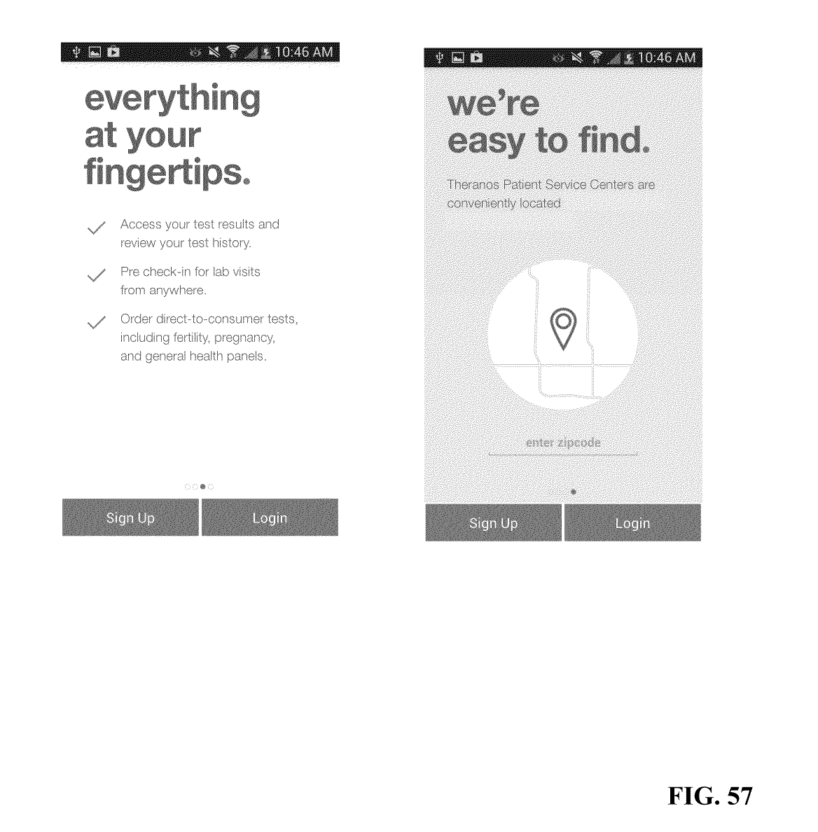

Referring now to FIGS. 56 to 57, non-limiting examples of user interfaces/workflows for user login screens are shown. These login screens may include information reminding users about conveniences or advantages of the present system, such as but not limited to the small size of the collected sample, slogans regarding advantages, visuals regarding the sample collected, lists of benefits, or the other reminders. Optionally, some embodiments can provide maps showing nearby test locations on the login screen.

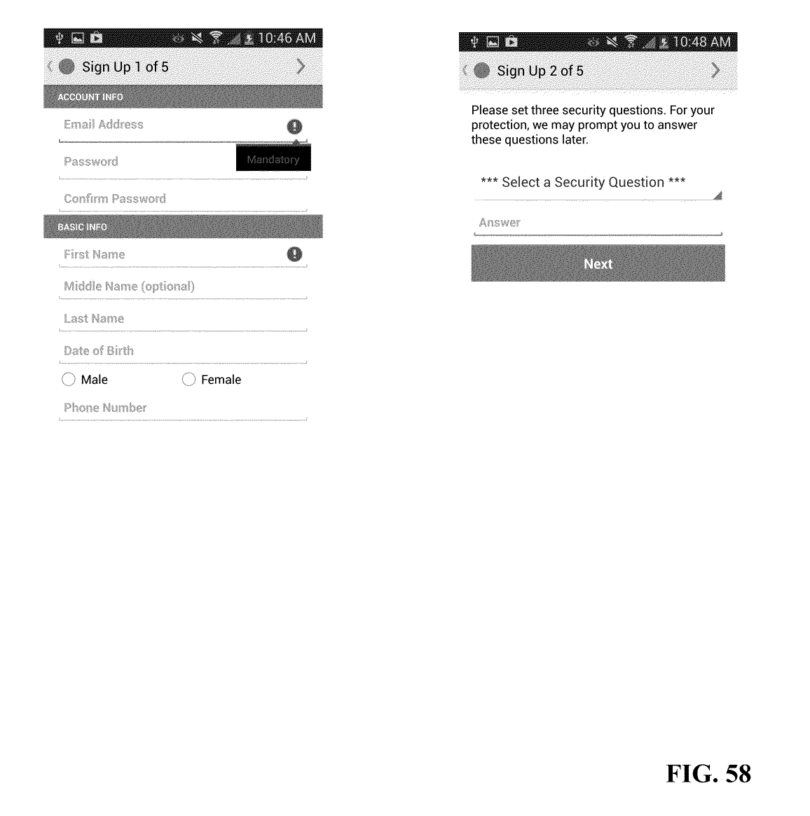

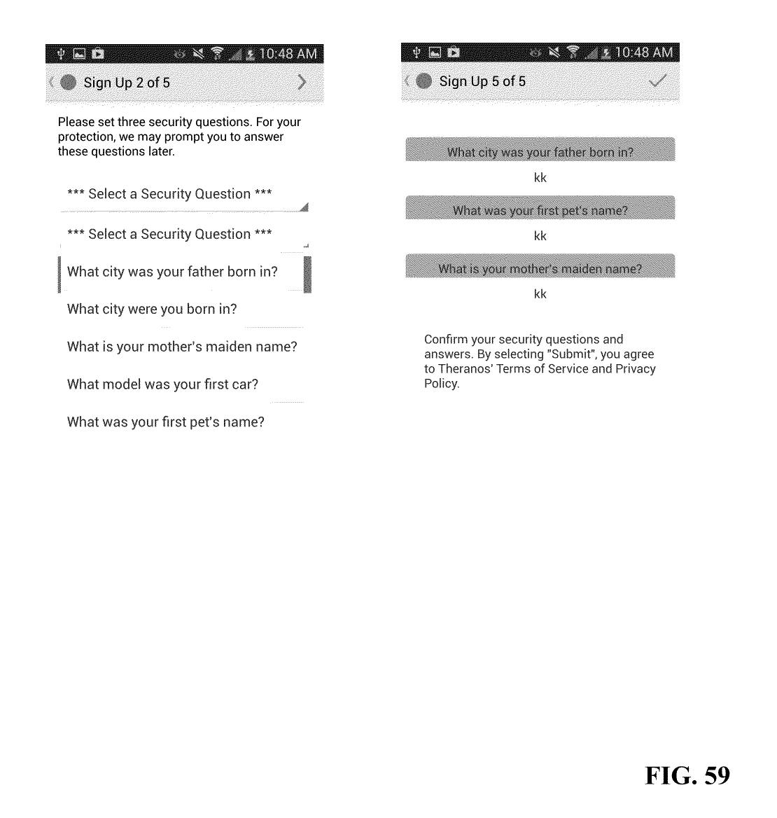

Referring now to FIGS. 58 to 59, non-limiting examples of user interfaces/workflows for user login screens are shown.

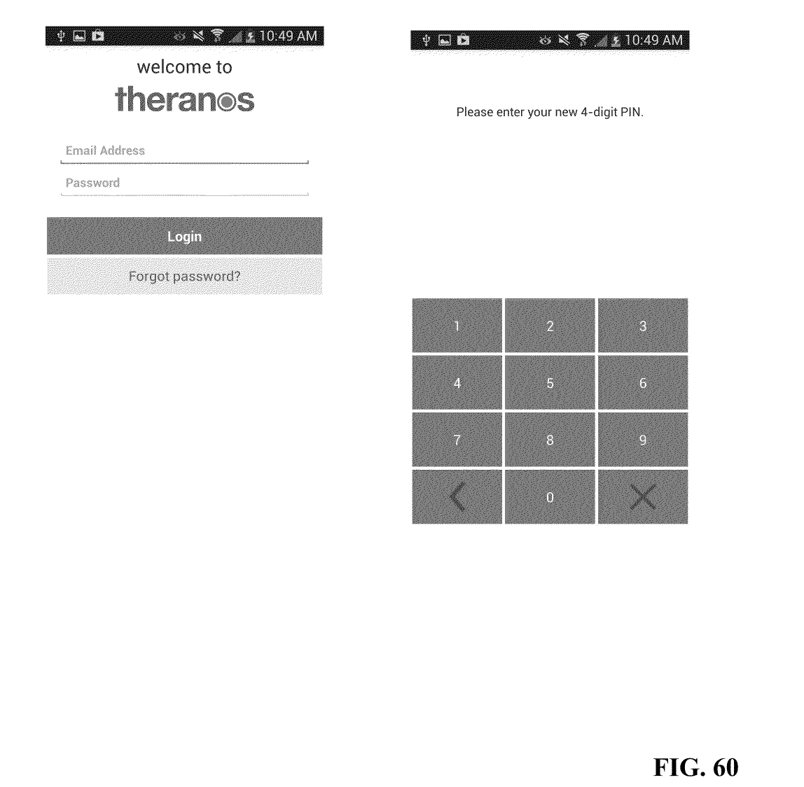

Referring now to FIG. 60, non-limiting examples of user interfaces/workflows for user login screens are shown. In one embodiment, FIG. 60 shows a login screen for the user where a password is required along with an associated username or email address. Optionally, FIG. 60 also shows a login screen setup screen where a user can enter a PIN for locking or unlocking the program.

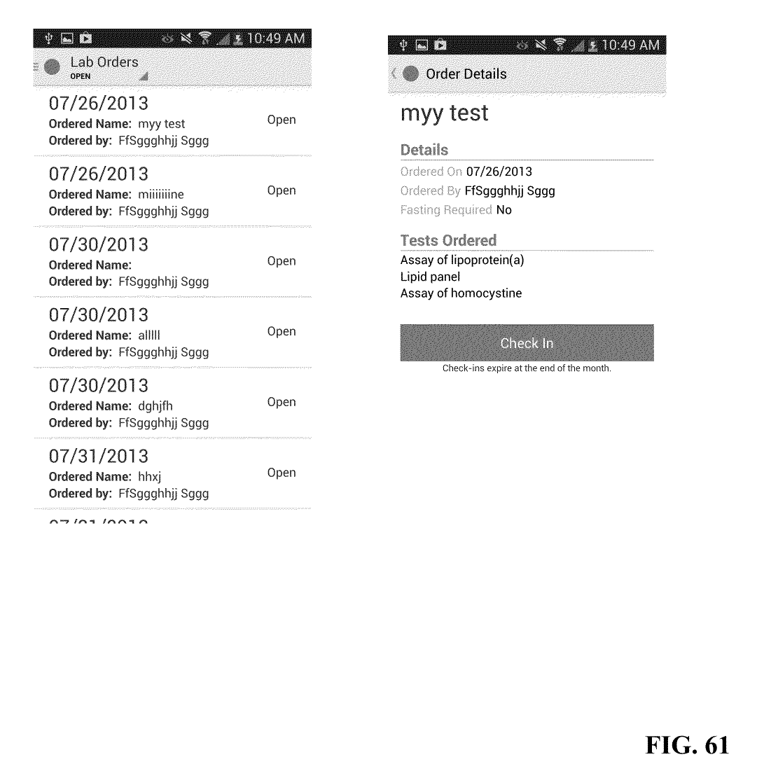

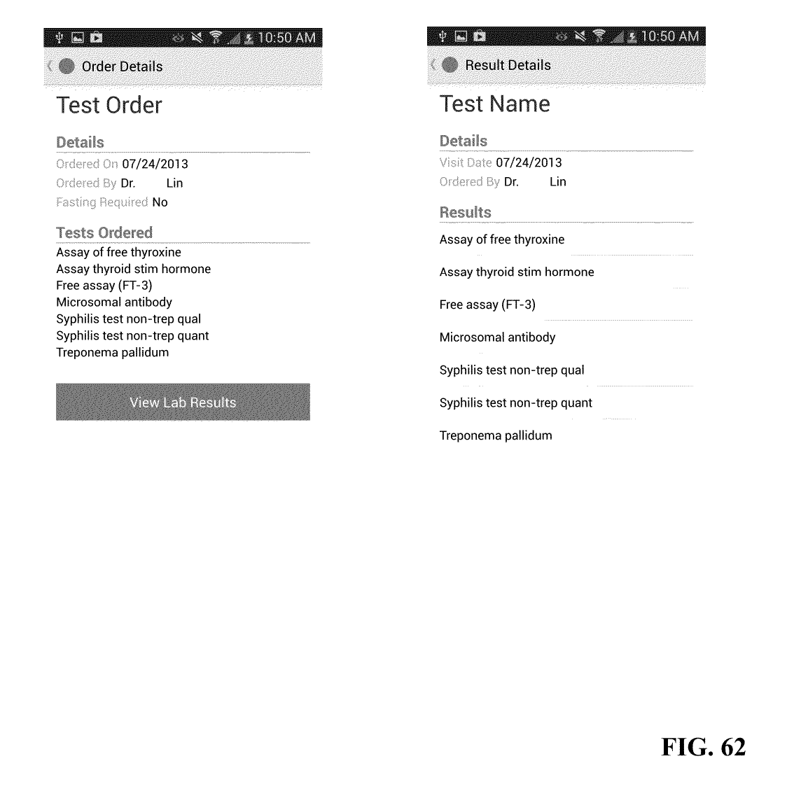

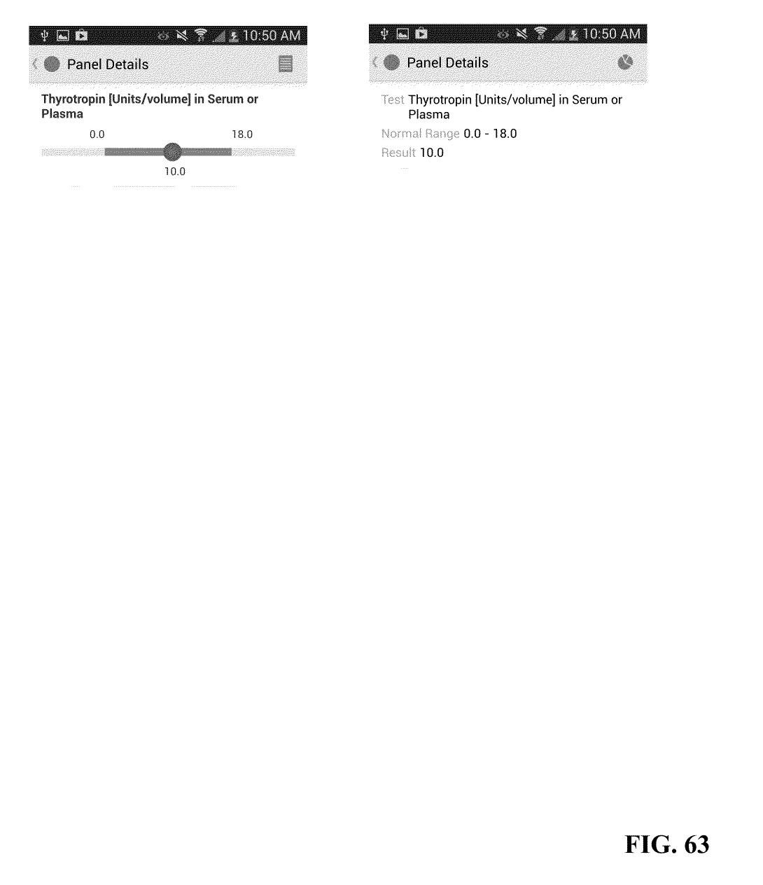

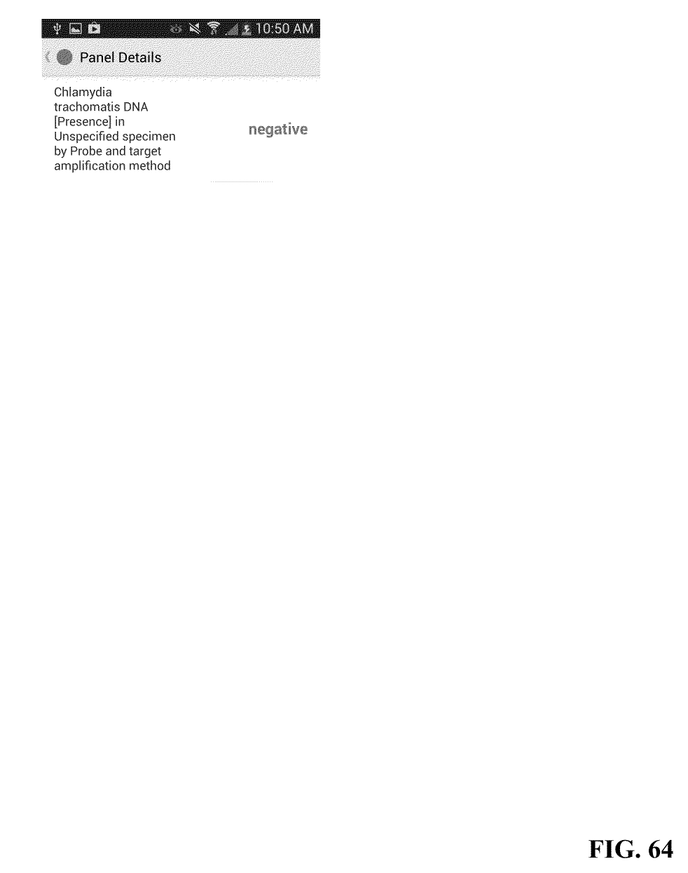

Referring now to FIG. 61, non-limiting examples of user interfaces/workflows for user lab orders and order details are shown. As seen in the screenshots, a green icon can be used to denote where a user can select different actions to bring-up a menu, dashboard, or the like. FIG. 62 shows additional order details and results details. FIG. 63 can show the panel details where the results are plotted along an acceptable range. Additional panel details can also be provided on the same or different screen. FIG. 64 shows a still further embodiment wherein the panel details and results are shown on the same page.

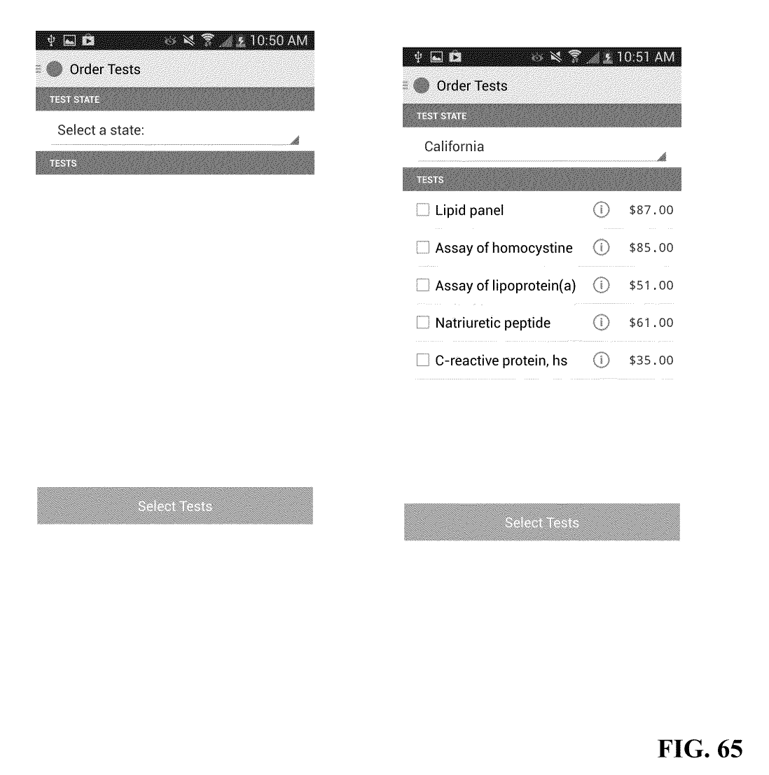

Referring now to FIG. 65, non-limiting examples of user interfaces/workflows for ordering tests, wherein when a user selects the state in which the user plans to have the test conducted. Optionally, some embodiments may have the system configured such that a default location is entered into the test order interface and the user can opt to change it. Optionally, the default location can be input based on the user location based on GPS, IP, and/or other location information. As seen in FIG. 65, once the test state is selected, a menu of available tests can be displayed, from which the user can select the desired test(s). Optionally, pricing for the tests can also be display. It should be understood that in some embodiments, the pricing is shown for an un-subsidized and/or non-insurance covered user. Optionally, the pricing may include an additional column and/or other display option showing pricing based on default insurance coverage, some default pricing based on different insurance company, and/or based on insurance (primary, secondary, or otherwise) that the user has input into their profile. Optionally, the pricing based on insurance which the user may not have can be used to suggest to the user that certain insurance coverage may be beneficial to them. By way of non-limiting example, there may also be a link or click if the user desires to find out more about the sign-up, pricing, and/or cost for health insurance. This can result in a browser or other software application being opened that brings the user to a different user interface that has more information about the potential insurance coverage or other product that can be interest to the user.

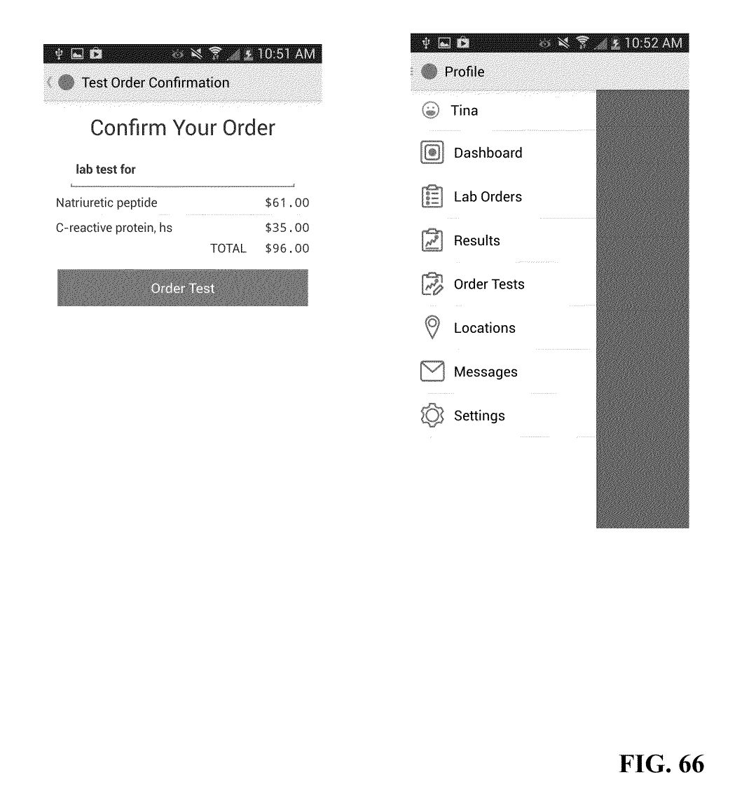

Referring now to FIG. 66, still further aspects of various user interface embodiments will now be described. FIG. 66 shows that a user can confirm the test order which may or may not also include the pricing. It should be understood that for those with insurance coverage, the pricing may be reduced to a single co-pay payment that would be the amount, assuming that insurance coverage for that test is or can be verified. Some embodiments may optionally also display a second dollar amount that would be the charge if the user's insurance authorization is not approved. A user may optionally be requested to confirm their order more than once, such as but not limited to clicking two check boxes or other confirmation interface, thus confirming that the authorize payment for either the insurance covered and/or the non-insurance covered pricing. Optionally, some embodiments can perform the dual confirmation by using separate user interface screens or the like.

As can be seen in FIG. 66, user menu screen can also be shown on one portion of the screen. Although full screen coverage is not excluded, the menu screen can be a menu that covers only a portion of the entire screen, leaving other portions visible and/or shadowed.

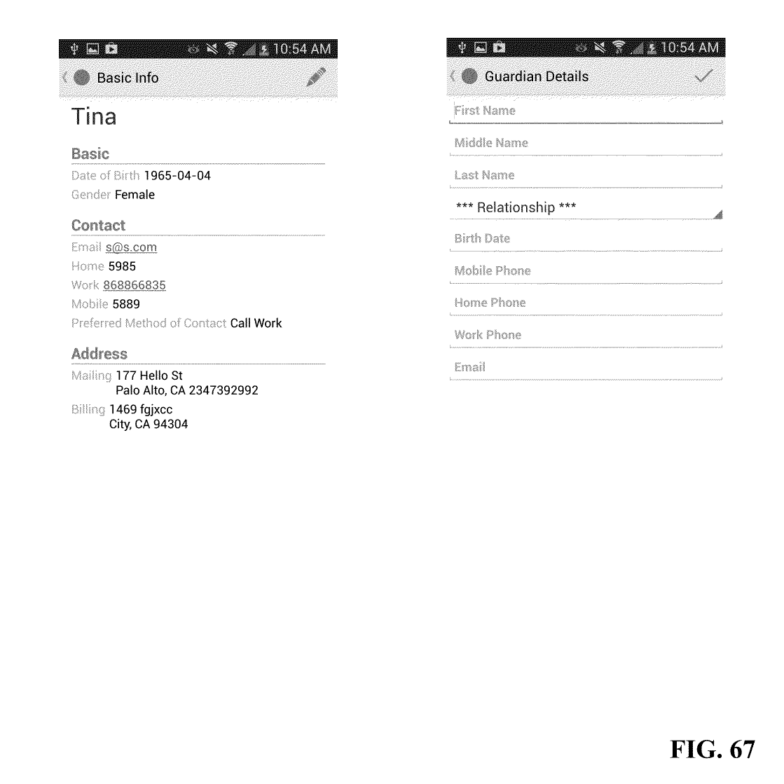

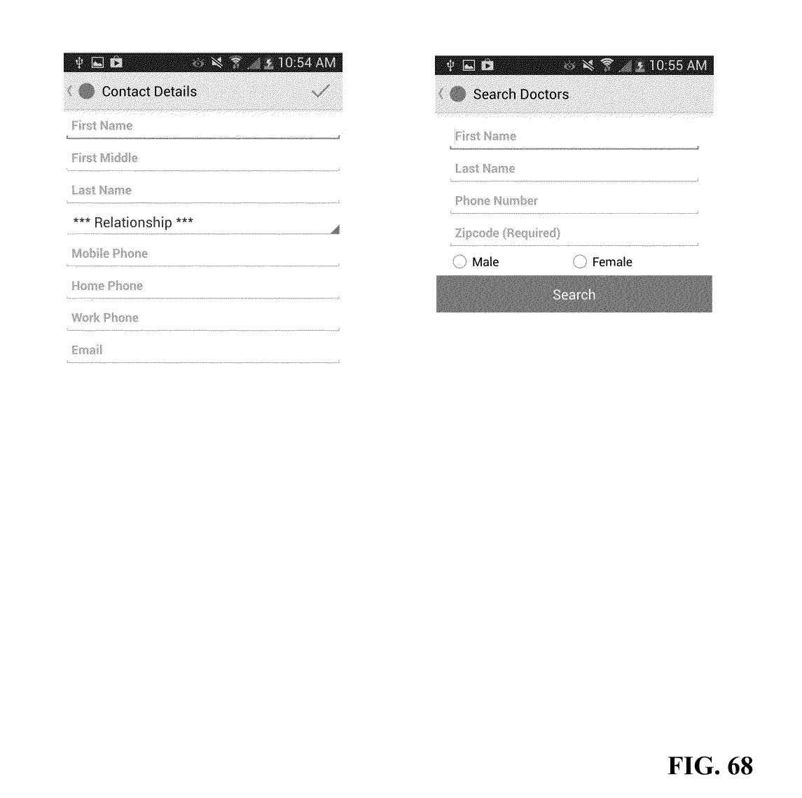

Referring now to FIGS. 67 to 68, still further aspects of various user interface embodiments will now be described. FIGS. 67 to 68 show user interfaces for basic information about the user, guardian details, contact details, search doctors, and/or other information about the user.

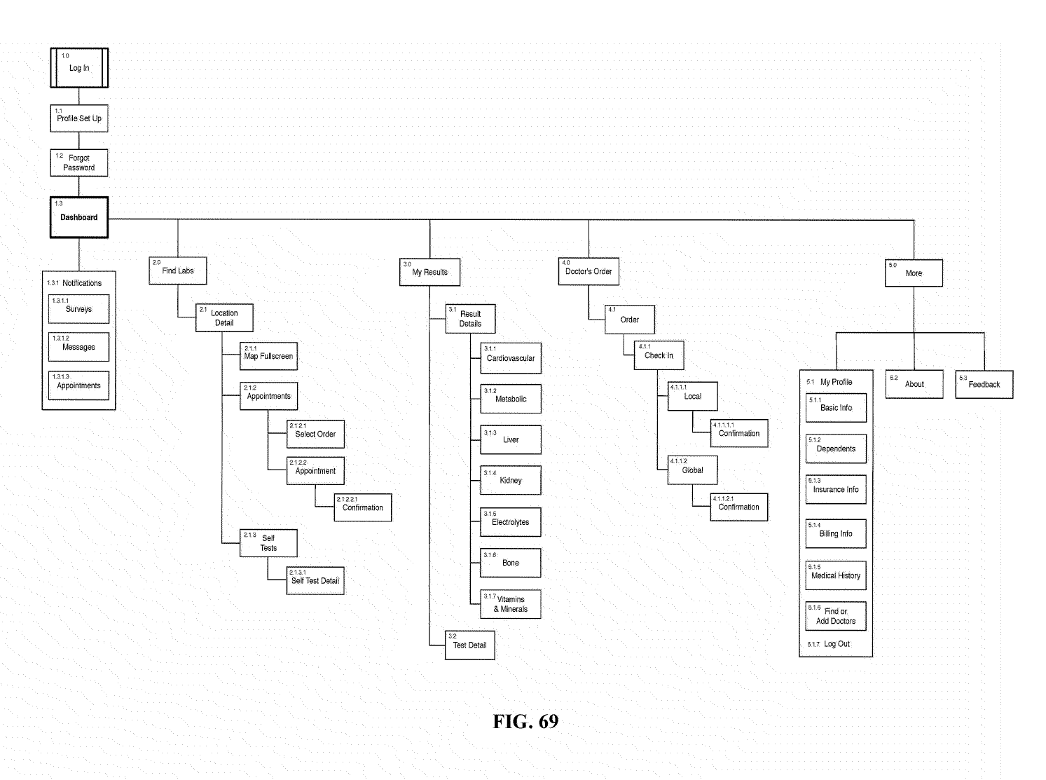

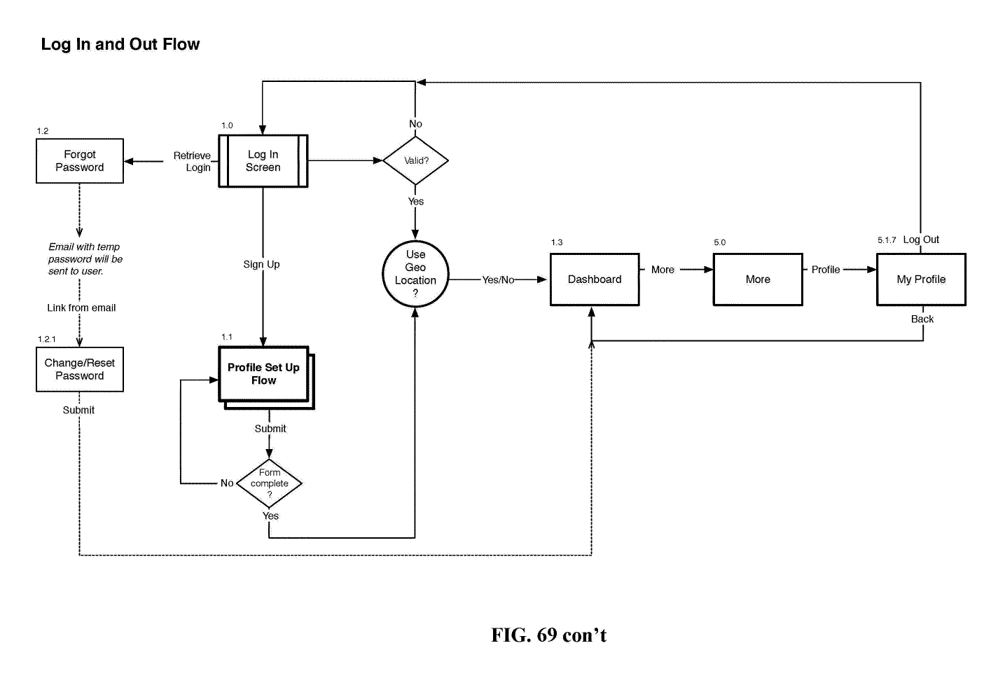

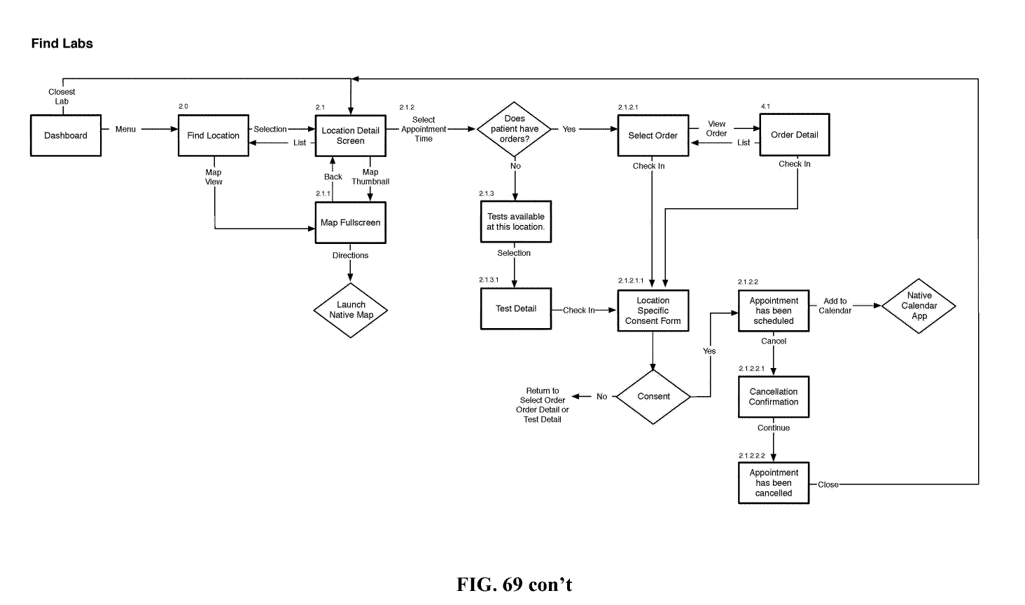

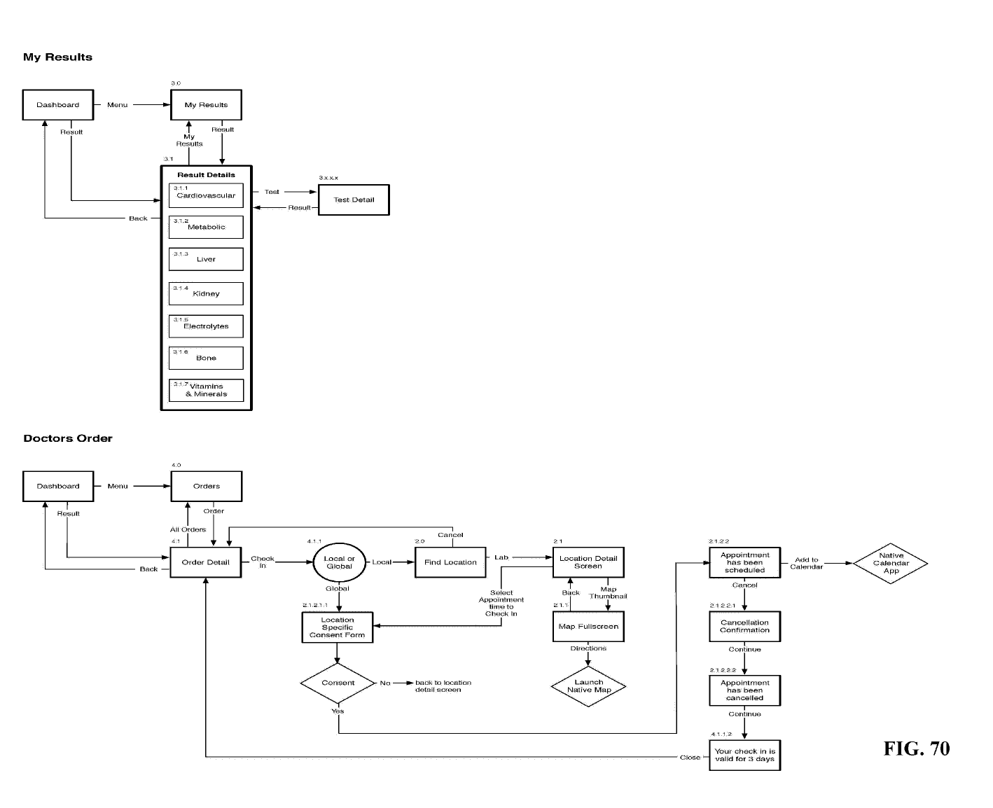

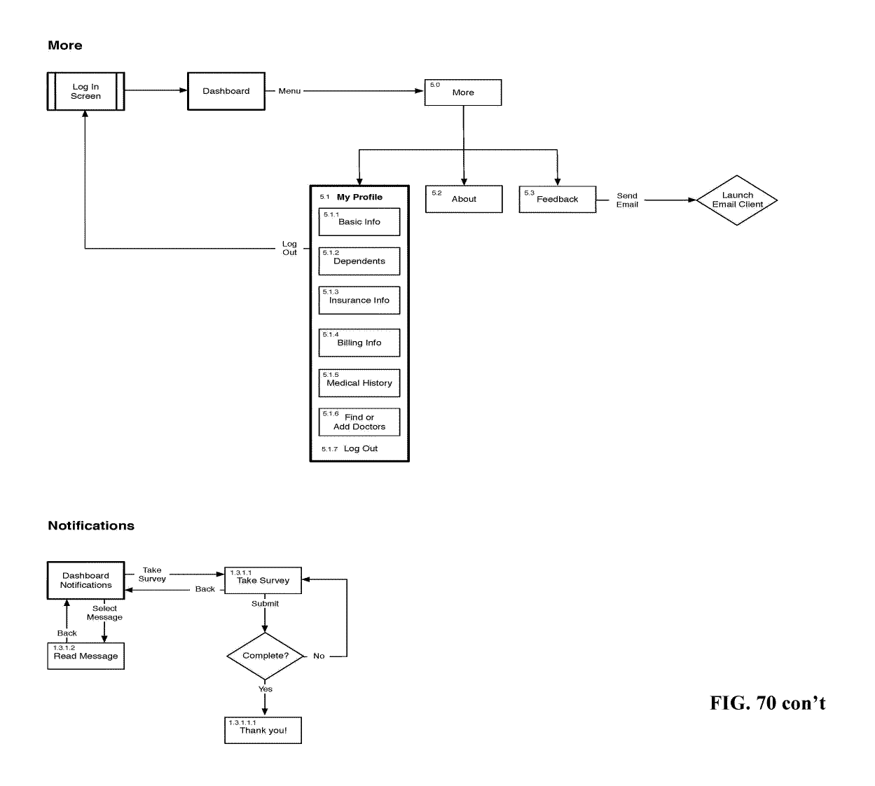

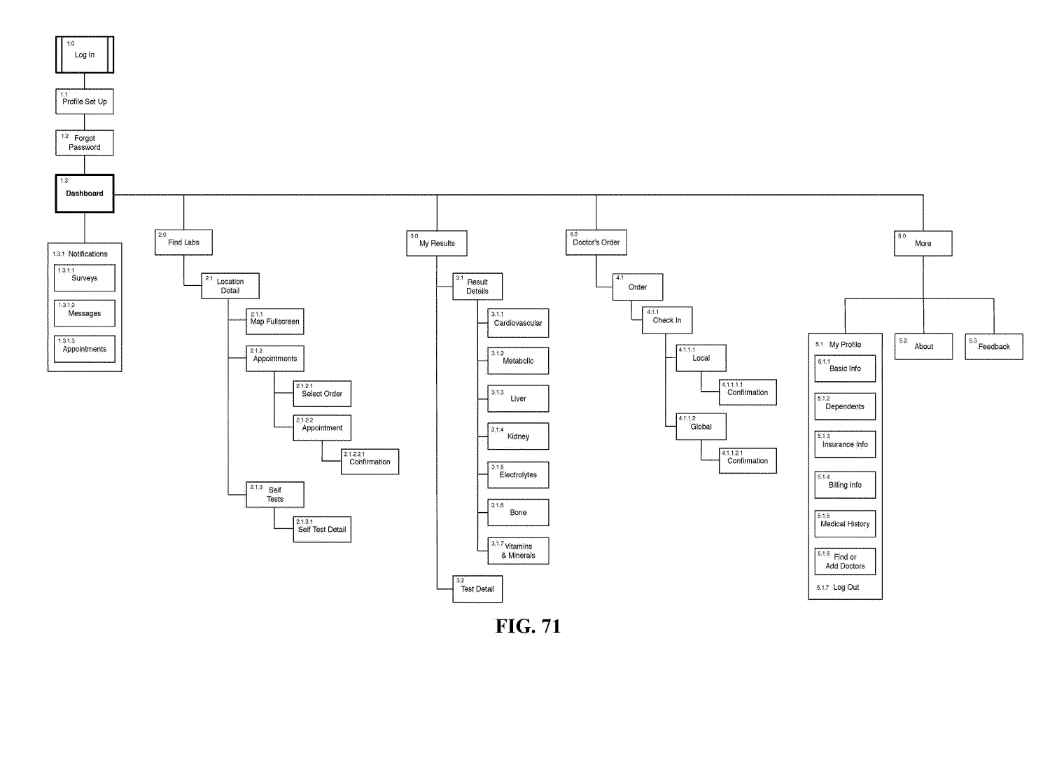

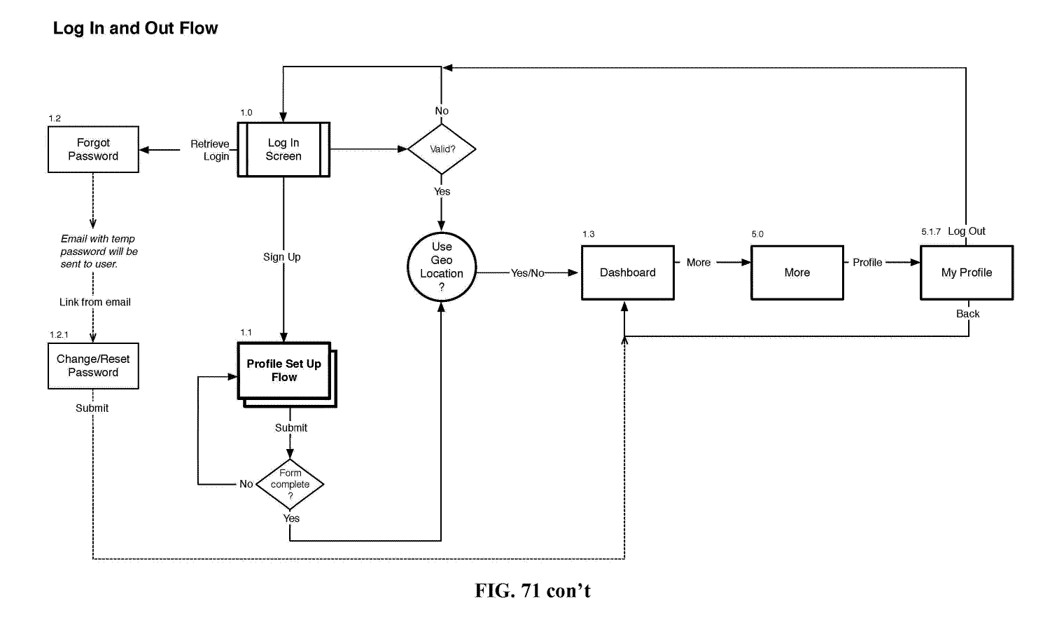

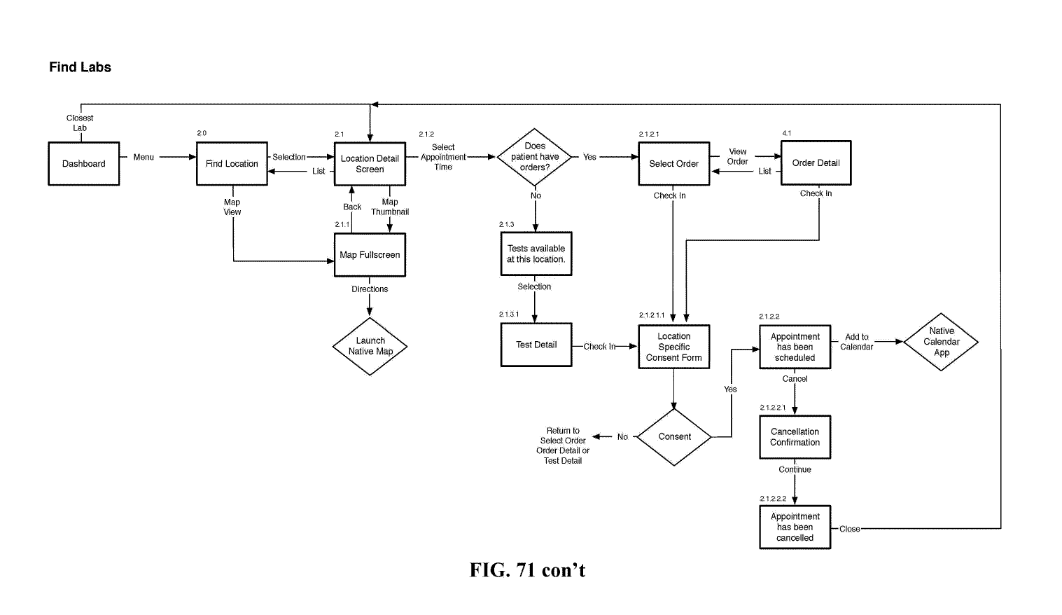

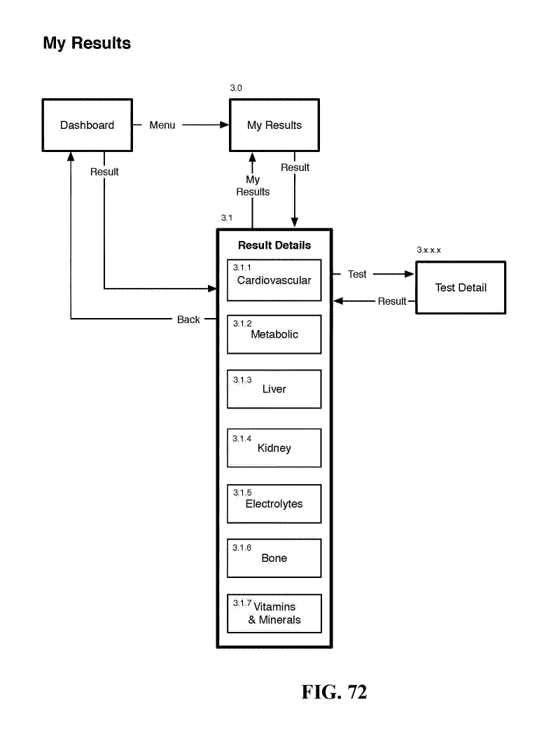

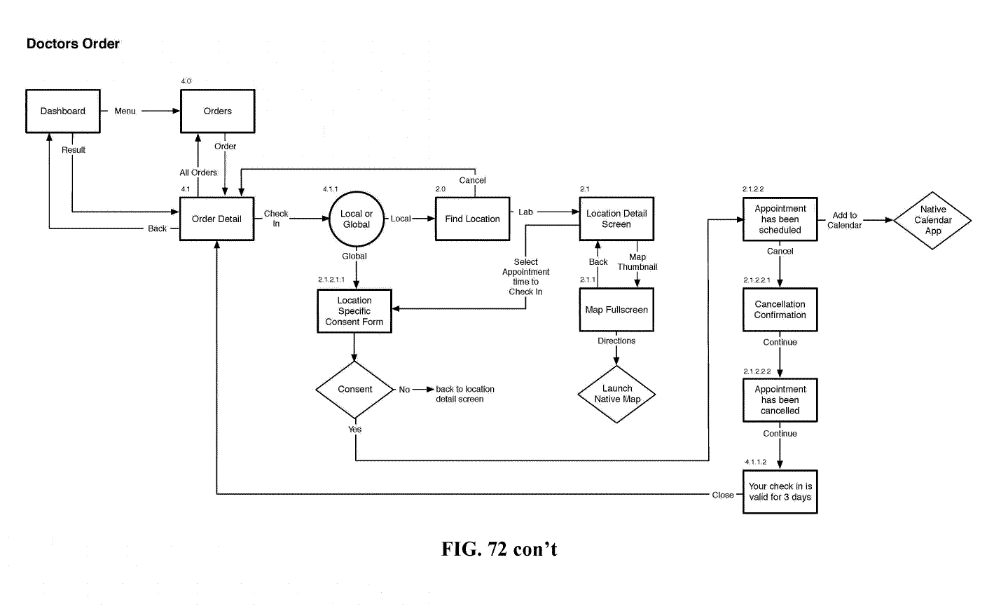

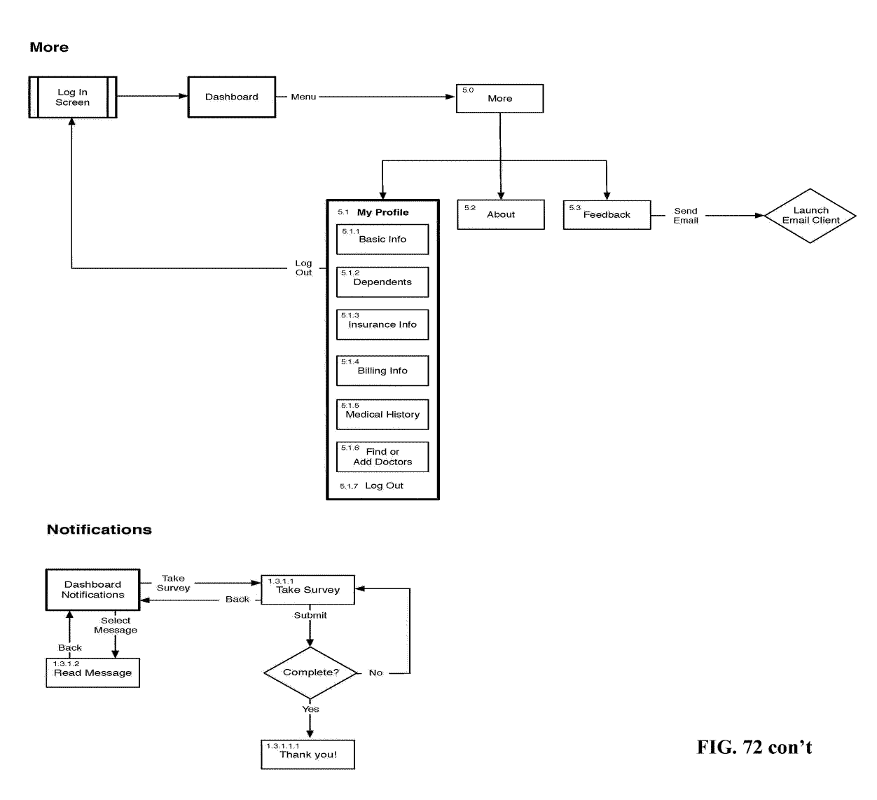

Referring now to FIGS. 69 to 72 provide non-limiting examples of workflows associated with many of the user interfaces described herein.

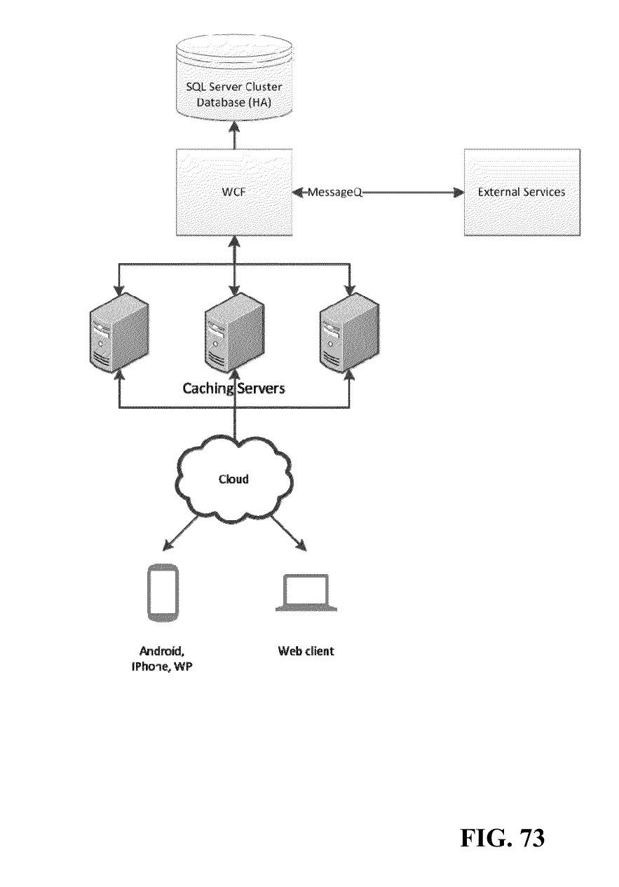

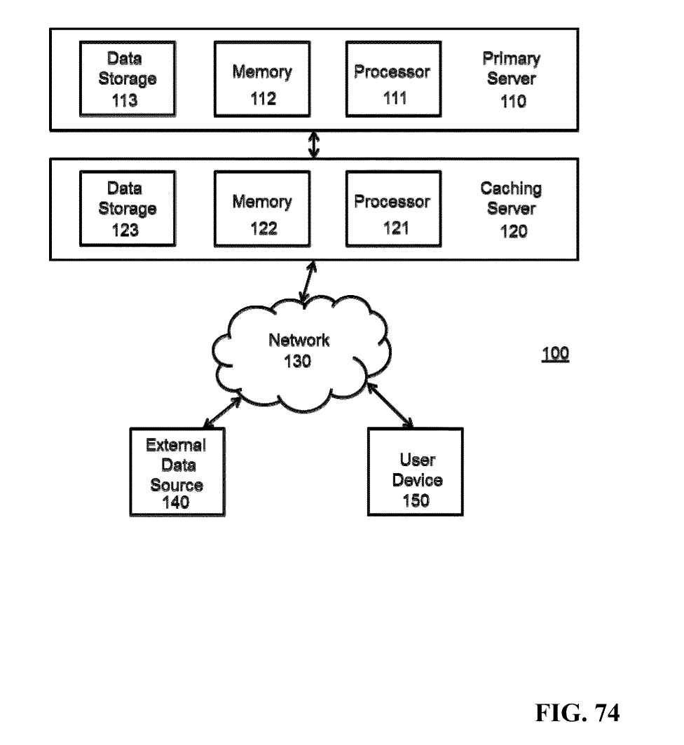

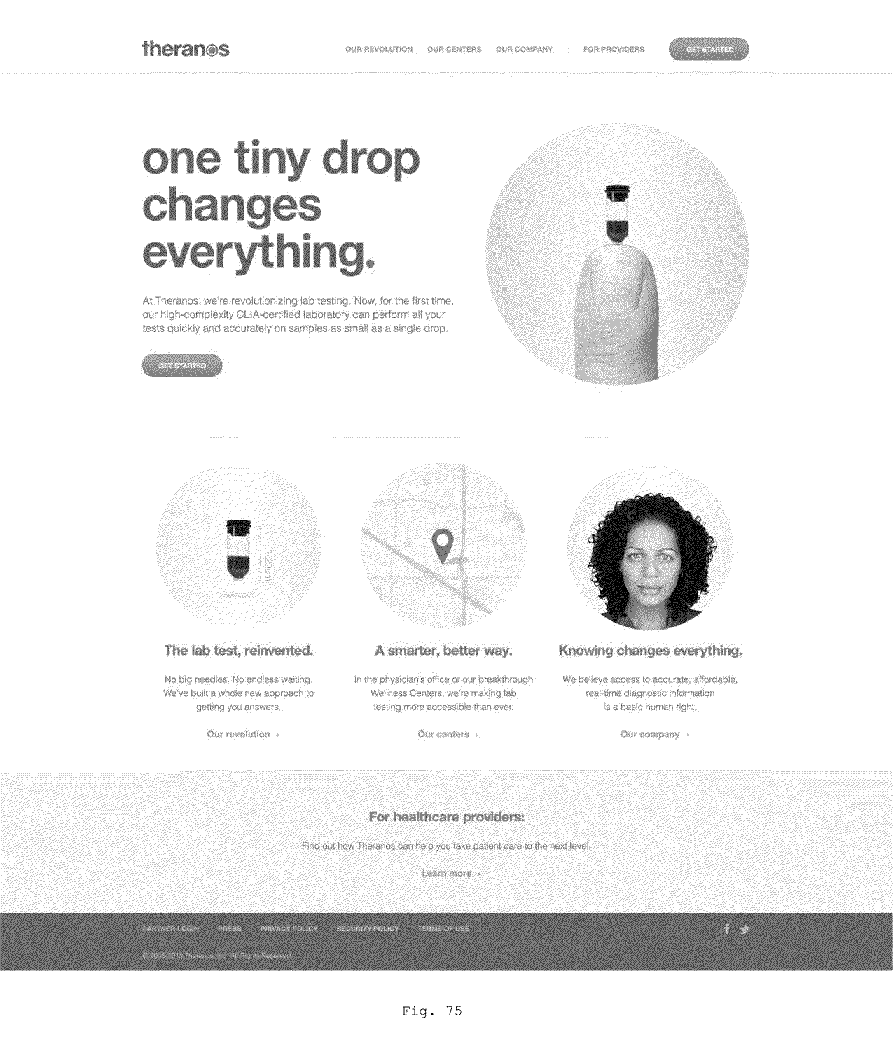

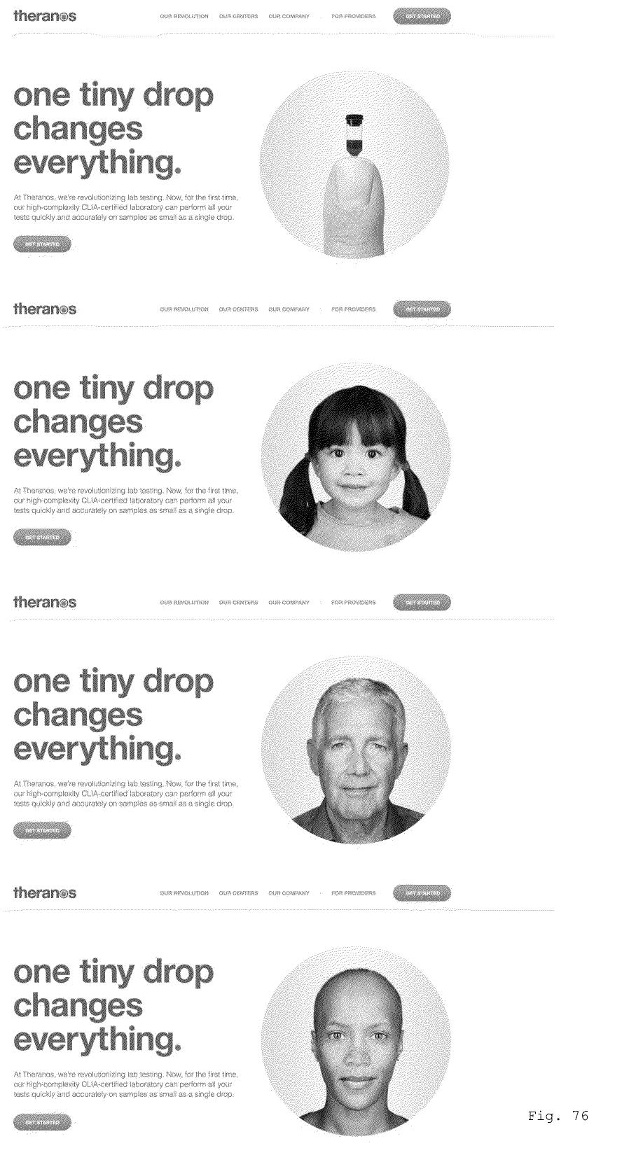

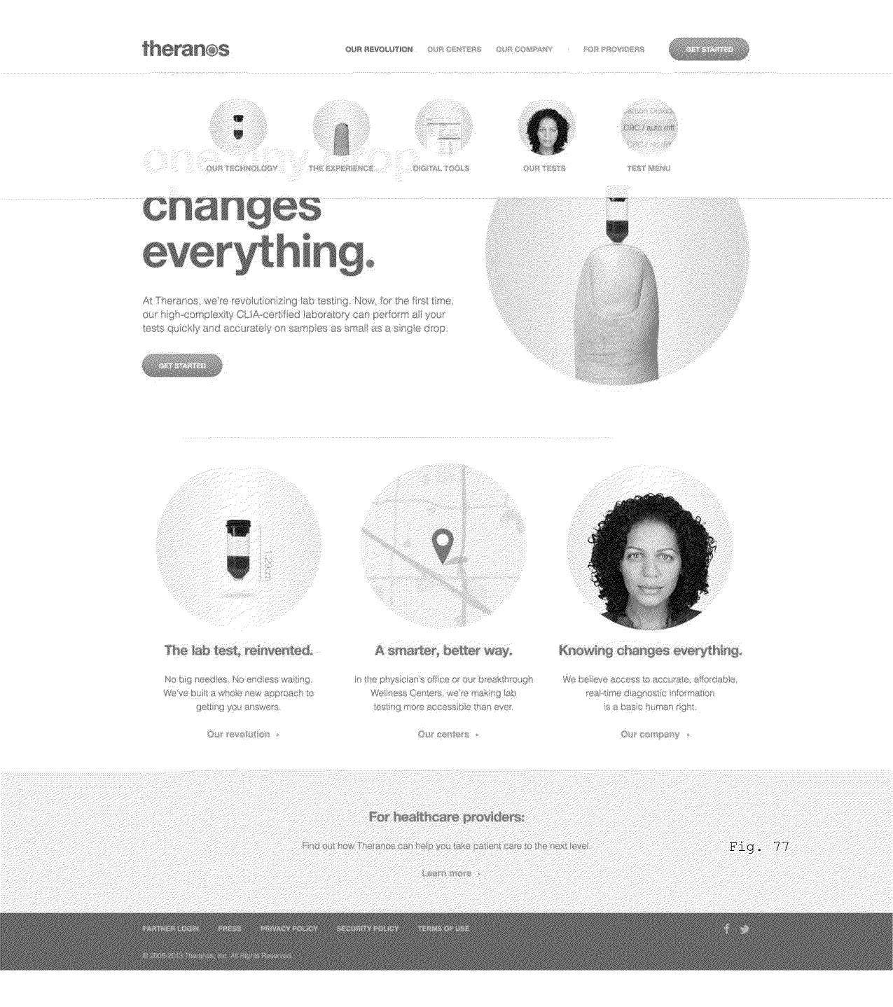

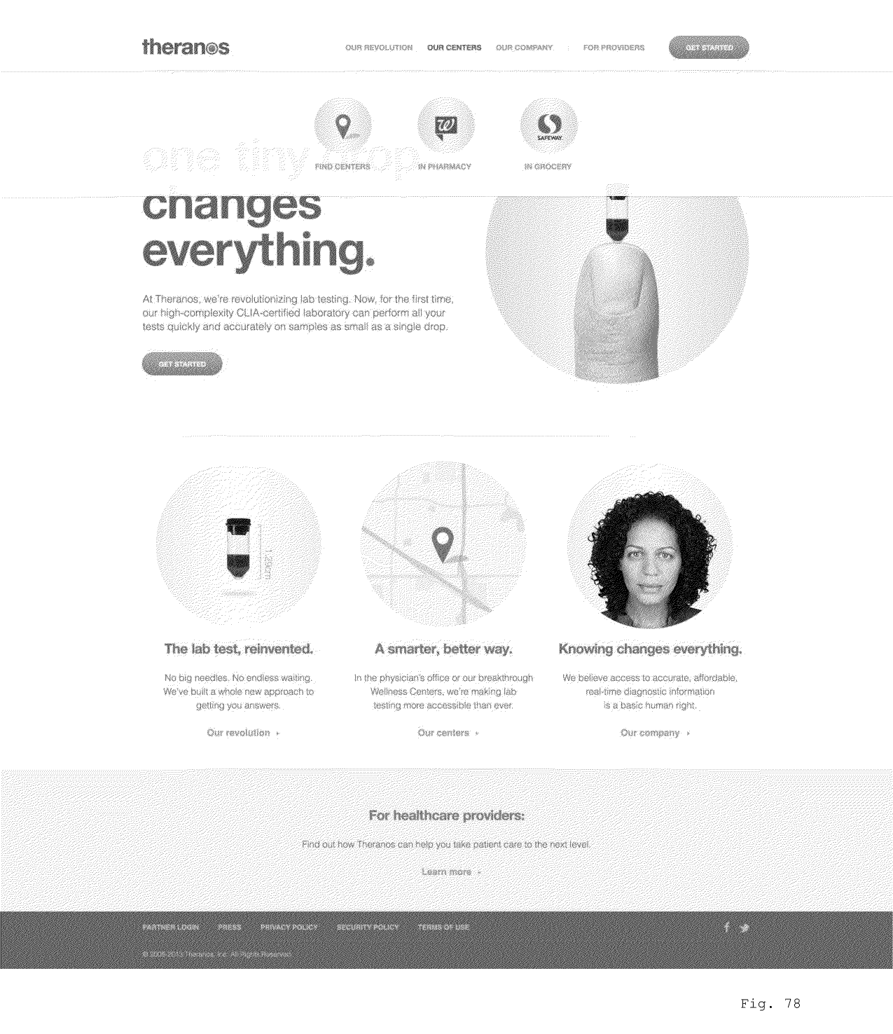

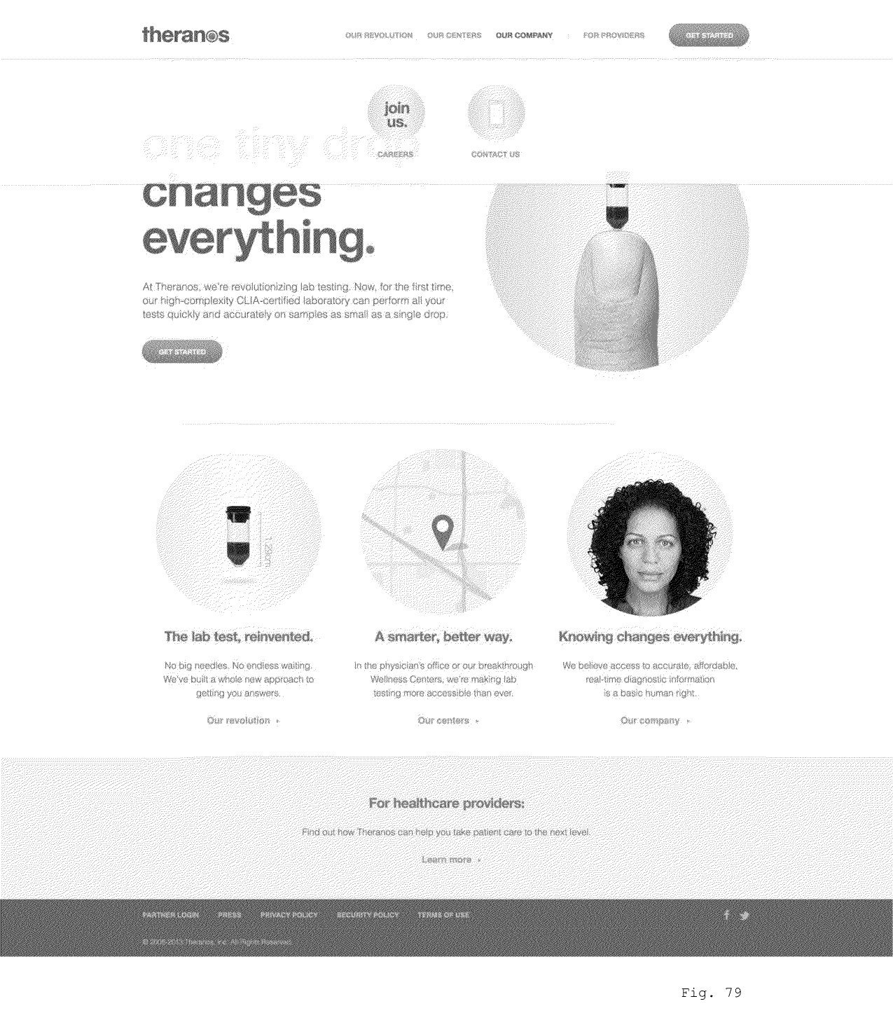

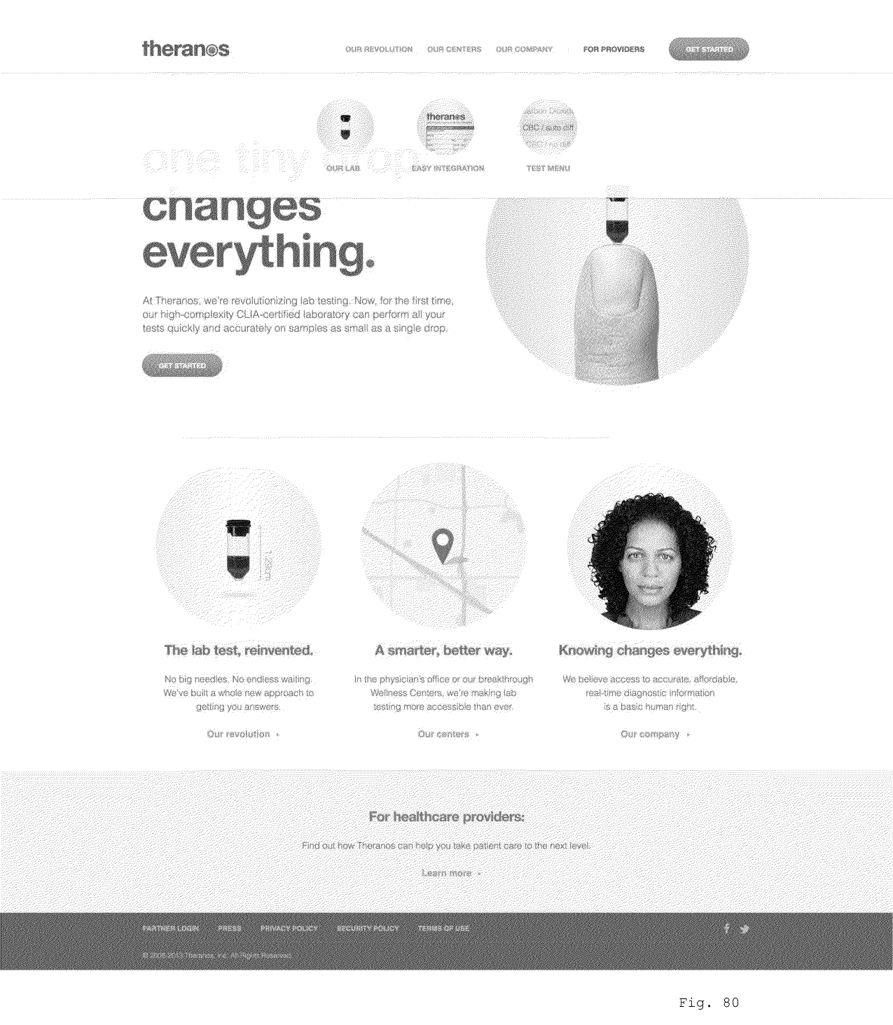

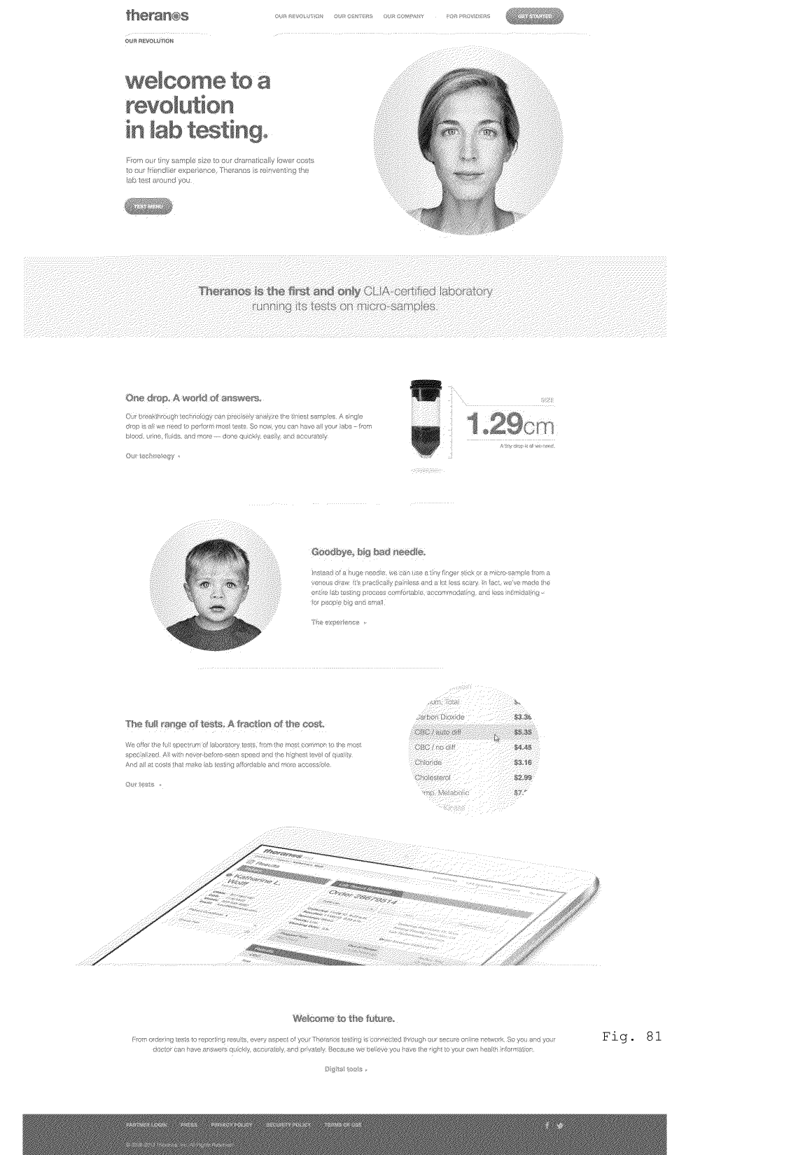

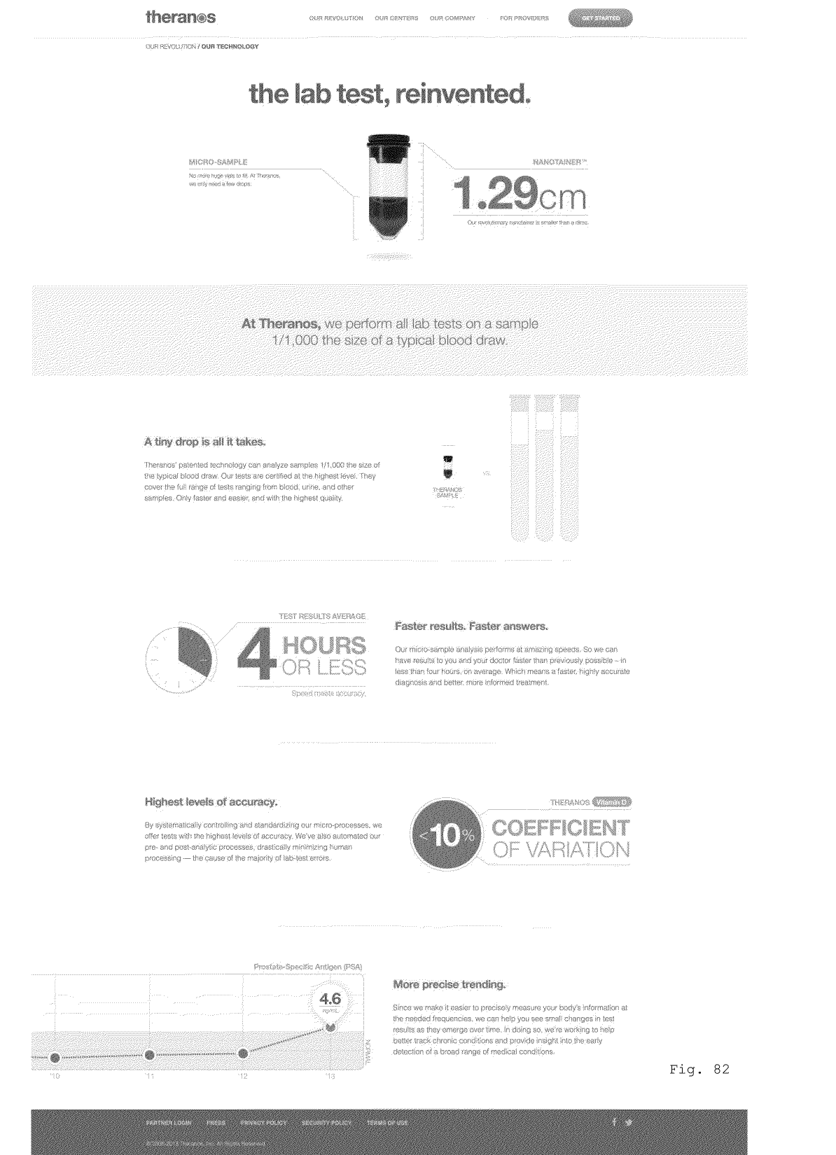

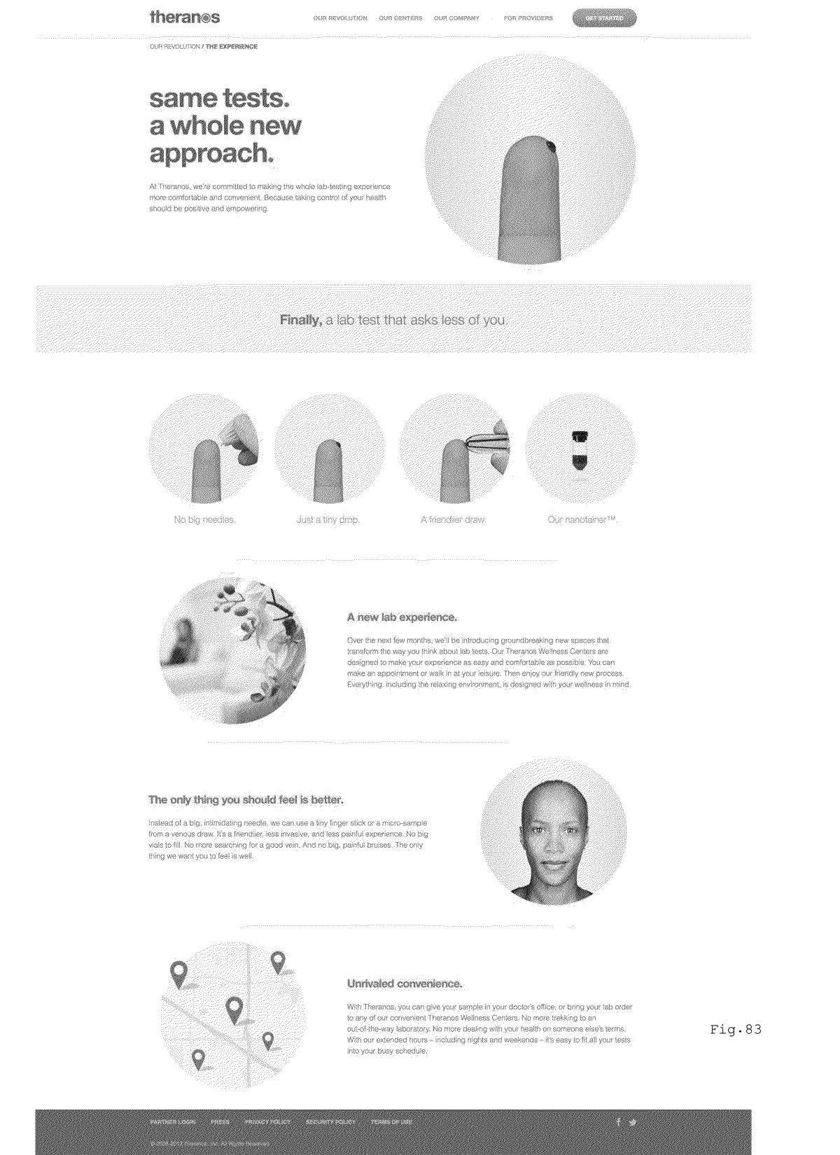

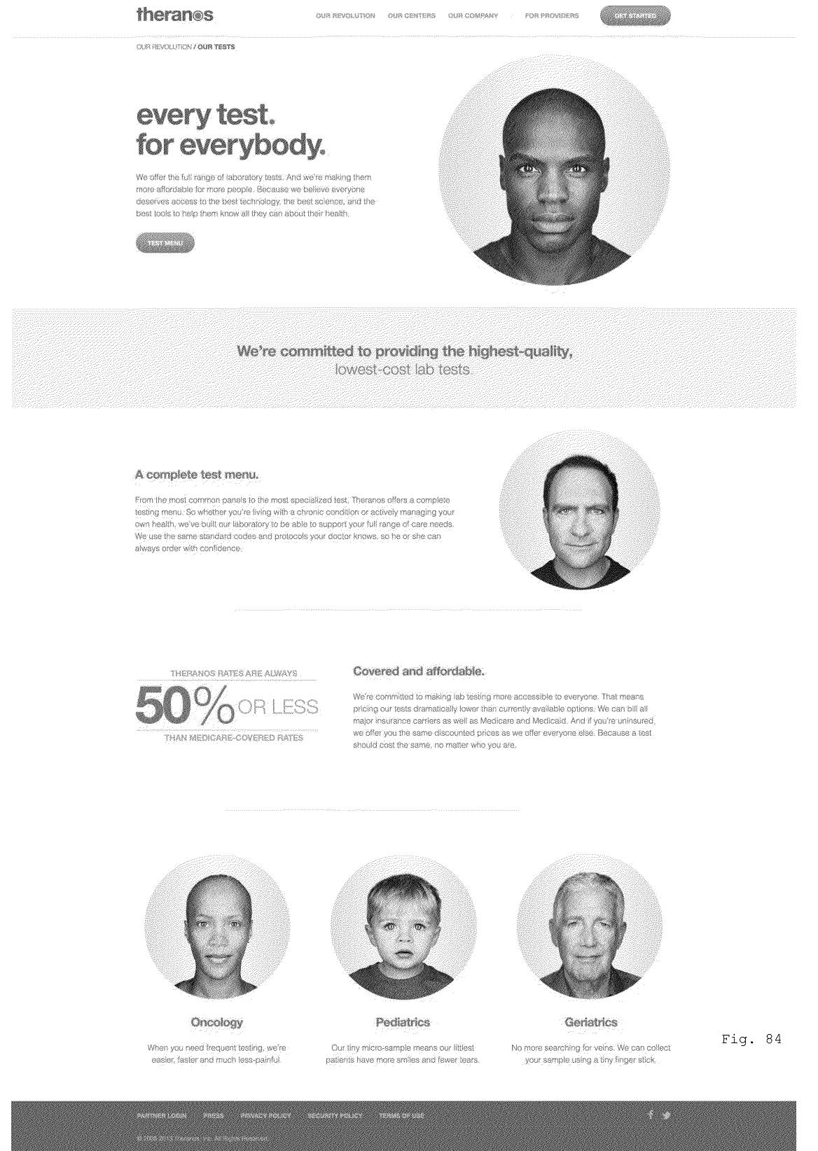

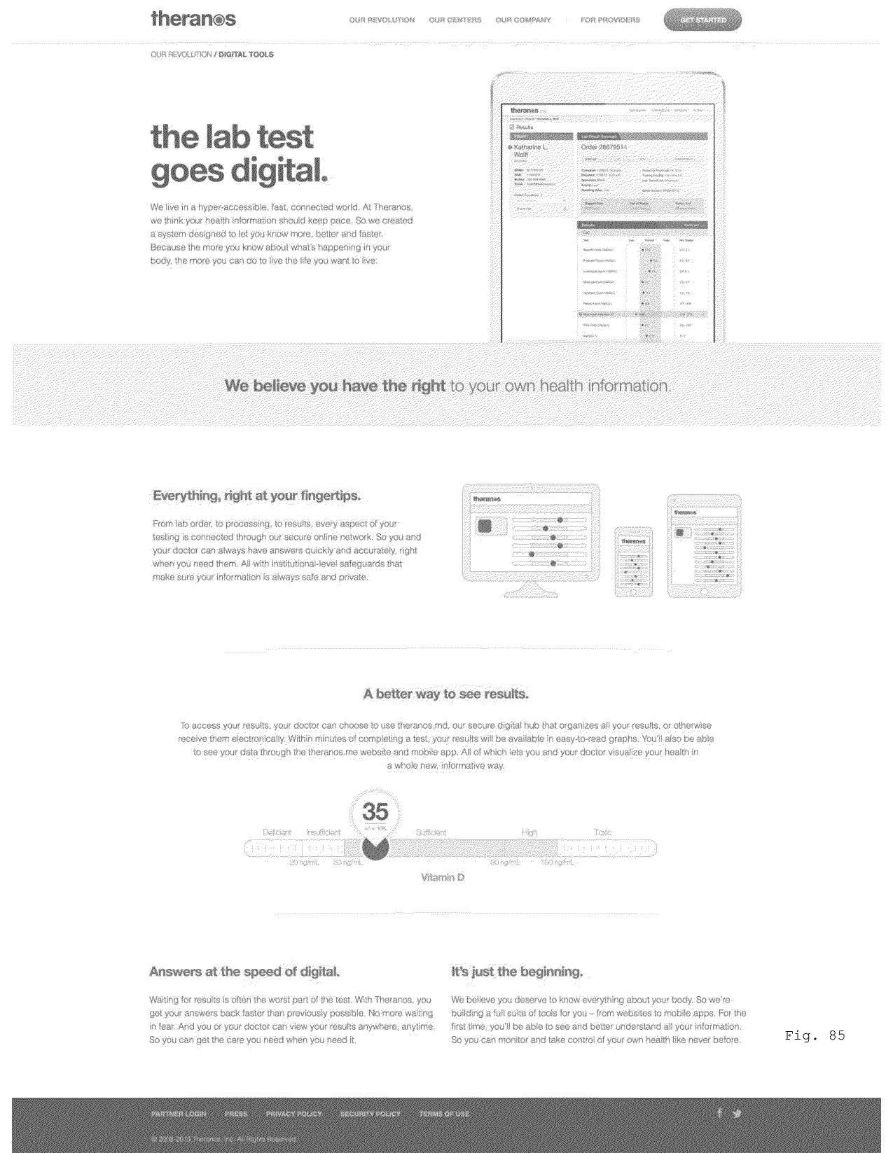

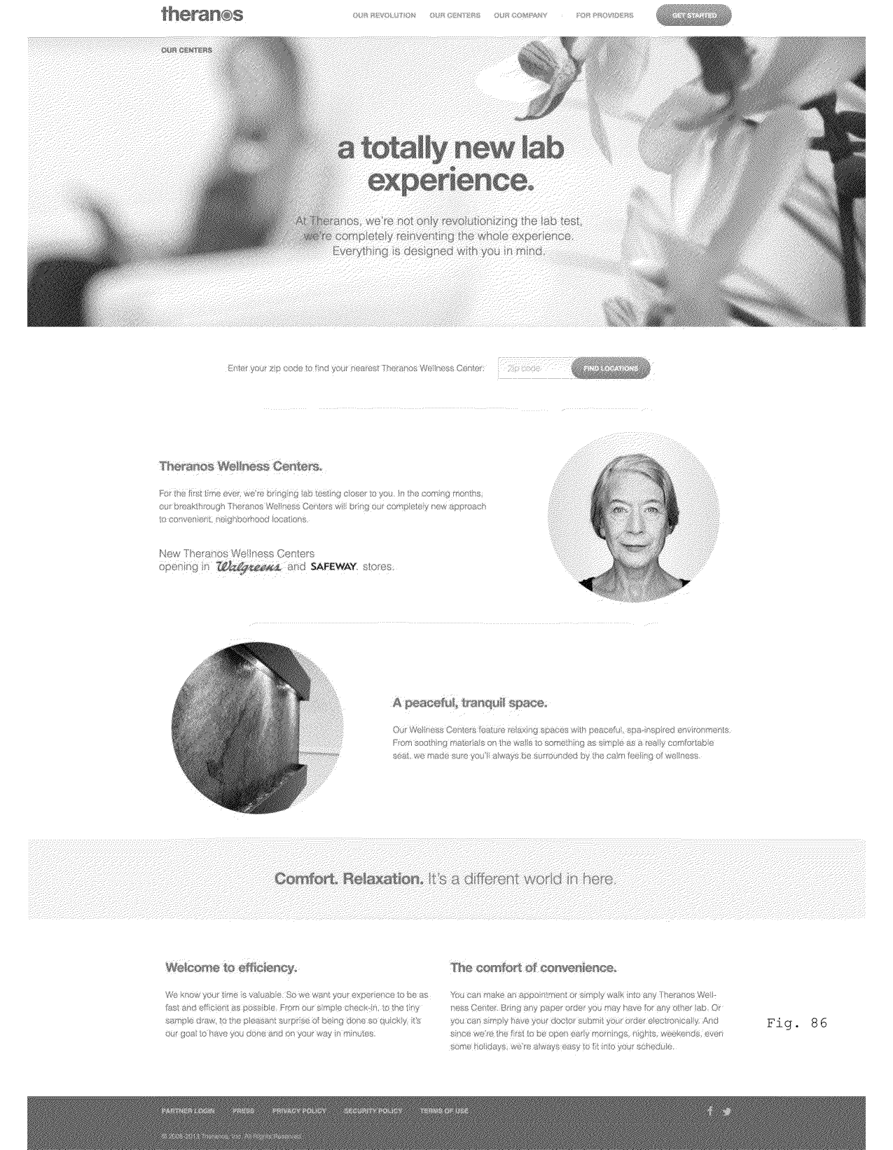

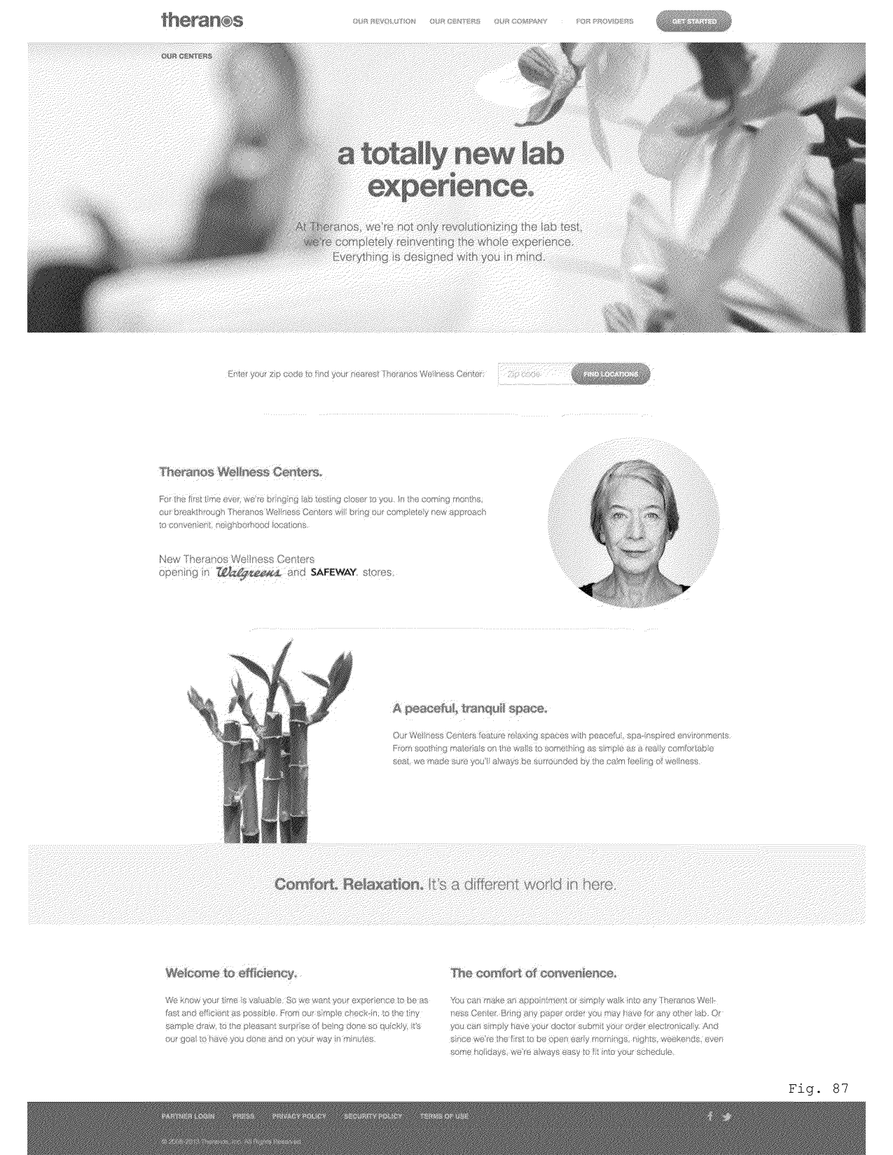

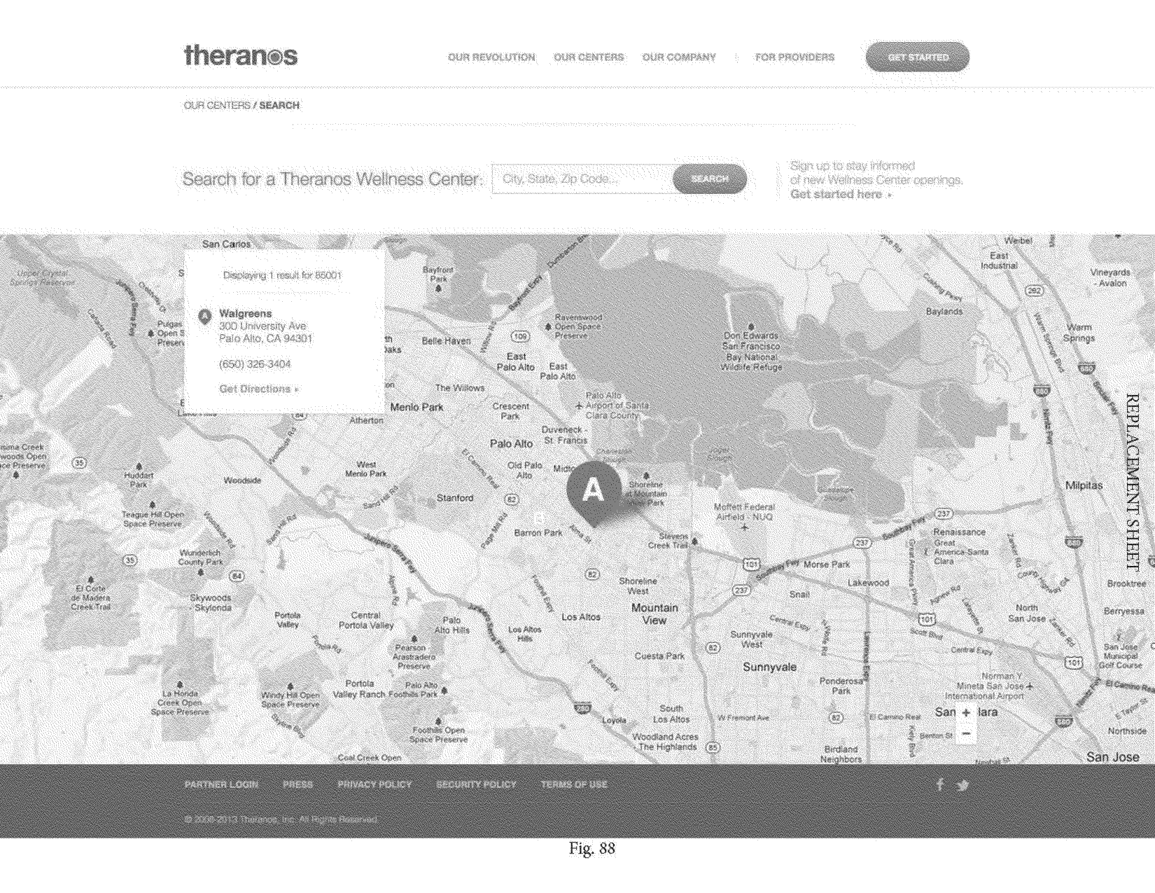

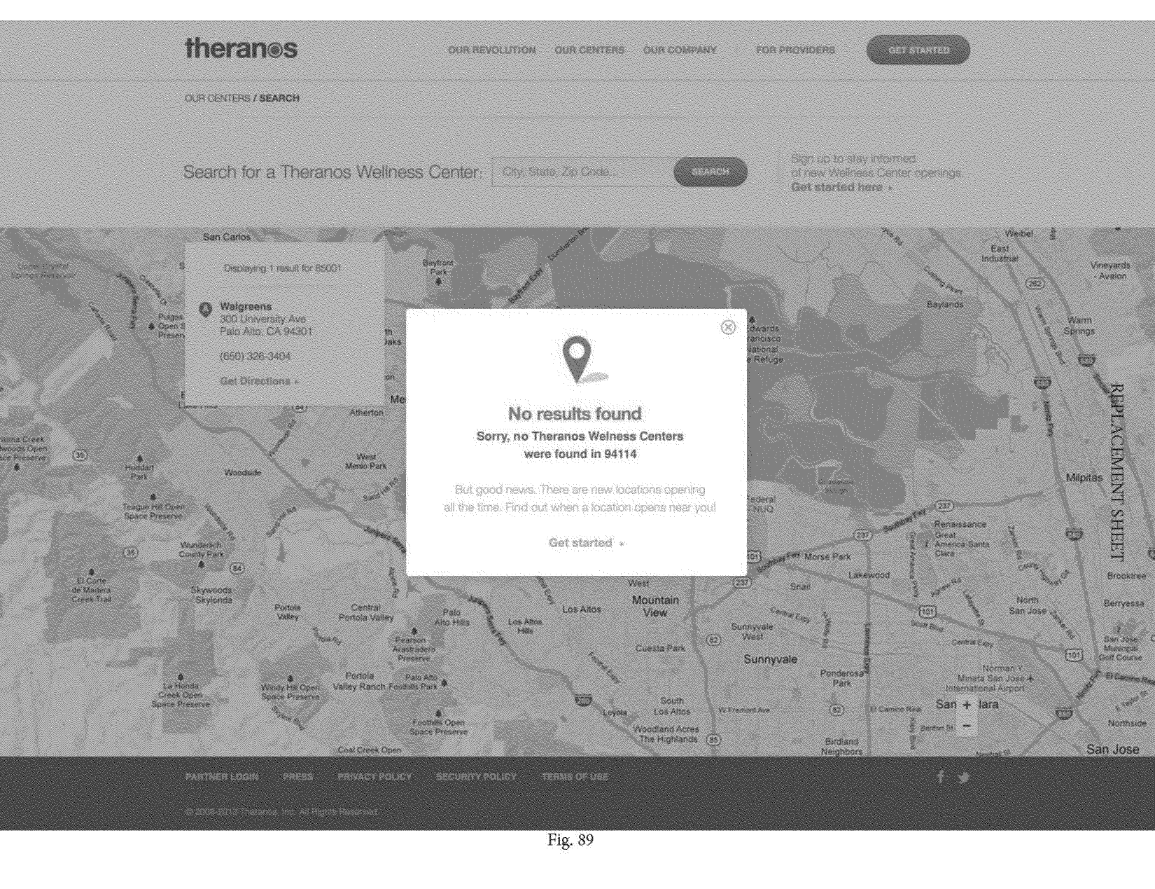

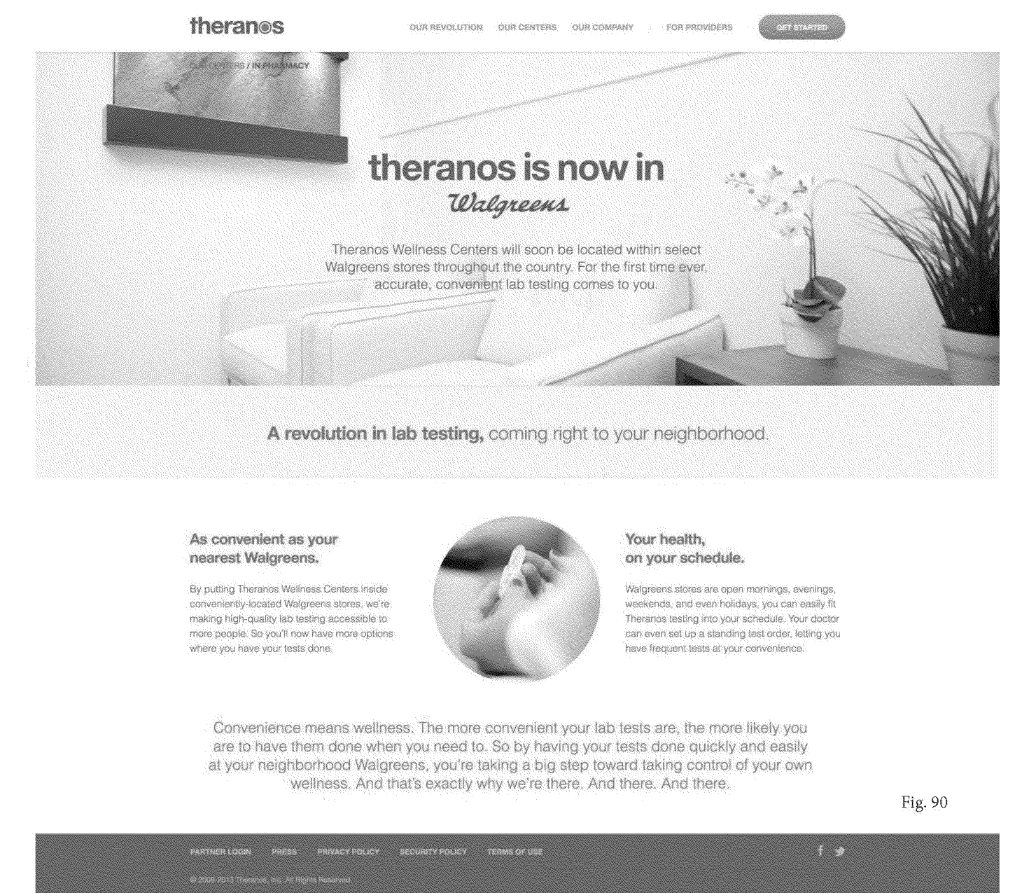

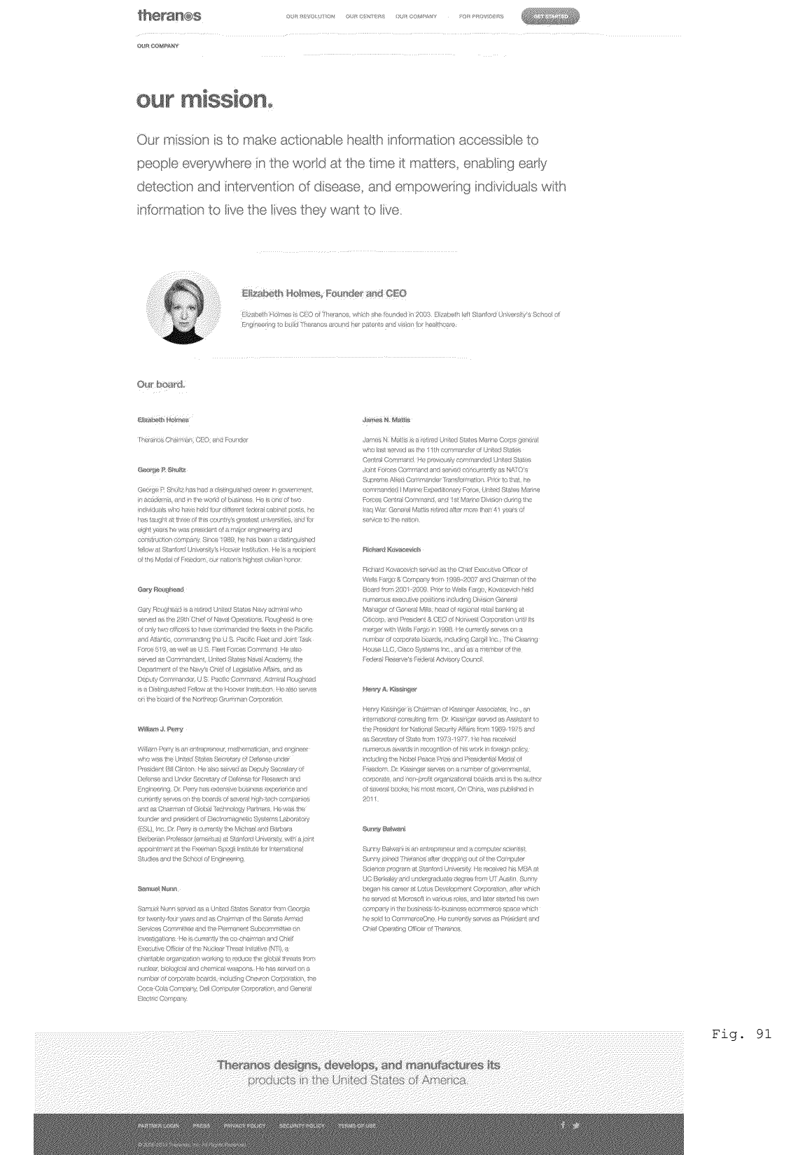

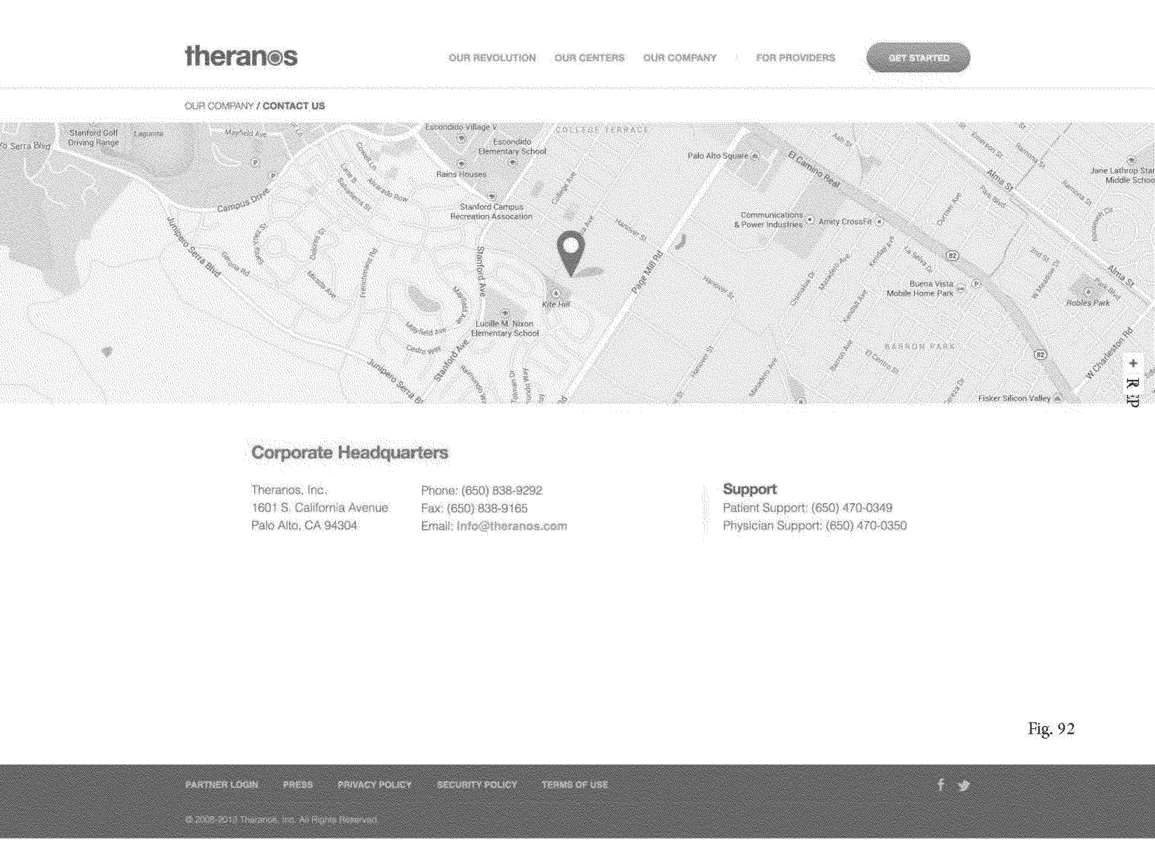

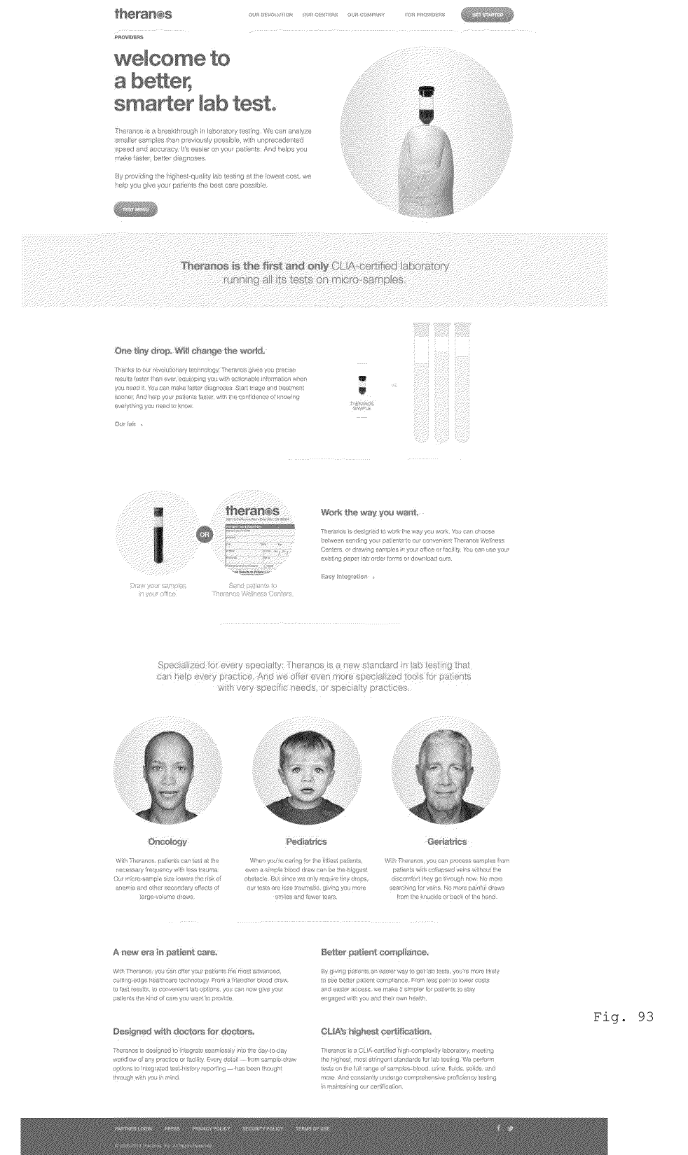

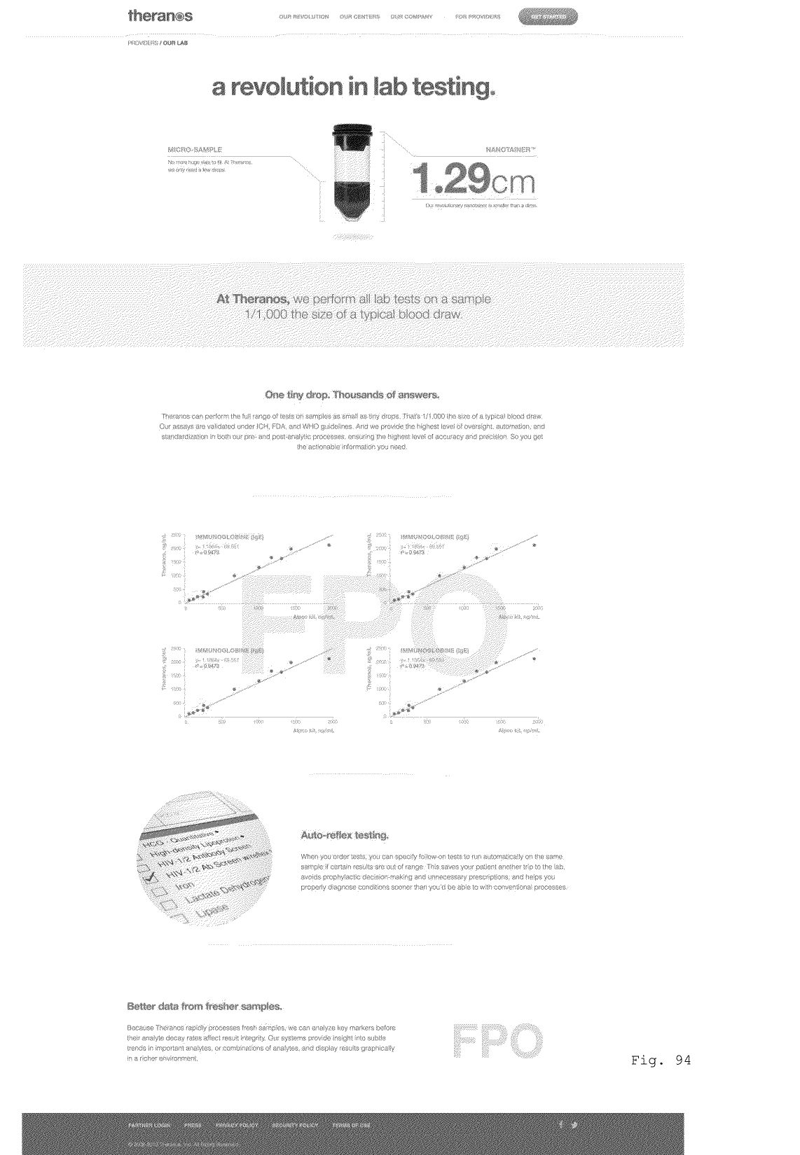

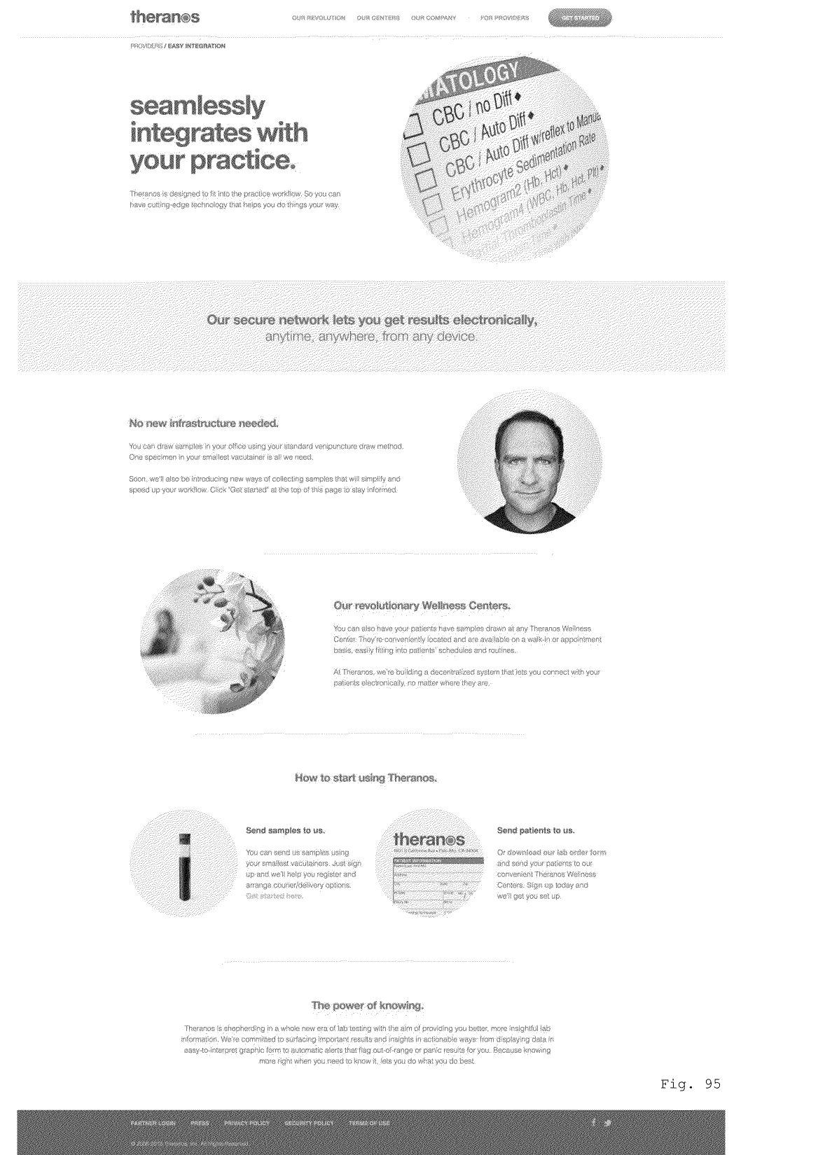

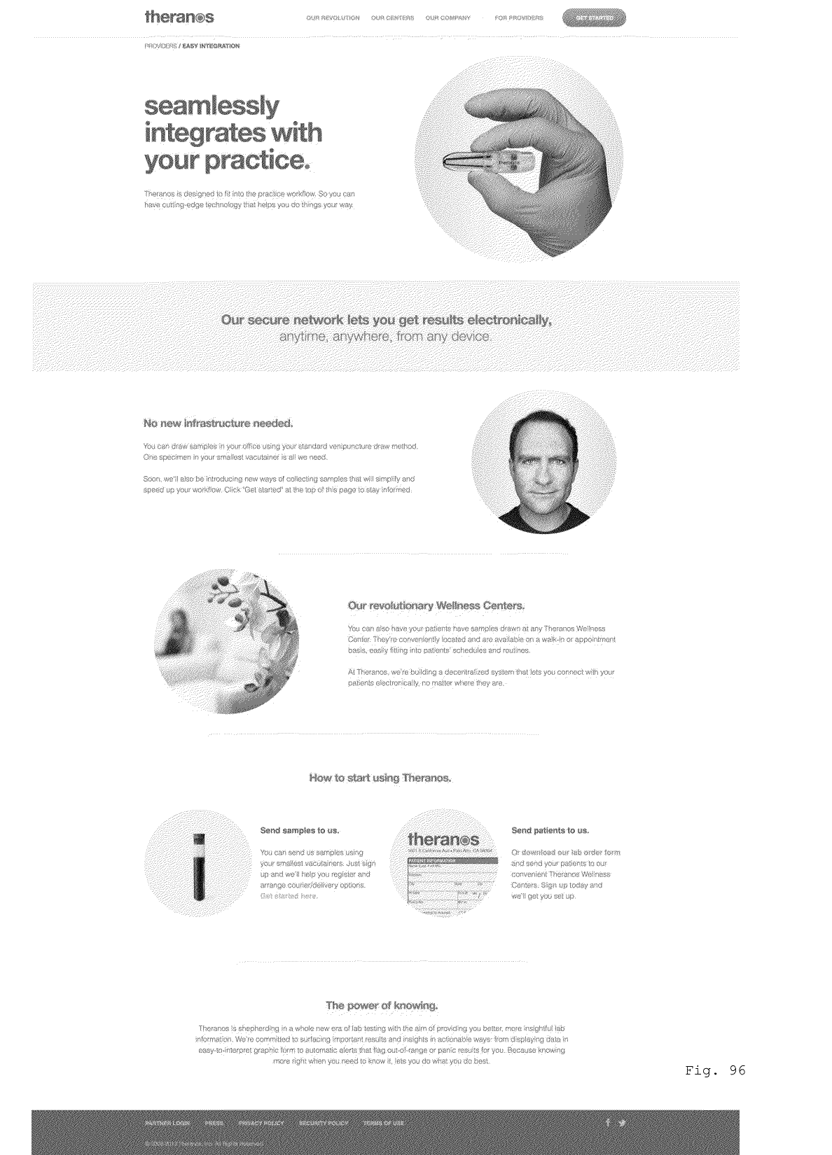

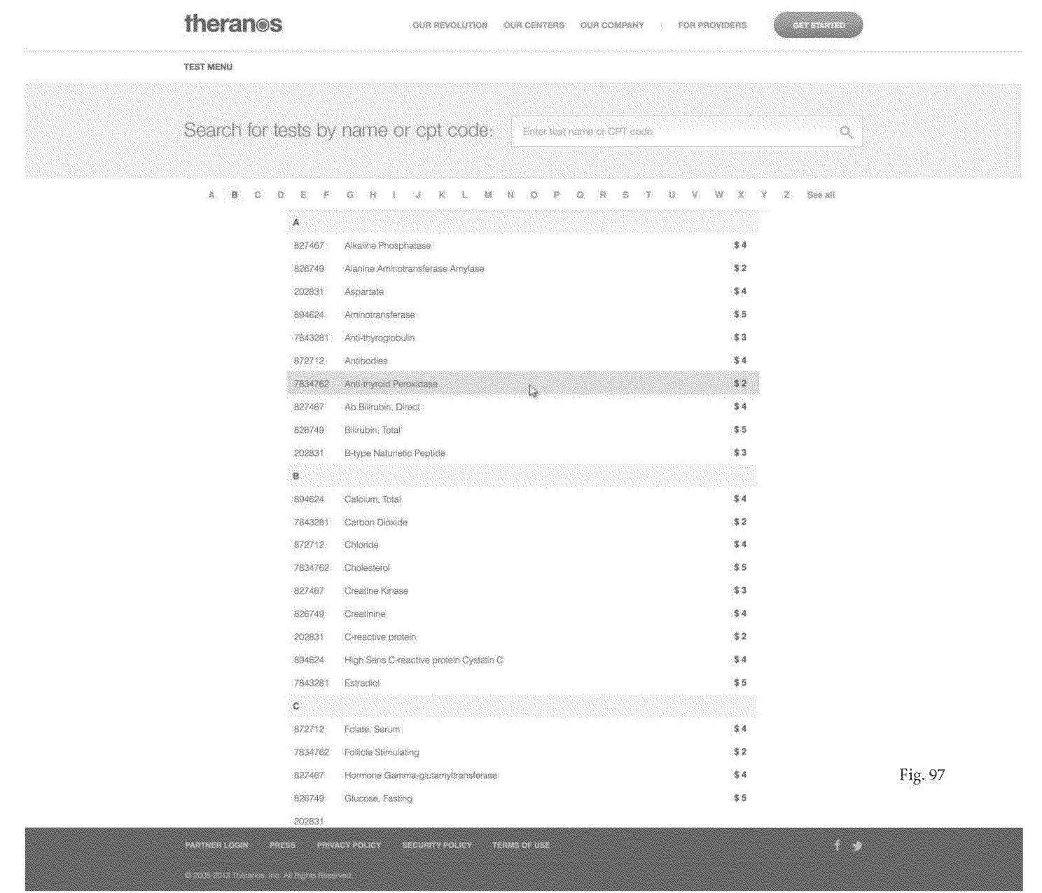

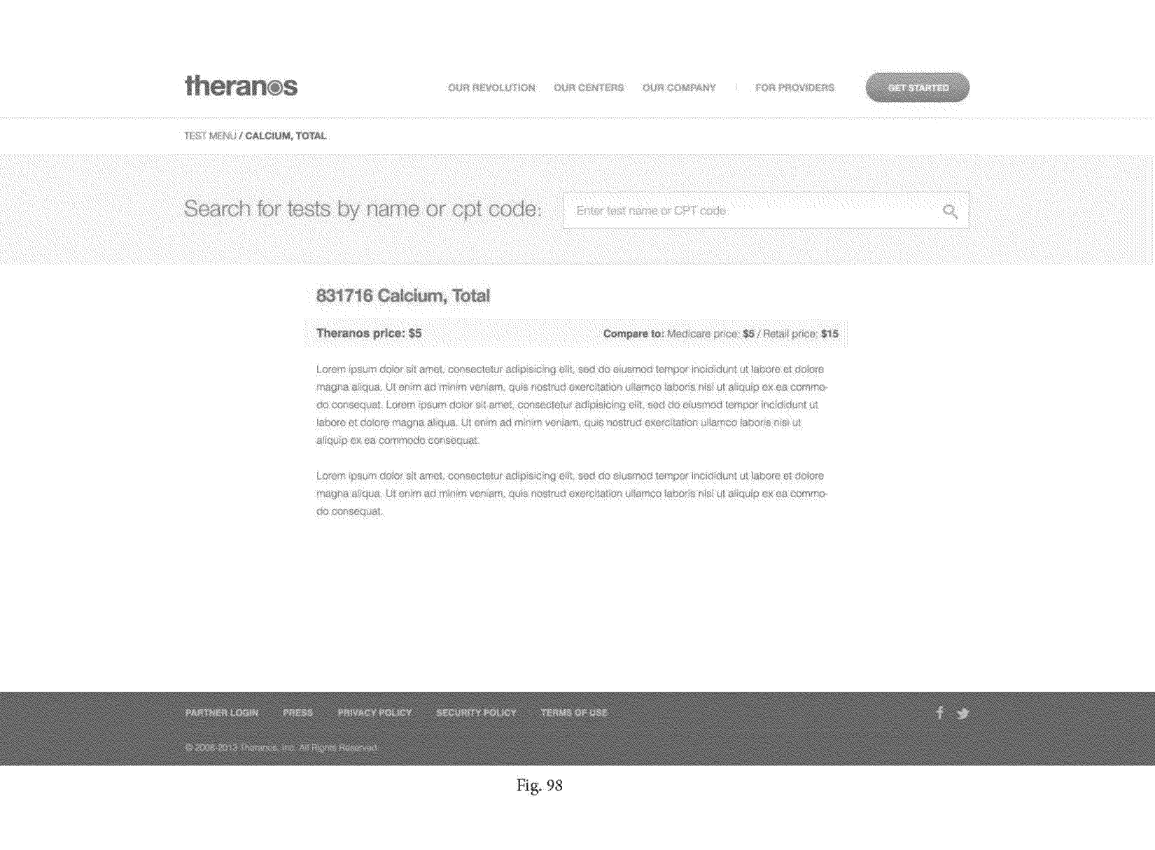

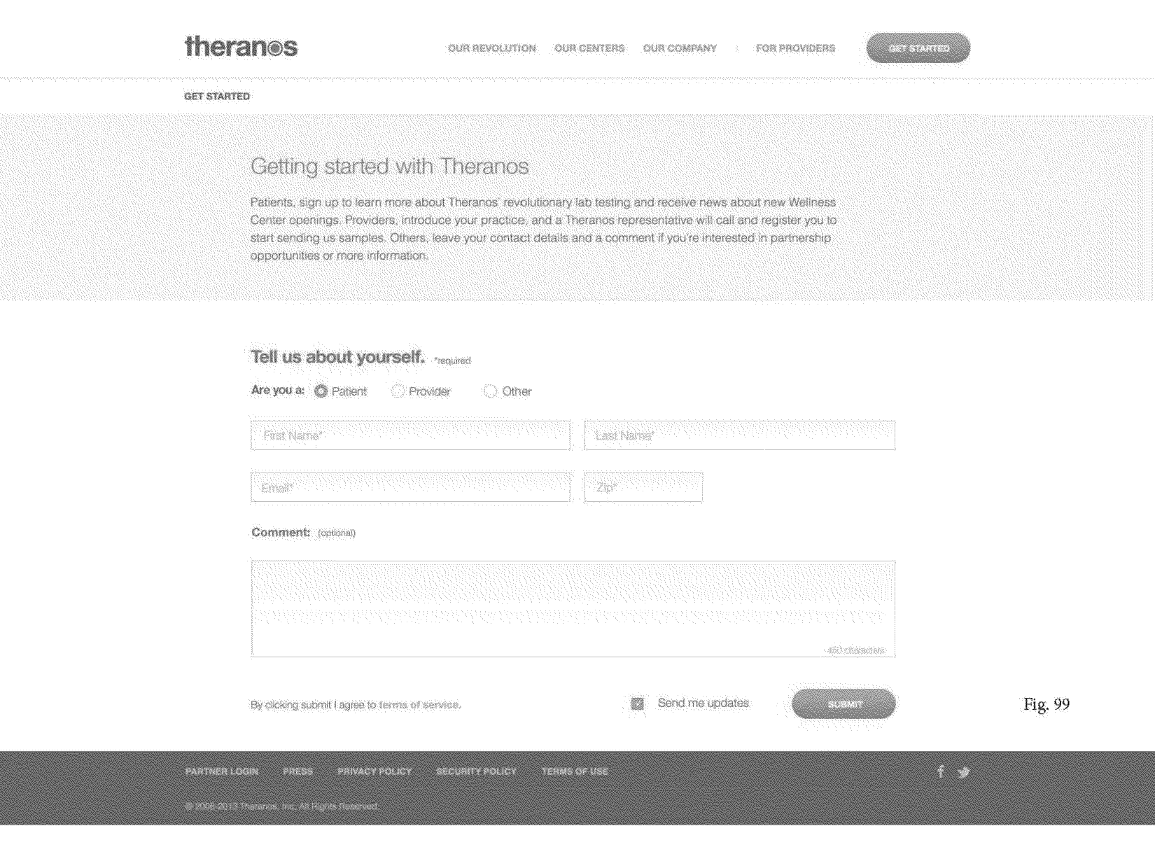

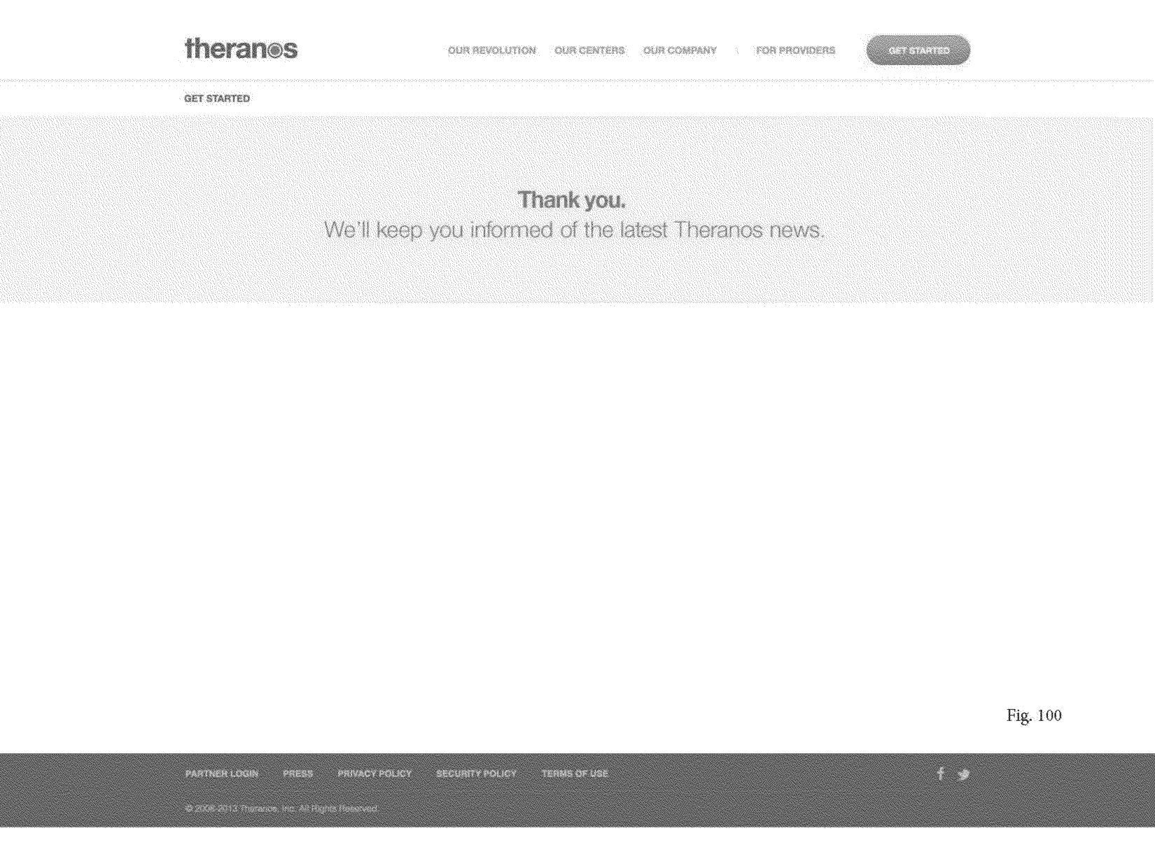

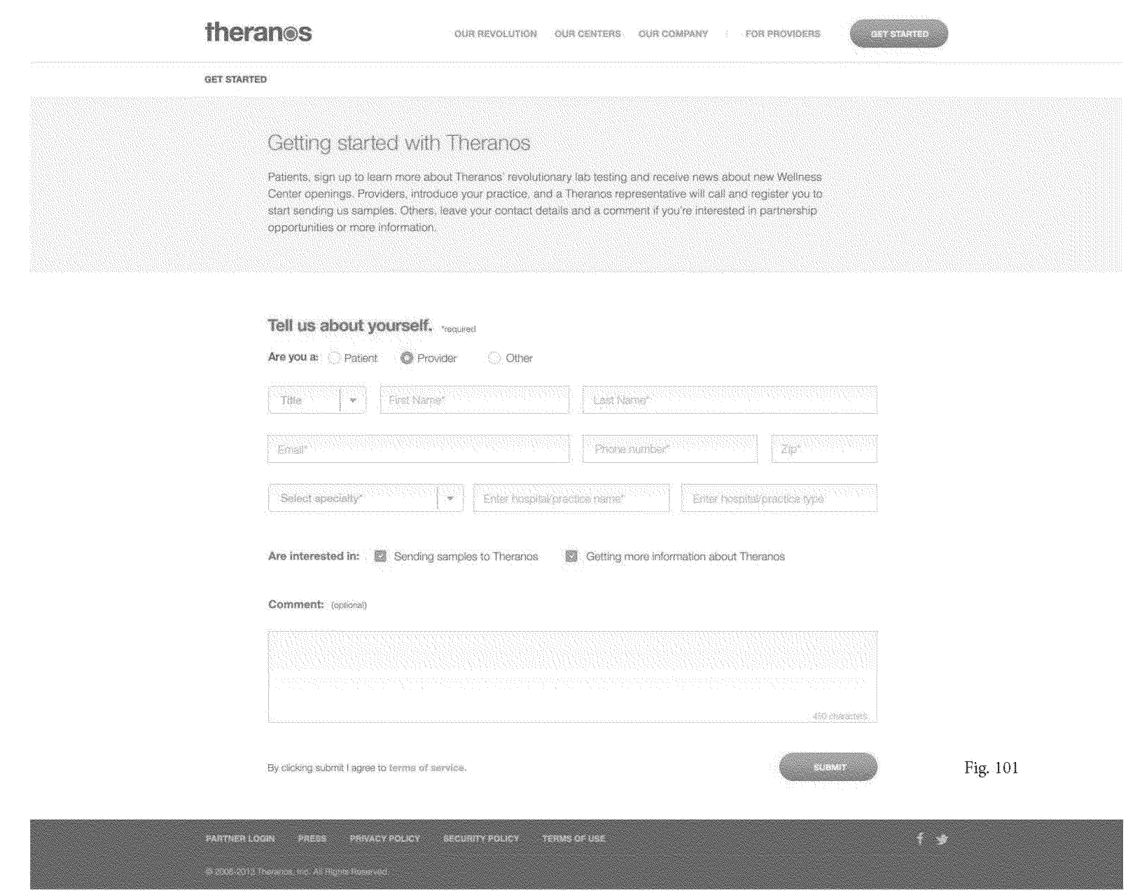

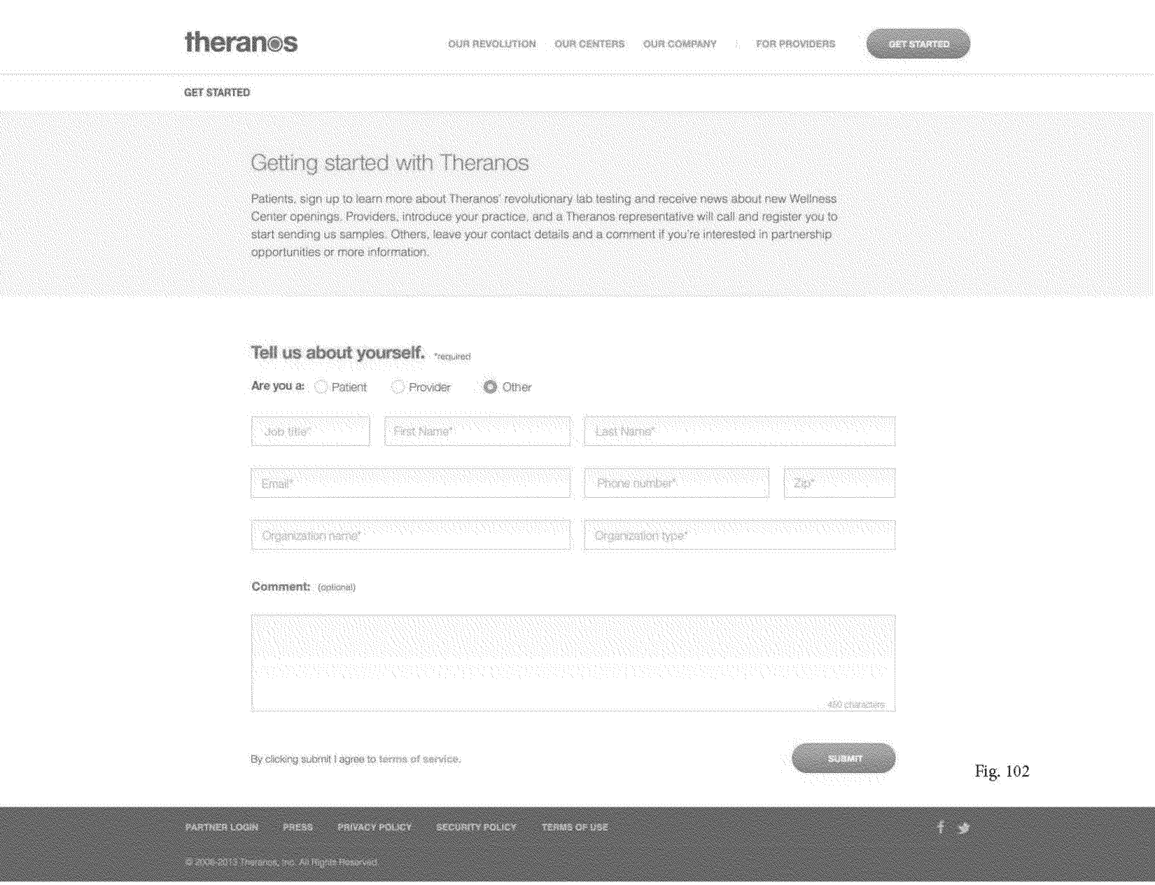

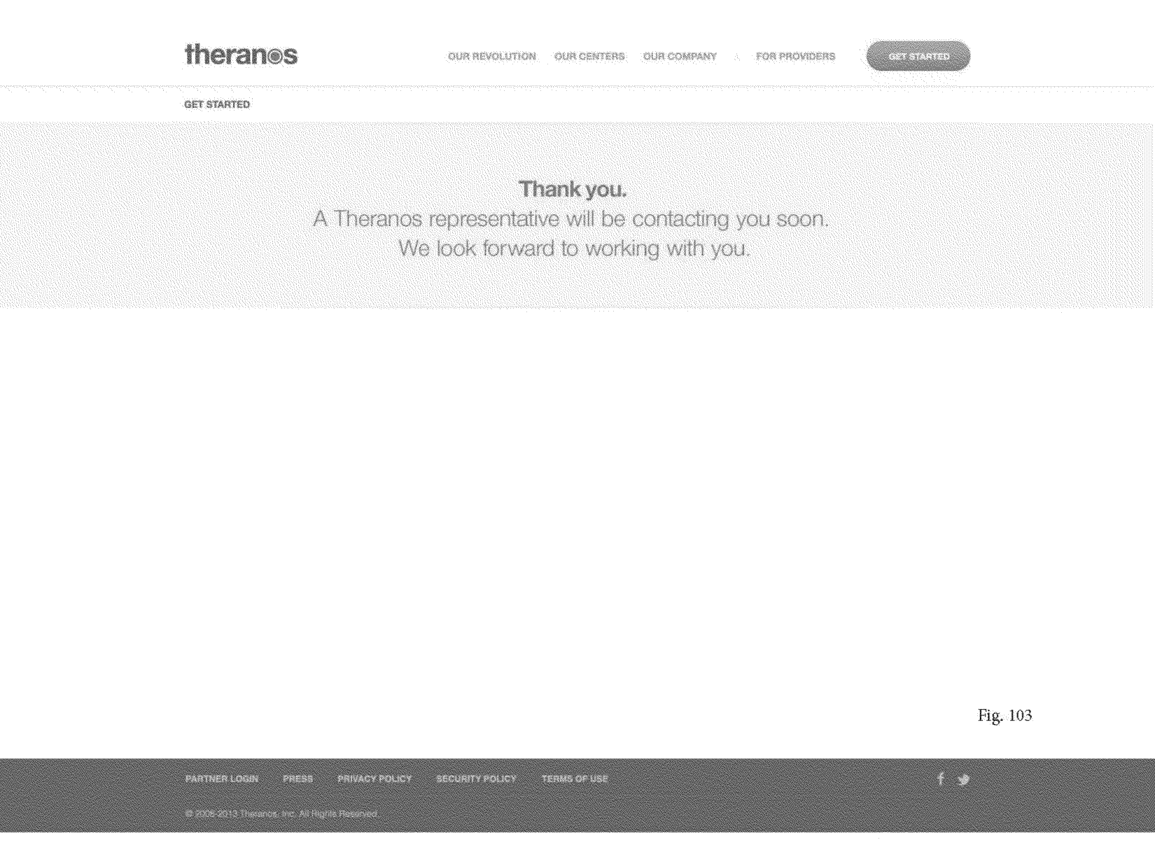

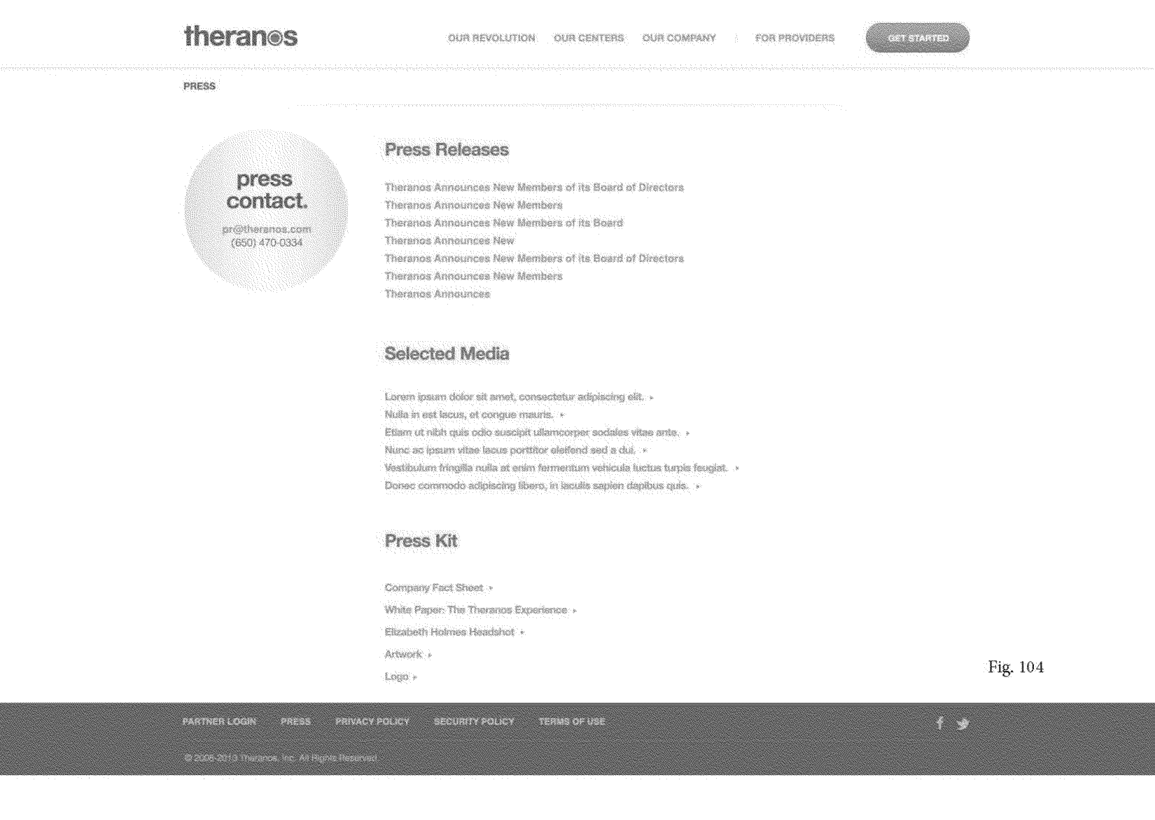

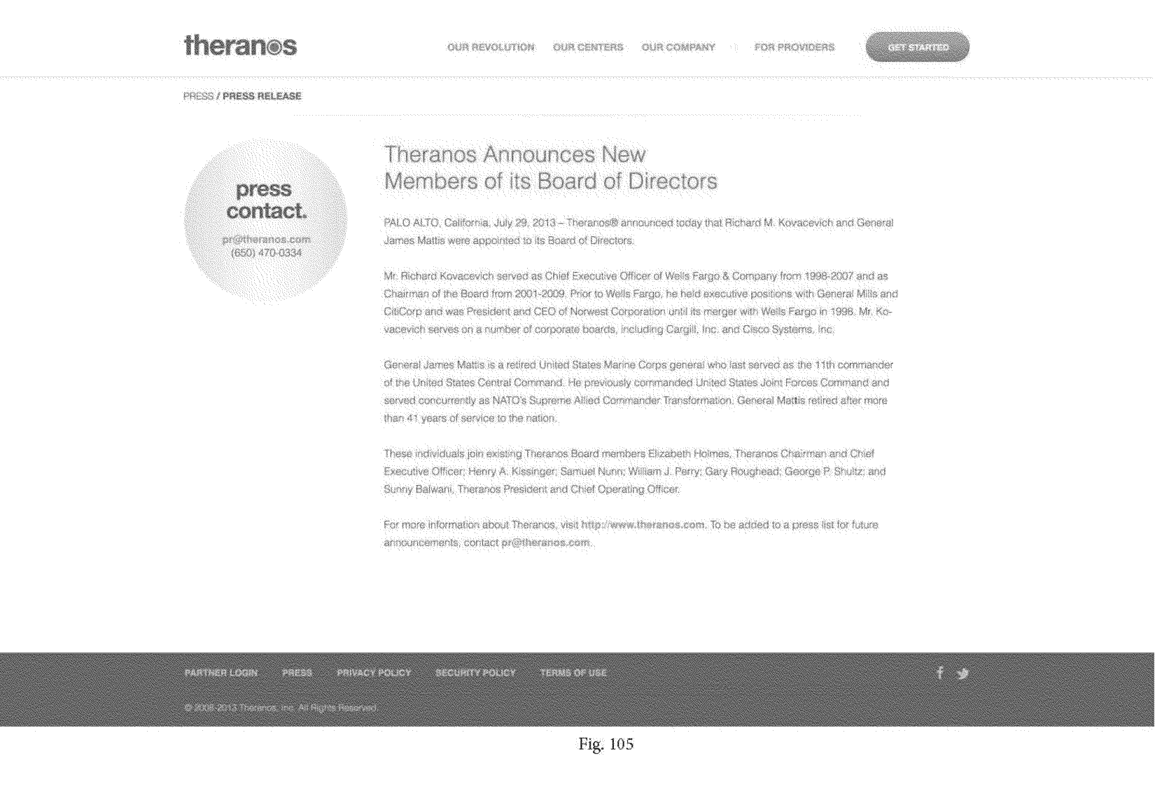

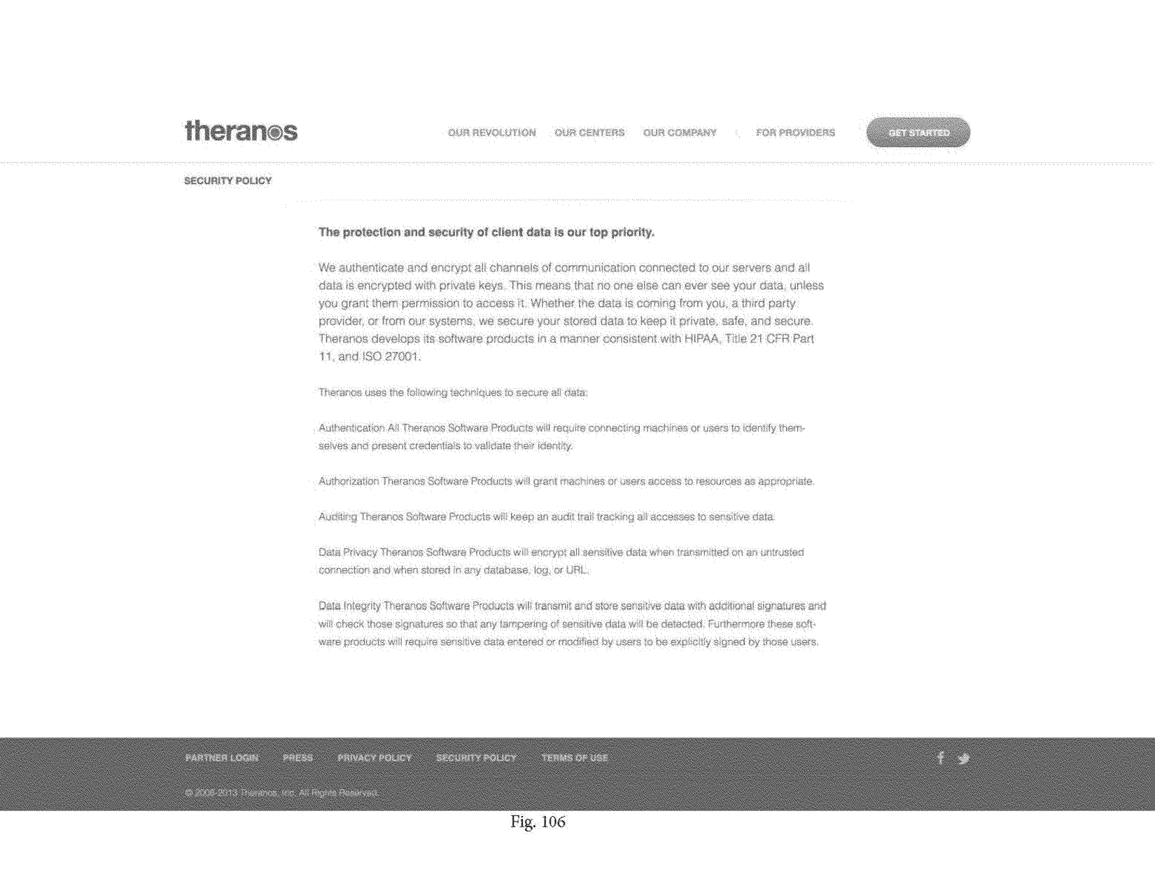

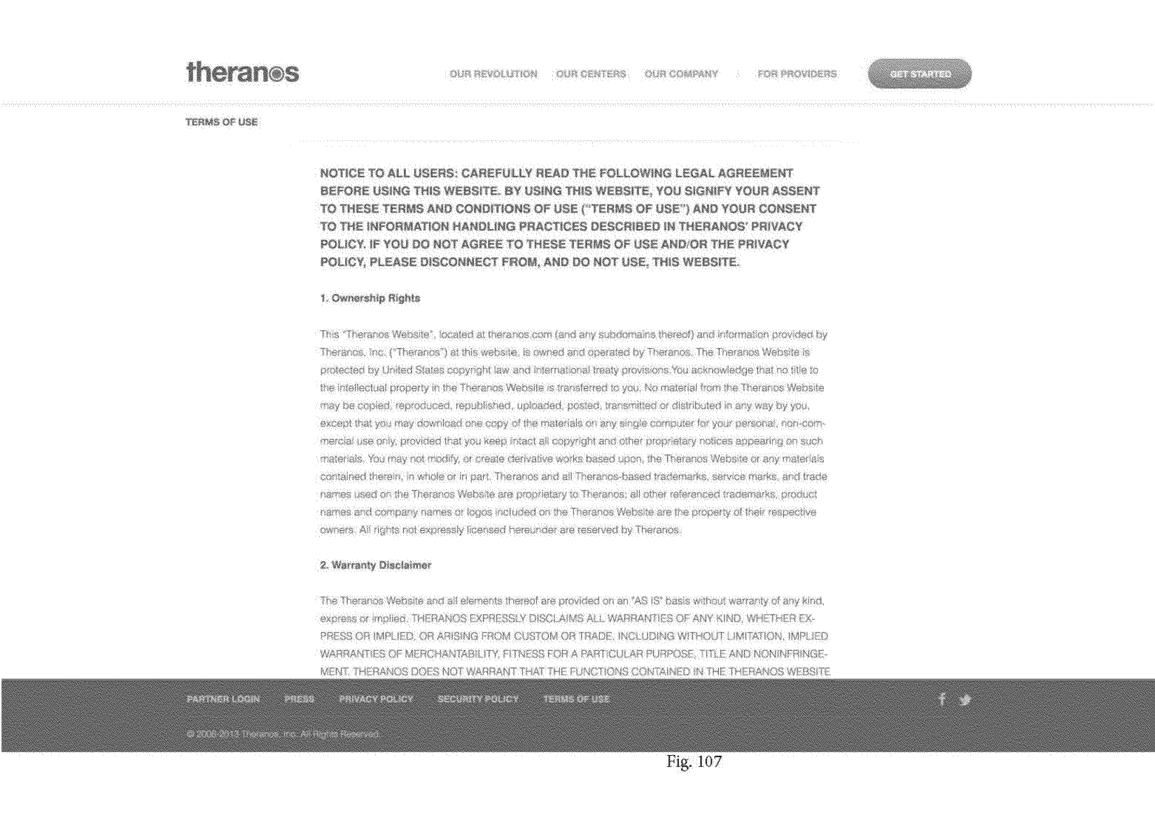

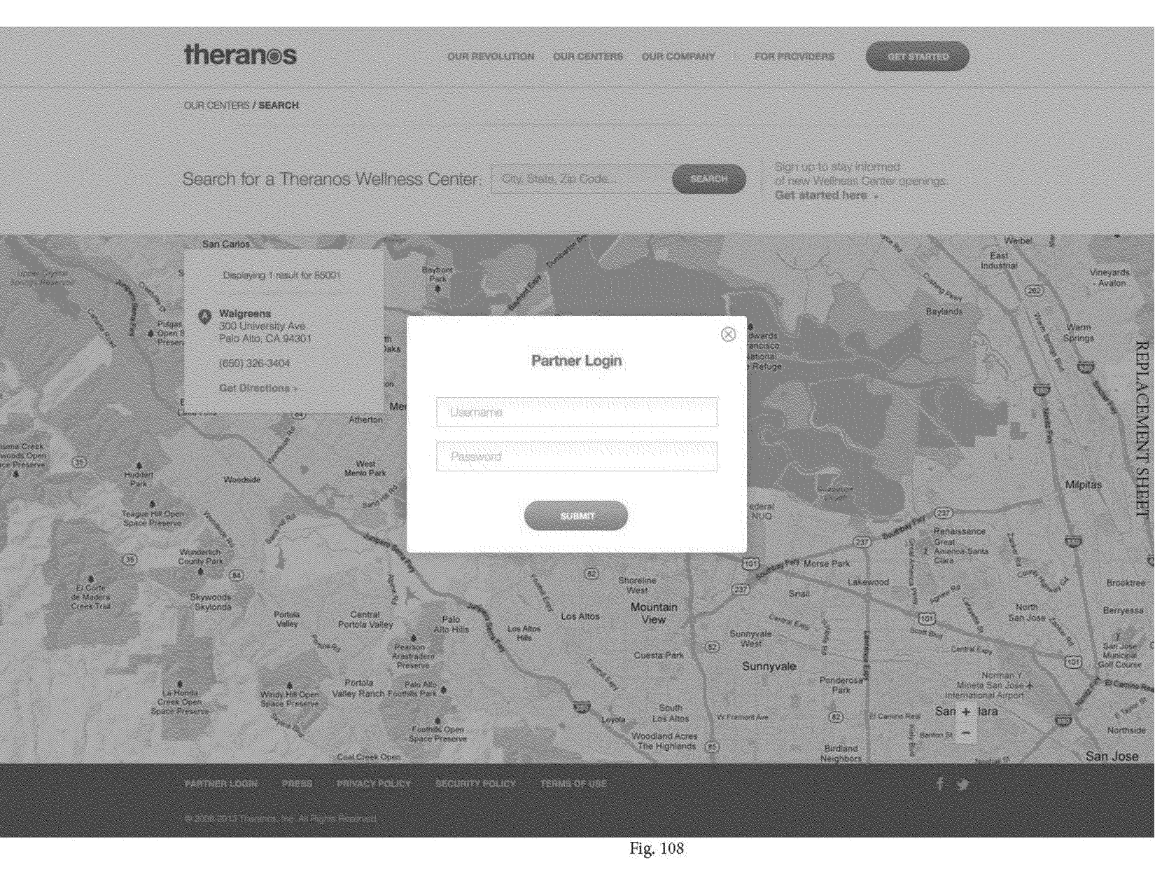

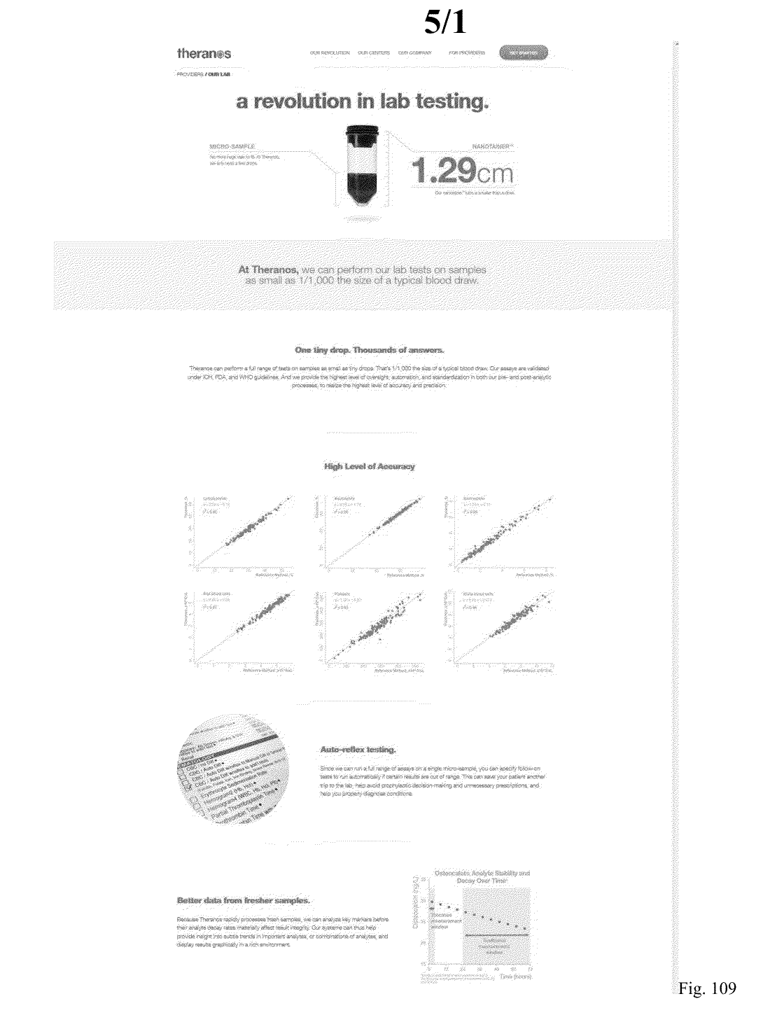

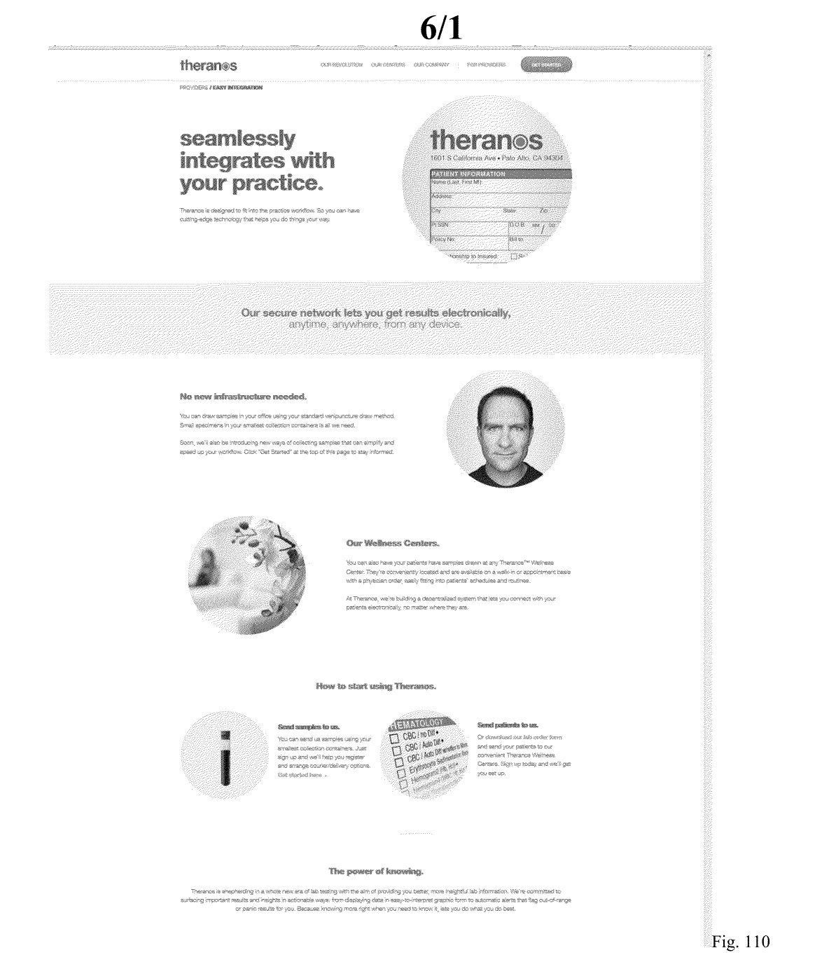

Referring now to FIGS. 73 and 74, exemplary embodiments of a system for use with the user interfaces, workflows, and/or other features is described herein. As seen in FIG. 73, there may be one or more caching servers that are in place to respond to data requests. In some embodiments, the caching server may not have the information requested. In such a scenario, the requesting device can already know to direct the request to the server with the data base, or optionally, for the caching server or other intermediary to direct the request to the server with the data. By way of example, the caching server can provide information that may be relevant to a geographic region or other factor for the server to be located in manner that responds the data request. Some embodiments may have scheduling information, location information, services information, or the like for users and/or locations in certain areas.

In one embodiment as seen in FIG. 74, the system 100 may involve, for example, a primary server 110, a caching server 120, a network 130, an external data source 140, and a user device 150. The primary server 110 may store or process data, such as laboratory test related information. The caching server 120 may also store or process data, although its major purpose may be to temporarily store copies of content which is also available in the primary server. The network 130 may be any structure which can support the operable connection of and data transfer between two or more computing devices, such as a local area network (LAN) or a wide area network (WAN), and may include, for example, an intranet or the Internet. The external data source 140 may be any computing device which may store, transmit, receive, or gather data that may be accessed by or sent to a server of the system. The user device 150 may be any computing device with which a user may review, input, or change laboratory test-related information. As used herein, a “computing device” refers to any device which may store, transmit, receive, gather, or process digital data, and may include, for example, servers, personal computers, data storage units, hard drives, portable digital media, smartphones, computer systems, mobile devices, external data sources, user devices, and websites. In embodiments, systems or elements thereof described herein may be implemented as a cloud-computing system.

A primary server 110 may contain, for example, a processor 111, a memory unit 112, and a data storage unit 113. The processor 111 of a server may be a hardware structure which performs computational operations of a computer program. In embodiments, a processor 111 may carry out instructions stored in a tangible computer readable medium. The processor 111 may contain one or more microprocessors. A memory unit 112 is a structure for storage of digital information which typically uses volatile storage and is rapidly or directly accessible by a processor (e.g. random access memory (RAM)). A data storage unit 113 is a structure for storage of digital information which typically uses non-volatile storage, and which typically has a much larger storage capacity than a memory unit 112, but is less quickly accessible by the processor 111 than the memory unit (e.g. hard drive). In embodiments, the memory unit 112 or data storage unit 113 may store non-transitory computer readable media, which may include, for example, code, logic, or instructions for performing methods provided herein. A primary server 110 may have any number of processors 111, memory units, 112, or data storage units 113 (e.g. 1, 2, 3, 4, 5, 6, 7, 8, 9, 10, 15, 20, 25, 50, 100, 1000, or more of any or each of the processors, memory units, or data storage units). A primary server 110 may also contain other components, such as a removable media drive (which may accept, for example, CDs, DVDs, floppy disks, or magnetic tape-based storage), input-output (I/O) channels, buses, network interfaces (wired or wireless structures for facilitating data transfer between a server a network), or power supplies. A primary server 110 may have a variety of different shapes and structures. For example, a primary server 110 may be a dedicated server, or it may be part of a computer which contains other features (e.g. a monitor, peripherals, etc.). In some embodiments, the primary server 110 may be part of, for example, a personal computer or a smart phone.

Optionally, a system provided herein may contain non-transitory tangible computer readable media. Computer readable media can be any available media which can be directly or indirectly accessed by a processor or server of a system provided herein. Computer readable media may include volatile and nonvolatile media, as well as removable and non-removable media. Computer readable media may be implemented in any method or technology for storage of information, such as computer readable instructions, data structures, program modules, or other data. Computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage device, or any other medium which can be used to store information and which may be accessed by a processor or server.

Optionally, a server may be operably connected to one or more external data source 140 (e.g. a website with information of interest, a GPS associated with a computing device of interest, a different server, a hard drive); the server may obtain information from such sources as-needed or at regular intervals. In embodiments, a server may include data mining hardware or software, such as software configured to search the Internet or predetermined web sites (e.g., “weather.com”) on the internet to obtain data of interest. In embodiments, an external data source 140 may be a data storage unit operably connected to the server. A server may have load balancing, task management, and backup capacities. The components of a server may be within a single housing unit, or they may be distributed between two or more housing units. A server may be implemented as a distributed network of processors, memory, and storage units. A server may contain or be operably connected to a database (for example, the database may be in a data storage unit of the server or in an external data source). The processor of a server may run a computer program or software, the instructions of which may be provided from, for example, a data storage unit, removable media, or a data storage unit operably connected to the server. In embodiments, two or more servers may act together to function as a server. Servers may communicate with any number and type of computing devices. The server may engage in one-way or two-way communication with computing devices. Other server components or configurations not explicitly discussed herein but known in the art may be included in servers and systems described herein.

By way of non-limiting example, the primary server 110 may contain or be operably connected one or more databases of information relevant to laboratory testing. For example, databases may contain information relating to users or patient accounts, such as patient home addresses, patient contact information (e.g. phone number, e-mail address), billing information, emergency contact information, insurance information, appointment histories, medical records, user login names and passwords, patient healthcare provider information, or other information. The primary server 110 may, with the aid of a processor, use data from one or more sources to perform methods relating to laboratory test analysis or scheduling Optionally, the caching server 120 may have any of the components or configurations of the primary server 110 described elsewhere herein. Generally, the caching server 120 is optimized for temporary storage of frequently-accessed content from the primary server 110, in order to increase the speed at which the content can be delivered to a client/user and to decrease the number of operations required to be performed by the primary server 110 (and in turn, to increase the performance of the primary server 110). The caching server 120 may store content in either or both of the memory unit 122 or data storage unit 123. In systems and methods provided herein, the caching server may store, for example, appointment information for one or more health service centers. The caching server 120 may be configured to regularly update from the primary server 110 its cached content. In embodiments, a caching server 120 may be located in a particular geographic area, and may be configured to respond to data requests from users the same or related geographic areas. For example, a first caching server 120 could be provided in North Carolina to respond to requests based in the eastern United States, a second caching server 120 could be provided in Texas to respond to requests based in the central United States, and a third caching server 120 could be provided in California to respond to requests based in the central United States. In embodiments, two or more caching servers 120 may be operably connected to a single primary server 110. In other embodiments, two or more caching servers 120 may be operably connected to two or more primary servers 110. In embodiments, a system provided herein may contain more caching servers 120 than primary servers 110, more primary servers 110 than caching servers 120, or equal numbers of primary servers 110 and caching servers 120.

Optionally, the network 130 may be any structure which can support the operable connection of and data transfer between two or more computing devices, such as a local area network (LAN) or a wide area network (WAN), and may include, for example, an intranet, an enterprise private network, the Internet, cellular, or satellite networks. The network may include, for example, one or more of wireless connections, wired connections, or fiber optic connections. Computing devices (e.g. servers, external data sources, and user devices) may connect to the network 130 by wired or wireless technologies. For example, a computing device may connect to the network 130 via wired technologies such as a dial-up connection with a modem, a direct link such as TI, ISDN, cable, Firewire, USB, or Ethernet wire. In other examples, a computing device may connect to the network 130 via wireless technologies such as Bluetooth, RTM, infrared (IR), radio frequency (RF), ZigBee, Z-wave, wireless USB, code division multiple access (CDMA) or global system for mobile communications (GSM). In embodiments, data may be encrypted before it is transmitted over the network 130.

Optionally, the external data source 140 may be any computing device which may store, transmit, receive, or gather data that may be accessed by or sent to a server of the system. External data sources include, for example, other servers, hard drives (e.g. IDE, ATA, or SATA drives), databases, personal computers, data storage units, hard drives, portable digital media, smartphones (e.g. Apple iPhone, Android-enabled phone), mobile devices, and computer systems, global positioning system (GPS) devices. An external data source may be portable or non-portable/at a fixed location. In embodiments, an external data source 140 may be capable of obtaining geolocation data, such as by wireless triangulation or a GPS system. In embodiments, an external data source 140 may be on or associated with a subject (e.g. on a subject's wrist or in a subject's pocket or handbag). The external data source 140 may be a portable computing device in proximity to the subject such that the measured location of the device corresponds to the location of the subject. The device may be a portable computing device the subject carries for other purposes. For example, the device may be a smart phone, such as an iPhone or Android-enabled phone, capable of gathering geolocation data, such as with the aid of a GPS module of the device. The device may be an iPad or other portable computing device, such as a watch capable of gathering geolocation data. A client-server relationship, peer-to-peer, or a distributed relationship, may be provided between the external data source 140 and a server of the system. In embodiments, an external data source 140 may communicate directly or indirectly with a server. For example, an external data source 140 may have a direct wired linkage to a server. In another example, an external data source may communicate wirelessly with a server. In another example, an external data source 140 may communicate with a server when the external data source is connected to a personal computer via a wire, and when the personal computer is connected to the Internet. In embodiments, the external data source 140 is operatively coupled to the primary server 110. The external data source 140 may be coupled to the primary server 110 such that data travelling between the external data source 140 and the primary server 110 passes through the caching server 120 as it travels between the external data source 140 and the primary server 110. Alternatively, the external data source 140 may be coupled to the primary server 110 such that data travelling between the external data source 140 and the primary server 110 does not pass through the caching server 120 as it travels between the external data source 140 and the primary server 110. In embodiments, the system may be configured such that the external data source 140 is operatively coupled to the primary server 110 without passing through or involving the caching server 120. With systems and methods provided herein, 1, 2, 3, 4, 5, 10, 15, 20, 25, 100, 1000 or more external data sources 140 may be in communication with a server.

Optionally, the user device 150 may be any computing device with which a user may review, input, request, or change laboratory-test related information. User devices may include, for example, personal computers, tablet computers, smartphones (e.g. Apple iPhone, Android-enabled phone), mobile devices, or computer systems. A user device may be portable or non-portable/at a fixed location. A user device 150 may contain one or more user interfaces. User interfaces may provide information to a user, obtain inputs from a user, or both. A user interface may have a display, such as a cathode ray tube, plasma, liquid crystal display (LCD), or light-emitting diode (LED)—based display. In embodiments, a user interface may include a graphical user interface (GUI) configured to display information to a user on a display, such as appointment time and availability information. A GUI may also be configured to receive information from a user, such as by capacitive or resistive touch-screen functions. In some situations, user interfaces may include camera for video or still images, a microphone for capturing audible information (e.g., a subject's voice), speakers for providing audible information, a printer for printing information, or a projector for displaying images and/or video on a predetermined viewing surface. Other user interfaces of a user device 150 may include, for example, a keyboard, touch pad, or a computer mouse. A user device may contain a processor and local memory and data storage.

In at least some embodiments, certain computing devices may function as both an external data source 140 and a user device 150 for systems provided herein. For example, a GPS receiver-containing tablet computer may both: i) obtain patient location data which is provided to a server running a software program described herein (and thus, function as an external data source 140), and ii) provide a user interface such as a touch screen which may display and receive user input regarding appointment times (and thus, function as a user device 150). In other embodiments, certain computing devices function as either an external data source 140 or a user device 150. For example, a stand-alone hard drive operatively coupled to a primary server 110 is an external data source 140 but not a user device 150. In another example, a computer having a display at a health service center to display appointment time information for patients may function as a user device 150 but not an external data source 140.

In at least some embodiments, a user may be able to interact with software on a server through a client application running on a user device 150. A client application may be, for example, a World Wide Web (WWW)-based interface. A WWW-based interface may be provided, for example, at a specific URL (e.g. a web page), which users may access via the network 130 through a user device 150. A user may request a WWW-based interface at a specific URL, and the content may be delivered to the user device from the primary server 110 or caching server 120. In embodiments, users may input information on a WWW-based interface, and the information may be provided to one or both of the primary server 110 or caching server 120. In embodiments, a WWW-based interface may permit a user to log in to a user account, to permit the user to access one or more interconnected web pages (e.g. web pages associated with the user account). In embodiments, a WWW-based interface may provide laboratory test-related information. With the WWW-based interface, a user may optionally be able to, for example, view appointment-related information, request an appointment, change an appointment date/time, cancel an appointment, or provide special instructions or comments relating to a past or upcoming appointment.

In addition to the system components and configurations described above and elsewhere herein, it is also noted that other suitable system components and configurations may be used with systems and methods provided herein. For example, embodiments of methods provided herein can be implemented in a computing system that includes a back-end component (e.g. a primary server) and a front-end component (e.g. a user computer having a GUI or Web browser through which a user can interact with a computer software for performing methods provided herein), in which the back-end component and front-end component are interconnected by any combination of hardware and software for digital data communication. In other examples, embodiments of methods provided herein can be implemented using a single computing device (e.g. where the computing device stores relevant data, contains one or more processors for performing operations described herein, receives user information, and displays information to a user). Also, it is noted that the relationship between objects depicted in FIG. 74 and elsewhere here is exemplary, and other relationships are within the scope of systems and methods provided herein. For example, although FIG. 74 depicts an external data source 140 being connected to a primary server 110 via a network 130, in embodiments, an external data source may 140 may directly link to a primary server 110 (i.e. without connecting through a network 130).

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, it should be understood that the user interfaces herein are not limited to IOS or Android and that other operating systems are not excluded.

For some embodiments herein, as data is sent to the cloud, the metadata in the file may be corrupted or not provide desired information regarding when test was taken. Some embodiments herein may opt not to use any of the metadata associated with the data. Optionally, some embodiments may extract metadata at the device and include it as part of the data such as but not limited to a value of one or more the data fields that are transmitted, instead of residing in the background as metadata. Optionally, the harvesting of the metadata can occur in the cloud. It may continue to be part of the metadata of the file or it can be incorporated into one or more the data fields that are transmitted onward to the laboratory.

Some embodiments herein may include an opt-in and/or opt-out user interface page or question so that the user may select the privacy, clinical trial, and/or other participation in programs associated with the user and/or the test data.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 nm to about 200 nm should be interpreted to include not only the explicitly recited limits of about 1 nm and about 200 nm, but also to include individual sizes such as 2 nm, 3 nm, 4 nm, and sub-ranges such as 10 nm to 50 nm, 20 nm to 100 nm, etc. . . . .

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited. The following applications are fully incorporated herein by reference for all purposes:

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Any feature, whether preferred or not, may be combined with any other feature, whether preferred or not. The appended claims are not to be interpreted as including means-plus-function limitations, unless such a limitation is explicitly recited in a given claim using the phrase “means for.” It should be understood that as used in the description herein and throughout the claims that follow, the meaning of “a,” “an,” and “the” includes plural reference unless the context clearly dictates otherwise. For example, a reference to “an assay” may refer to a single assay or multiple assays. Also, as used in the description herein and throughout the claims that follow, the meaning of “in” includes “in” and “on” unless the context clearly dictates otherwise. Finally, as used in the description herein and throughout the claims that follow, the meaning of “or” includes both the conjunctive and disjunctive unless the context expressly dictates otherwise. Thus, the term “or” includes “and/or” unless the context expressly dictates otherwise.

1-2. (canceled)

3. A method comprising:
using a mobile computing device to schedule an appointment time for a laboratory test;
displaying a laboratory test menu on the mobile computing device, selecting one or more tests from said test menu, wherein the test menu is variable-based on geographic location; and
using the mobile computing device to send a laboratory test request and appointment information to a server.

4. (canceled)

5. A method comprising:
displaying a plurality of laboratory test results on a mobile computing device, wherein each of said test results has an acceptable range that is normalized such that a longest physical dimension of such acceptable range is displayed in manner that is the same between each of the test results.

6. A method comprising:
associating insurance coverage information with a user account that is accessible by way of a mobile computing device, wherein insurance coverage of a laboratory test request is confirmed and displayed to the user to show the user's copayment and any other payment required from the user for a laboratory test request for that user.

7-12. (canceled)
